(19) United States
(12) Patent Application Publication
(10) Pub. No.: US 2025/0343221 A1
(43) Pub. Date: Nov. 6, 2025

(54) METHOD FOR MANUFACTURING SECONDARY BATTERY

(71) Applicant: SEMICONDUCTOR ENERGY LABORATORY CO., LTD., Atsugi-shi, Kanagawa-ken (JP)

(72) Inventors: Rihito WADA, Atsugi, Kanagawa (JP); Atsushi KAWATSUKI, Yokohama, Kanagawa (JP); Jo SAITO, Atsugi, Kanagawa (JP); Takayuki IKEDA, Atsugi, Kanagawa (JP); Shunpei YAMAZAKI, Setagaya, Tokyo (JP)

(21) Appl. No.: 18/873,507

(22) PCT Filed: Jun. 9, 2023
(86) PCT No.: PCT/IB2023/055954

§ 371 Date: Dec. 10, 2024

(30) Foreign Application Priority Data
Jun. 17, 2022 (JP) 2022-097938
Jun. 17, 2022 (JP) 2022-097957

(51) Int. Cl. H01M 4/04; H01M 4/02; H01M 4/36; H01M 4/525

(52) U.S. Cl. CPC H01M 4/0471; H01M 4/364; H01M 4/366; H01M 4/525; H01M 2004/021; H01M 2004/028

(57) ABSTRACT

A positive electrode active material inhibiting a decrease in discharge capacity due to charge and discharge cycles and a secondary battery including the positive electrode active material are provided. Alternatively, a secondary battery with a high level of safety is provided. The secondary battery includes a positive electrode containing a positive electrode active material, a negative electrode, and an electrolyte. The positive electrode active material is formed by a first step of mixing a composite oxide containing lithium, cobalt, and oxygen, a magnesium source, and a nickel source to form a mixture and a second step of heating the mixture. The nickel source is nickel fluoride. Magnesium, nickel, and fluorine are segregated on the surface of the composite oxide.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a power storage device including a secondary battery, a semiconductor device, a display device, a light-emitting device, a lighting device, an electronic device, or a manufacturing method thereof.

Electronic devices in this specification refer to all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1 to Patent Document 3). In addition, a crystal structure of a positive electrode active material has also been studied (Non-Patent Document 1 to Non-Patent Document 4).

X-ray diffraction (XRD) is a method used for analysis of the crystal structure of a positive electrode active material. With the use of the ICSD (Inorganic Crystal Structure Database) described in Non-Patent Document 5, XRD data can be analyzed. For example, the ICSD can be referred to for the lattice constant of the lithium cobalt oxide described in Non-Patent Document 6. For Rietveld analysis, the analysis program RIETAN-FP (Non-Patent Document 7) can be used, for example.

As image processing software, for example, ImageJ (Non-Patent Document 8 to Non-Patent Document 10) is known. Using this software makes it possible to analyze the shape of a positive electrode active material, for example.

Nanobeam electron diffraction can also be effectively used to identify the crystal structure of a positive electrode active material, in particular, the crystal structure of a surface portion of the positive electrode active material. For analysis of electron diffraction patterns, an analysis program called ReciPro (Non-Patent Document 11) can be used, for example.

Fluorides such as fluorite (calcium fluoride) have been used as fusing agents in iron manufacture and the like for a very long time, and the physical properties of fluorides have been studied (Non-Patent Document 12). Non-Patent Document 13 shows the physical properties of fluorides such as nickel fluoride.

Lithium-ion secondary batteries are known to enter thermal runaway after going through several states when the temperature increases during charging (Non-Patent Document 15).

Various researches and developments have been conducted for the reliability and safety of lithium-ion secondary batteries. For example, Non-Patent Document 14 shows the thermal stability of a positive electrode active material and an electrolyte solution.

### REFERENCE

### Patent Document

[Patent Document 1] Japanese Published Patent Application No. 2019-179758
[Patent Document 2] PCT International publication No. 2020/026078
[Patent Document 3] Japanese Published Patent Application No. 2020-140954

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, p. 17340-17348
[Non-Patent Document 2] Motohashi, T. et al., “Electronic phase diagram of the layered cobalt oxide system LiₓCoO₂ (0.0≤x≤1.0)”, Physical Review B, 80 (16); 165114
[Non-Patent Document 3] Zhaohui Chen et al., “Staging Phase Transitions in LixCoO₂”, Journal of The Electrochemical Society, 2002, 149 (12), Al604-Al609
[Non-Patent Document 4]G. G. Amatucci et al., “CoO₂, The End Member of the LixCoO₂ Solid Solution”, J. Electrochem. Soc., 143 (3), 1114 (1996).
[Non-Patent Document 5] Belsky, A. et al., “New developments in the Inorganic Crystal Structure Database (ICSD): accessibility in support of materials research and design”, Acta Cryst., (2002) B58, 364-369.
[Non-Patent Document 6] Akimoto, J.; Gotoh, Y.; Oosawa, Y. “Synthesis and structure refinement of LiCoO₂ single crystals”, Journal of Solid State Chemistry (1998) 141, p. 298-302.
[Non-Patent Document 7]F. Izumi and K. Momma, Solid State Phenom., 130, 15-20 (2007).
[Non-Patent Document 8] Rasband, W. S., ImageJ, U. S. National Institutes of Health, Bethesda, Maryland, USA, http://rsb.info.nih.gov/ij/, 1997-2012.
[Non-Patent Document 9] Schneider, C. A., Rasband, W. S., Eliceiri, K. W., “NIH Image to ImageJ: 25 years of image analysis”, Nature Methods, 9, 671-675, 2012.
[Non-Patent Document 10] Abramoff, M. D., Magelhaes, P. J., Ram, S. J., “Image Processing with ImageJ”, Biophotonics International, volume 11, issue 7, 36-42, 2004.
[Non-Patent Document 11] Seto, Y. & Ohtsuka, M., “ReciPro: free and open-source multipurpose crystallographic software integrating a crystal model database and viewer, diffraction and microscopy simulators, and diffraction data analysis tools” J. Appl. Cryst., 55, 2022.
[Non-Patent Document 12]W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36[1]12-17, 1953.
[Non-Patent Document 13]J. A. Ocadiz-Flores et al., “Thermodynamic assessment of the LiF—NiF₂, NaF—NiF₂ and KF—NiF₂ systems”, The Journal of Chemical Thermodynamics, 121, 17-26, 2018.
[Non-Patent Document 14] Shinya Kitano et al., GS Yuasa Technical Report, Vol. 2, No. 2, December, 2015, p. 18-24.
[Non-Patent Document 15] Nobuo Eda, “2-4: Mechanism of Heat Generation” in “Learning Charging and Discharging Techniques of Li-Ion Batteries from Data” [Translated from Japanese.], CQ Publishing Co., Ltd., published on Apr. 4, 2020, p. 68-72.

### SUMMARY OF THE INVENTION

### Problems to be Solved by the Invention

There is room for improvement in a variety of aspects of secondary batteries including lithium-ion secondary batteries, such as discharge capacity, cycle performance, reliability, safety, and cost.

Therefore, positive electrode active materials that can improve discharge capacity, cycle performance, reliability, safety, cost, and the like when used in secondary batteries have been required.

An object of one embodiment of the present invention is to provide a positive electrode active material or a composite oxide which can be used in a secondary battery and in which a decrease in discharge capacity due to charge and discharge cycles is inhibited. Another object is to provide a positive electrode active material or a composite oxide whose crystal structure is not easily broken even when charging and discharging are repeated. Another object is to provide a positive electrode active material or a composite oxide with high discharge capacity. Another object is to provide a highly safe or reliable secondary battery.

Another object of one embodiment of the present invention is to provide a positive electrode active material, a composite oxide, a power storage device, or a manufacturing method thereof.

Note that the description of these objects does not preclude the existence of other objects. One embodiment of the present invention does not need to achieve all these objects. Other objects can be derived from the descriptions of the specification, the drawings, and the claims.

### Means for Solving the Problems

One embodiment of the present invention is a method for manufacturing a secondary battery that includes a positive electrode containing a positive electrode active material, a negative electrode, and an electrolyte; the positive electrode active material is formed by a first step of mixing a composite oxide containing lithium, cobalt, and oxygen, a magnesium source, and a nickel source to form a mixture and a second step of heating the mixture; the nickel source is nickel fluoride; magnesium, nickel, and fluorine are segregated on a surface of the composite oxide by the second step.

In the above embodiment, the magnesium source is preferably magnesium fluoride.

Another embodiment of the present invention is a method for manufacturing a secondary battery that includes a positive electrode containing a positive electrode active material, a negative electrode, and an electrolyte; the positive electrode active material is formed by a first step of mixing a composite oxide containing lithium, cobalt, and oxygen, magnesium fluoride, nickel fluoride, and lithium fluoride to form a mixture and a second step of heating the mixture; magnesium, nickel, and fluorine are segregated on a surface of the composite oxide by the second step.

In the above embodiment, the positive electrode active material preferably has a layered rock-salt crystal structure belonging to R-3m and a structure in which a CoO₂ layer and a lithium layer are alternately stacked; magnesium segregated on the surface of the composite oxide preferably inhibits a shift in the CoO₂ layer.

In the above embodiment, the heating in the second step is preferably performed at a temperature higher than or equal to 650° C. and lower than or equal to 1000° C.

In the above embodiment, the heating in the second step is preferably performed at a temperature at which cation mixing is unlikely to occur.

Another embodiment of the present invention is a method for manufacturing a secondary battery that includes a positive electrode containing a positive electrode active material, a negative electrode, and an electrolyte; the positive electrode active material is formed by a first step of mixing a first composite oxide, a magnesium source, and a nickel source to form a first mixture, a second step of performing first heating on the first mixture to form a second composite oxide, a third step of mixing the second composite oxide and an aluminum source to form a second mixture, and a fourth step of performing second heating on the second mixture; the first composite oxide contains lithium, cobalt, and oxygen; the nickel source is nickel fluoride; and magnesium, nickel, and fluorine are segregated on a surface of the second composite oxide by the second step.

In the above embodiment, the magnesium source is preferably magnesium fluoride.

In the above embodiment, the positive electrode active material preferably has a layered rock-salt crystal structure belonging to R-3m and a structure in which a CoO₂ layer and a lithium layer are alternately stacked; magnesium segregated on the surface of the second composite oxide preferably inhibits a shift in the CoO₂ layer.

In the above embodiment, the first heating in the second step is preferably performed at a temperature higher than or equal to 650° C. and lower than or equal to 1000° C.; the second heating in the fourth step is preferably performed at a lower temperature than the first heating.

Another embodiment of the present invention is a method for manufacturing a secondary battery that includes a positive electrode containing a positive electrode active material, a negative electrode, and an electrolyte; the positive electrode active material is formed by a first step of mixing a first composite oxide, a first nickel source, and lithium fluoride to form a first mixture, a second step of performing first heating on the first mixture to form a second composite oxide, a third step of mixing the second composite oxide and a second nickel source to form a second mixture, and a fourth step of performing second heating on the second mixture; the first composite oxide contains lithium and cobalt.

In the above embodiment, the first nickel source is preferably nickel fluoride.

In the above embodiment, a magnesium source is preferably mixed in addition to the first composite oxide, the first nickel source, and the lithium fluoride to form the first mixture in the first step.

In the above embodiment, the first nickel source is preferably nickel fluoride and the magnesium source is preferably magnesium fluoride.

Another embodiment of the present invention is a method for manufacturing a secondary battery that includes a positive electrode containing a positive electrode active material, a negative electrode, and an electrolyte; the positive electrode active material is formed by a first step of mixing a first composite oxide and a first nickel source to form a first mixture, a second step of performing first heating on the first mixture to form a second composite oxide, a third step of mixing the second composite oxide, a second nickel source, and lithium fluoride to form a second mixture, and a fourth step of performing second heating on the second mixture; the first composite oxide contains lithium, cobalt, and oxygen.

In the above embodiment, the second nickel source is preferably nickel fluoride.

In the above embodiment, a magnesium source is preferably mixed in addition to the second composite oxide, the second nickel source, and the lithium fluoride to form the second mixture in the third step.

In the above embodiment, the first nickel source is preferably nickel fluoride and the magnesium source is preferably magnesium fluoride.

In the above embodiment, the first heating in the second step is preferably performed at a temperature higher than or equal to 650° C. and lower than or equal to 1000° C.; the second heating in the fourth step is preferably performed at a lower temperature than the first heating.

### Effect of the Invention

According to one embodiment of the present invention, a positive electrode active material or a composite oxide which can be used in a secondary battery and in which a decrease in discharge capacity due to charge and discharge cycles is inhibited can be provided. A positive electrode active material or a composite oxide whose crystal structure is not easily broken even when charging and discharging are repeated can be provided. A positive electrode active material or a composite oxide with high discharge capacity can be provided. A highly safe or reliable secondary battery can be provided.

According to one embodiment of the present invention, a positive electrode active material, a composite oxide, a power storage device, or a manufacturing method thereof can be provided.

Note that the description of these effects does not preclude the existence of other effects. One embodiment of the present invention does not need to have all these effects. Other effects will be apparent from the descriptions of the specification, the drawings, the claims, and the like, and other effects can be derived from the descriptions of the specification, the drawings, the claims, and the like.

### BRIEF DESCRIPTION OF THE DRAWINGS

FIG. 1A and FIG. 1B are diagrams illustrating a method for forming a positive electrode active material.

FIG. 2 is a diagram illustrating a method for forming a positive electrode active material.

FIG. 3A and FIG. 3B are diagrams illustrating a method for forming a positive electrode active material.

FIG. 4A and FIG. 4B are diagrams illustrating a method for forming a positive electrode active material.

FIG. 5 is a diagram illustrating a method for forming a positive electrode active material.

FIG. 6A and FIG. 6B are diagrams illustrating a method for forming a positive electrode active material.

FIG. 7 is a diagram illustrating a method for forming a positive electrode active material.

FIG. 8A and FIG. 8B are diagrams illustrating a method for forming a positive electrode active material.

FIG. 9 is a diagram illustrating a method for forming a positive electrode active material.

FIG. 10A and FIG. 10B are diagrams illustrating a method for forming a positive electrode active material.

FIG. 11 is a diagram illustrating a method for forming a positive electrode active material.

FIG. 12A and FIG. 12B are diagrams illustrating a method for forming a positive electrode active material.

FIG. 13 is a phase diagram showing a relation between temperature and compositions of lithium fluoride and magnesium fluoride.

FIG. 14 is a phase diagram showing a relation between temperature and compositions of lithium fluoride and nickel fluoride.

FIG. 15 is an example of a cross-sectional view illustrating a step of one embodiment of the present invention.

FIG. 16A and FIG. 16B are cross-sectional views of a positive electrode active material.

FIG. 17 is a diagram illustrating crystal planes of a positive electrode active material.

FIGS. 18A to 18C show distribution examples of additive elements contained in a positive electrode active material.

FIGS. 19A to 19C show distribution examples of additive elements contained in a positive electrode active material.

FIG. 20 is an example of a TEM image showing crystal orientations substantially aligned with each other.

FIG. 21A is an example of a STEM image showing crystal orientations substantially aligned with each other. FIG. 21B is an FFT pattern of a region of a rock-salt crystal RS and FIG. 21C is an FFT pattern of a region of a layered rock-salt crystal LRS.

FIG. 22 is a diagram illustrating crystal structures of a positive electrode active material.

FIG. 23 is a diagram illustrating crystal structures of a conventional positive electrode active material.

FIG. 24 is a diagram showing charge depths and lattice constants of a positive electrode active material.

FIG. 25 is a diagram showing XRD patterns calculated from crystal structures.

FIG. 26 is a diagram showing XRD patterns calculated from crystal structures.

FIG. 27A and FIG. 27B are diagrams showing XRD patterns calculated from crystal structures.

FIG. 28A to FIG. 28C show lattice constants calculated using XRD.

FIG. 29A to FIG. 29C show lattice constants calculated using XRD.

FIG. 30A and FIG. 30B are cross-sectional views of a positive electrode active material.

FIG. 31 is a diagram illustrating the appearance of a secondary battery.

FIG. 32A to FIG. 32C are diagrams illustrating a method for manufacturing a secondary battery.

FIG. 33 is a graph showing a temperature rise in a secondary battery.

FIG. 34A and FIG. 34B are diagrams illustrating a nail penetration test.

FIG. 35 is a graph showing a temperature rise in a secondary battery when an internal short circuit occurs.

FIG. 36A to FIG. 36H are diagrams illustrating examples electronic devices.

FIG. 37A to FIG. 37D are diagrams illustrating examples electronic devices.

FIG. 38A to FIG. 38C are diagrams illustrating examples of electronic devices.

FIG. 39A to FIG. 39C are diagrams illustrating examples of vehicles.

### MODE FOR CARRYING OUT THE INVENTION

Examples of embodiments of the present invention will be described below with reference to the drawings and the like. Note that the present invention should not be interpreted as being limited to the examples of embodiments given below. Embodiments of the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations; in this specification and the like, because of format limitations, space groups, crystal planes, and crystal orientations are sometimes expressed by placing “-” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure in some cases. In some cases, not only (hkl) but also (hkil) is used as the Miller index. Here, i is −(h+k). In this specification and the like, a crystal plane or the like in the space group R-3m is represented with use of a composite hexagonal lattice, unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., x in LixCoO₂. In the case of a positive electrode active material in a secondary battery, x=(theoretical capacity−charge capacity)/theoretical capacity can be satisfied. For example, in the case where a secondary battery using LiCoO₂ as a positive electrode active material is charged to 219.2 mAh/g, the positive electrode active material can be represented by Li_{0.2}CoO₂ or x=0.2. Small x in LixCoO₂ means, for example, 0.1<x≤0.24. The amount of lithium extracted from a positive electrode active material with respect to the theoretical capacity is referred to as charge depth in some cases. In this specification and the like, the charge depth is represented by 1−x.

Lithium cobalt oxide to be used for a positive electrode, which has been appropriately synthesized and almost satisfies the stoichiometric proportion, is LiCoO₂ with x of 1. Even after discharge of a secondary battery ends, the lithium cobalt oxide can be called LiCoO₂ with x of 1. Here, “discharge ends” means that a voltage becomes 3.0 V or 2.5 V or lower at a current of 100 mA/g or lower, for example.

Charge capacity and/or discharge capacity used for calculation of x in LixCoO₂ is preferably measured under the condition where there is no influence or small influence of a short circuit and/or decomposition of an electrolyte solution or the like. For example, data of a secondary battery containing a sudden capacity change that seems to result from a short circuit should not be used for calculation of x.

The space group of a crystal structure is identified by XRD, electron diffraction, neutron diffraction, or the like. Thus, in this specification and the like, belonging to a space group, being attributed to a space group, or being a space group can be rephrased as being identified as a space group.

Note that in this specification and the like, a structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

The distribution of an element refers to the region where the element is successively detected by a successive analysis method to the extent that the detection value is no longer on the noise level. The region where the element is successively detected to the extent that the detection value is no longer on the noise level can be rephrased as, for example, the region where the element is detected every time the analysis is performed.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a decrease in charge and discharge capacity due to repeated charging and discharging.

A short circuit of a secondary battery might cause not only a malfunction in charge operation and/or discharge operation of the secondary battery but also heat generation and ignition. In order to obtain a safe secondary battery, a short-circuit current is preferably inhibited even at a high charge voltage. With the positive electrode active material of one embodiment of the present invention, short-circuit current is inhibited even at a high charge voltage. Thus, a secondary battery having a high discharge capacity and a high level of safety can be obtained. The positive electrode active material of one embodiment of the present invention has a unique effect that release of oxygen is inhibited, which presumably inhibits oxidation reaction of an electrolyte solution and suppresses heat generation. Moreover, the positive electrode active material of one embodiment of the present invention is expected to reduce the speed of current flowing into the positive electrode in the case of an internal short circuit and to have a significant effect that thermal runaway and resultant ignition or the like are less likely to occur.

Note that the description is made on the assumption that materials (such as a positive electrode active material, a negative electrode active material, an electrolyte, and a separator) of a secondary battery have not been degraded unless otherwise specified. A decrease in discharge capacity due to aging treatment and burn-in treatment during the manufacturing process of a secondary battery is not regarded as deterioration. For example, the case where discharge capacity is higher than or equal to 97% of the rated capacity of a lithium-ion secondary battery cell and an assembled lithium-ion secondary battery (hereinafter, referred to as a lithium-ion secondary battery) can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

Note that in this specification and the like, in some cases, materials included in a secondary battery that have not been degraded are referred to as initial products or materials in an initial state, and materials that have been degraded (have discharge capacity lower than 97% of the rated capacity of the secondary battery) are referred to as products in use, materials in a used state, products that are already used, or materials in an already-used state.

### Embodiment 1

In this embodiment, a method for forming a positive electrode active material of one embodiment of the present invention will be described.

The positive electrode active material of one embodiment of the present invention contains lithium, cobalt, oxygen, and an additive element.

The additive element preferably forms a solid solution with the positive electrode active material of one embodiment of the present invention. The positive electrode active material of one embodiment of the present invention preferably contains the additive element in its surface portion. The surface portion can be rephrased as the vicinity of a surface, a region in the vicinity of a surface, or a shell.

In the positive electrode active material of one embodiment of the present invention, the concentration of the additive element in the surface portion is preferably higher than that in the inner portion. The inner portion can be rephrased as an inner region or a core. In some cases, the additive element is not detected in the inner portion of the positive electrode active material of one embodiment of the present invention.

Note that peaks of the detected amounts of the additive elements in the surface portion of the positive electrode active material of one embodiment of the present invention are exhibited at different depths in some cases.

The positive electrode active material of one embodiment of the present invention can be formed by, for example, forming a composite oxide containing lithium, cobalt, and oxygen and then adding an additive element to the composite oxide. The addition of the additive element can be performed by, for example, forming a mixture of the formed composite oxide and an additive element source and heating the mixture. In that case, the additive element with a high diffusion rate in the composite oxide may be added to a deep region from the surface of the positive electrode active material.

The positive electrode active material can also be formed by adding the additive element at the same time as formation of the composite oxide containing lithium, cobalt, and oxygen. Specifically, for example, a lithium source, a cobalt source, and an additive element source can be mixed to form a composite oxide containing the additive element as the positive electrode active material. In such a method, however, it is difficult to make the concentration of the additive element in the surface portion higher than that in the inner portion.

By contrast, in a method in which a composite oxide is formed and then an additive element is added to the composite oxide, it is easy to make the concentration of the additive element in the surface portion higher than that in the inner portion. For this reason, the method is further preferable as a method for forming a positive electrode active material of one embodiment of the present invention.

In the case where a plurality of additive elements are added, the additive elements can be added in different steps. For example, a composite oxide containing lithium, cobalt, and oxygen is formed and then the composite oxide and a first additive element source are mixed and heated. After that, a second additive element source is added and heating is performed. Note that the number of additive element sources is not limited to two.

Alternatively, different additive elements may be added in the same step. For example, a composite oxide containing lithium, cobalt, and oxygen is formed and then the composite oxide, a first additive element source, and a second additive element source are mixed and heated. The number of additive element sources is not limited to two, and three or more additive element sources may be mixed.

Here, as the composite oxide containing lithium, cobalt, and oxygen, a composite oxide having a layered rock-salt crystal structure belonging to R-3m is preferably used.

As the additive element, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used.

### [Magnesium and Nickel]

The positive electrode active material of one embodiment of the present invention preferably contains magnesium and nickel.

In a method for forming a positive electrode active material of one embodiment of the present invention, a composite oxide containing lithium, cobalt, and oxygen is formed and then the composite oxide, a first additive element source, and a second additive element source are mixed and heated, for example. In this case, the composite oxide containing lithium, cobalt, and oxygen preferably has a layered rock-salt crystal structure belonging to R-3m, and when magnesium is used as the first additive element and nickel is used as the second additive element, a magnesium source and a nickel source are preferably added in the same step, for example.

In that case, it is further preferable that fluoride functioning as a fusing agent be mixed in addition to the additive element sources. In other words, a formation process of a positive electrode active material of one embodiment of the present invention preferably includes a step of forming a composite oxide containing lithium, cobalt, and oxygen, a step of mixing the composite oxide, a magnesium source, a nickel source, and fluoride to form a mixture, and a step of heating the mixture, and the composite oxide containing lithium, cobalt, and oxygen preferably has a layered rock-salt crystal structure belonging to R-3m.

Here, the composite oxide containing lithium, cobalt, and oxygen is, for example, a composite oxide represented by LiMeO₂ (Me is a metal). Here, the metal Me is cobalt, for example. That is, the composite oxide containing lithium, cobalt, and oxygen is lithium cobalt oxide represented by LiCoO₂, for example. Alternatively, as the metal Me, a transition metal can be used in addition to cobalt. For example, as the metal Me, one or two selected from nickel and manganese may be used in addition to cobalt. Cobalt is preferably used at higher than or equal to 75 at %, further preferably higher than or equal to 90 at % as the metal Me, in which case many advantages such as relatively easy synthesis, easy handling in a synthesis process, and excellent cycle performance are offered.

The positive electrode active material of one embodiment of the present invention, which is formed by adding an additive element to a composite oxide, preferably has a layered rock-salt crystal structure belonging to the space group R-3m. Note that the composition of LiMeO₂ is not strictly limited to Li:Me:O=1:1:2.

In the positive electrode active material, the distribution, composition, and the like of the additive element change depending on the way of adding the additive element in the formation process. By devising a method for forming a positive electrode active material, a positive electrode active material with favorable internal crystallinity can be obtained.

In the formation process of the positive electrode active material of one embodiment of the present invention, it is preferable that a composite oxide represented by LiMeO₂ be synthesized first and then an additive element source be mixed, followed by heat treatment. The case where the metal Me is cobalt is described below as a specific example.

In a method for synthesizing lithium cobalt oxide containing an additive element by mixing an additive element source simultaneously with a cobalt source and a lithium source, it is sometimes difficult to increase the concentration of the additive element in the surface portion. In addition, after lithium cobalt oxide is synthesized, only mixing an additive element source without performing heating causes the additive element to be just attached to the lithium cobalt oxide without forming a solid solution therewith. It is difficult to distribute the additive element favorably without sufficient heating. Thus, synthesis of lithium cobalt oxide preferably precedes mixing of an additive element source and heat treatment, in which case the concentration of the additive element can be higher in the surface portion than in the inner position. The heat treatment after mixing of the additive element source may be referred to as annealing.

Magnesium is divalent, and a magnesium ion is more stable in lithium sites than in cobalt sites in a layered rock-salt crystal structure; thus, magnesium is likely to enter the lithium sites. However, when a large amount of magnesium is added, magnesium can enter the cobalt sites in addition to the lithium sites.

Magnesium in the lithium sites has an effect of maintaining a layered rock-salt crystal structure belonging to R-3m when x in LixCoO₂ is reduced in charging of a secondary battery. By contrast, magnesium in the cobalt sites is less effective in maintaining the layered rock-salt crystal structure belonging to R-3m when x in LixCoO₂ is reduced.

Nickel in a layered rock-salt crystal structure of LiMeO₂ can exist in both cobalt sites and lithium sites. Addition of nickel to a region to which magnesium is added is expected to inhibit entry of magnesium into the cobalt sites and keep the crystal structure of a positive electrode active material stable.

As described above, nickel is also preferably added to the region to which magnesium is added. Thus, the distribution of magnesium and that of nickel preferably overlap with each other. In the method for forming a positive electrode active material, magnesium and nickel are added in the same step, whereby the concentration distribution of magnesium in the depth direction and that of nickel in the depth direction can overlap with each other, for example. Here, the concentration distribution of an additive in the depth direction can be evaluated by, for example, performing EDX line analysis from the surface toward the inner portion in a cross section of the positive electrode active material. The expression “the concentration distribution of magnesium in the depth direction and that of nickel in the depth direction overlap with each other” means that a region where magnesium is detected and a region where nickel is detected overlap with each other in the EDX line analysis.

When nickel exists in cobalt sites, higher charge and discharge capacity can be obtained in some cases, which will be described in detail later. In addition, when nickel exists in lithium sites, a shift in a layered structure formed of octahedrons of cobalt and oxygen can be inhibited, contributing to a stable crystal structure. Thus, it can be said that nickel contributes to an improvement in performance of the positive electrode active material when added to either the cobalt sites or the lithium sites.

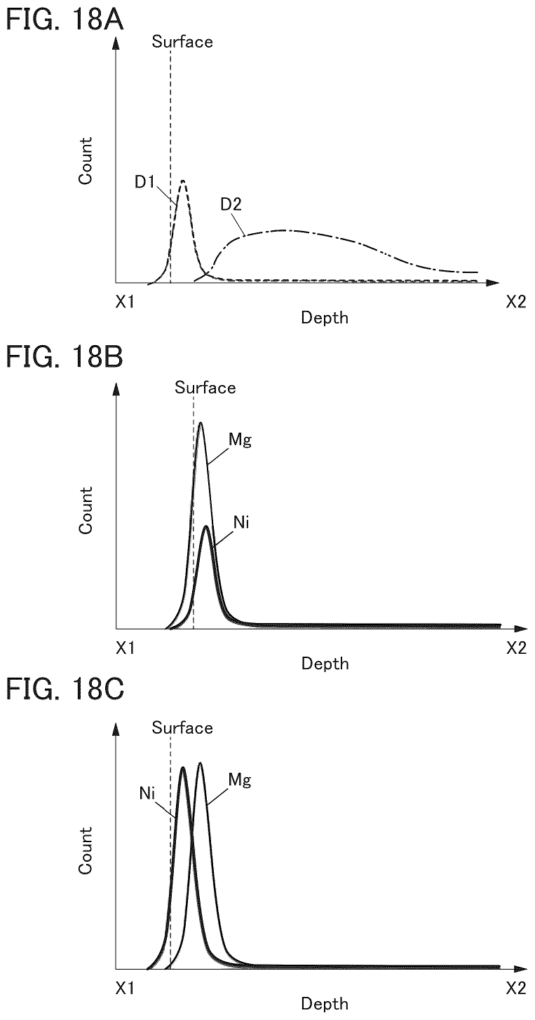

Here, nickel is preferably contained in the surface portion at a high concentration together with magnesium, in which case the crystal structure of the positive electrode active material is expected to remain stable. Meanwhile, nickel may be widely distributed in a deeper region, e.g., the inner portion of the positive electrode active material in addition to existing at a high concentration in the surface portion of the positive electrode active material. For example, as shown in FIG. 18A, which will be described later, nickel may have a distribution represented by the sum of the distribution D1 having a peak of the detected amount with a small width in the surface portion and the distribution D2 widely distributed in a region deeper than the distribution D1, e.g., the inner portion of the positive electrode active material. The charge and discharge capacity of a secondary battery is expected to be increased by widely distributing nickel in the inner portion, for example.

Simultaneous addition of two or more additive elements may also be preferable in terms of a decrease in heating temperature in formation of a positive electrode active material. Favorable distribution of the additive element is difficult unless adequate heating follows the mixing of the additive element source with lithium cobalt oxide. However, annealing at an excessively high temperature may cause cation mixing, which increases the possibility of entry of the additive element such as magnesium into the cobalt sites. Furthermore, heat treatment at an excessively high temperature might have an adverse effect; for example, cobalt might be reduced to have a valence of two or lithium might be evaporated.

When a mixture of lithium cobalt oxide, a magnesium source, and a nickel source is formed and heated in a formation process of a positive electrode active material, the melting point drop of the lithium cobalt oxide or the like might occur due to the mixing of the magnesium source and the nickel source. The melting point drop facilitates favorable distribution of magnesium and nickel in the lithium cobalt oxide at a temperature at which cation mixing is unlikely to occur.

In addition, divalent nickel can exist more stably in the vicinity of divalent magnesium. By adding the magnesium source and the nickel source in the same step, for example, magnesium and nickel are placed close to each other and divalent magnesium is made to exist stably, so that dissolution of magnesium can be inhibited.

Fluoride is preferably used as the additive element source. When mixed with a different additive element source, the fluoride can function as a fusing agent (also referred to as a flux) that lowers the melting point of the different additive element source and the melting point of lithium cobalt oxide.

A material functioning as a fusing agent may be further mixed together with the additive element source. A material having a lower melting point than lithium cobalt oxide can be regarded as a material functioning as a fusing agent. For example, fluoride such as lithium fluoride is preferably mixed together with the magnesium source and the nickel source. Addition of the fluoride functioning as a fusing agent lowers the melting points of the additive element sources and the lithium cobalt oxide. Lowering the melting points makes it easier to favorably distribute the additive element at a temperature at which cation mixing is unlikely to occur.

In the method for forming a positive electrode active material of one embodiment of the present invention, magnesium fluoride can be used as a magnesium source, nickel fluoride can be used as a nickel source, and lithium fluoride can be used as a fusing agent.

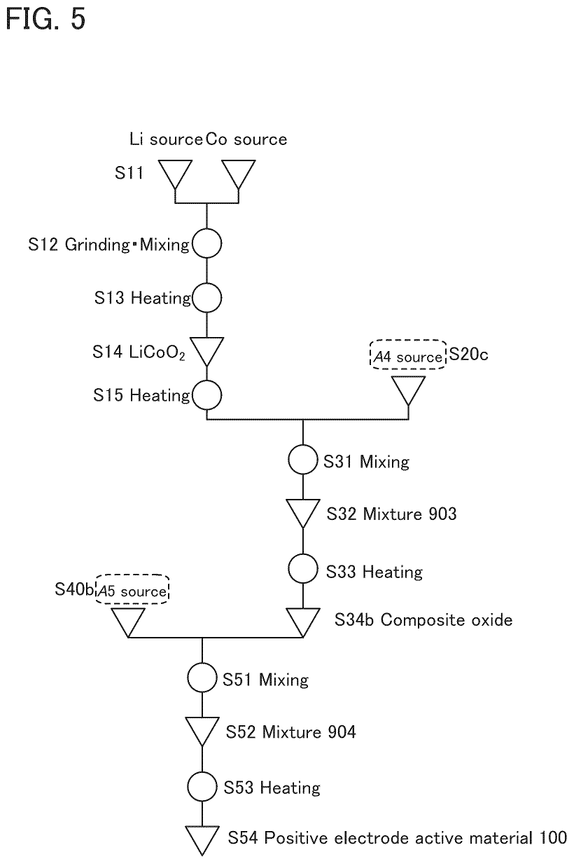

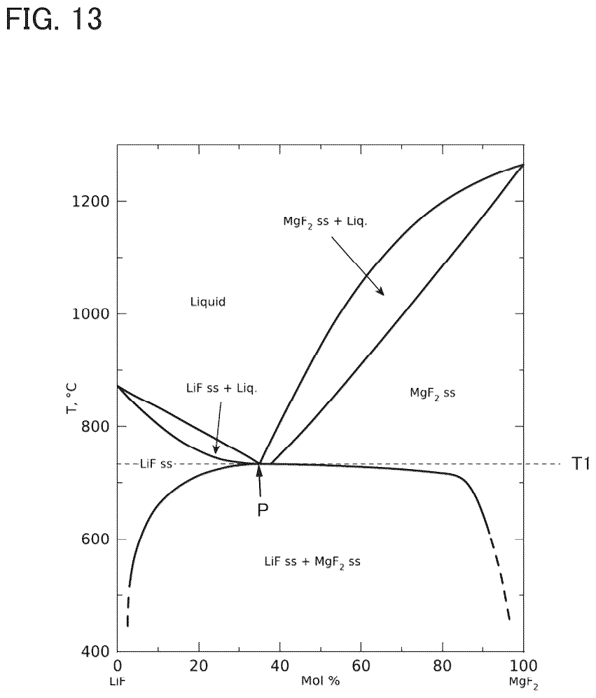

The eutectic point of magnesium fluoride that is a magnesium source and lithium fluoride that is a fusing agent is described. The eutectic point P of LiF and MgF₂ is around 742° C. (T1) as shown in FIG. 13 (cited from FIG. 5 of Non-Patent Document 12 and retouched).

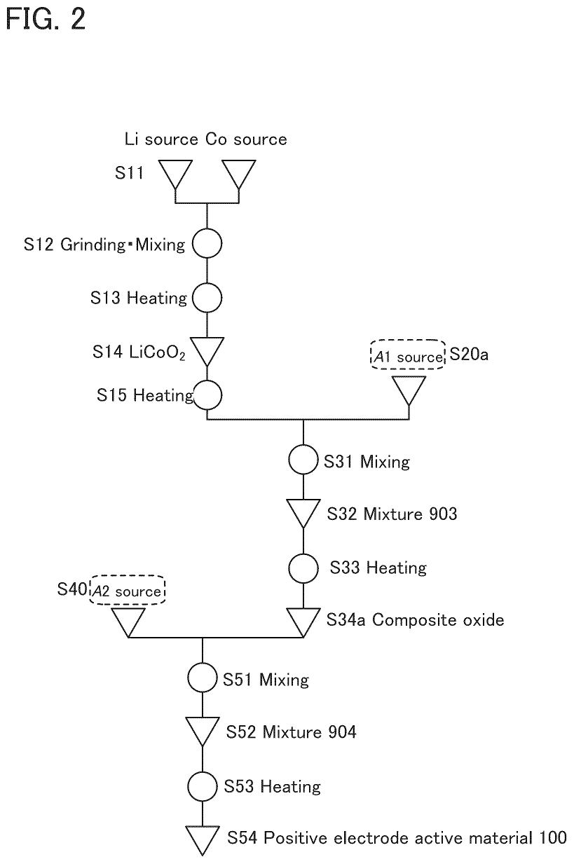

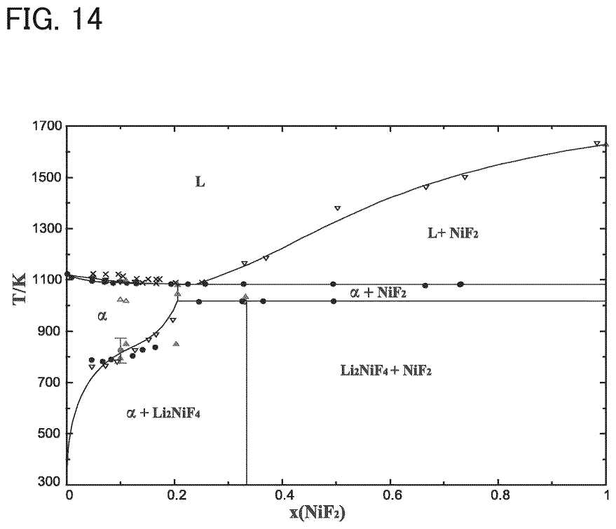

The eutectic point of nickel fluoride that is a nickel source and lithium fluoride that is a fusing agent is described. As shown in FIG. 14 (cited from FIG. 2 of Non-Patent Document 13), the eutectic point of LiF and NiF₂ is in the range of 1060 [K] to 1065 [K](in the range of 787° C. to 792° C.) at a content of NiF₂ (the horizontal axis x in FIG. 14) of 0.2, for example.

FIG. 13 and FIG. 14 show the eutectic point of the fusing agent and each additive element source. The melting points might be further lowered in the case where three materials of magnesium fluoride, nickel fluoride, and lithium fluoride are mixed in the method for forming a positive electrode active material of one embodiment of the present invention.

Note that the depth at which the additive element is added also depends on the orientation of the plane exposed at the surface of lithium cobalt oxide.

In a layered rock-salt crystal structure belonging to R-3m, cations are arranged parallel to the (001) plane. Such a structure can be regarded as a structure in which CoO₂ layers and lithium layers are alternately stacked parallel to the (001) plane. A diffusion path for lithium ions exists parallel to the (001) plane.

In the layered rock-salt crystal structure belonging to R-3m, magnesium and nickel are likely to diffuse in a direction parallel to the (001) plane.

In the case where the (001) plane is exposed at the surface of lithium cobalt oxide, a path along the direction parallel to the (001) plane is not exposed at the surface; thus, magnesium and nickel are regarded as being less likely to enter the lithium cobalt oxide.

By contrast, in the case where a plane other than the (001) plane is exposed at the surface of lithium cobalt oxide, a path along the direction parallel to the (001) plane is exposed at the surface. Thus, magnesium and nickel are regarded as being more likely to enter the lithium cobalt oxide and being able to diffuse more deeply in the case where the plane other than the (001) plane is exposed at the surface than in the case where the (001) plane is exposed at the surface.

Here, the (001) plane, the (003) plane, and the like are sometimes collectively referred to as the (001) plane. The (00/) plane is sometimes referred to as a basal plane, a C-plane, or the like. A plane other than the (00) plane is sometimes referred to as an edge plane.

The CoO₂ layer is relatively stable; thus, the surface of a positive electrode active material is highly stable when having the (001) plane. By contrast, a diffusion path for lithium ions is exposed at a surface having an orientation other than the (001) orientation. The surface having an orientation other than the (001) orientation is regarded as being likely to be unstable because it is a region where extraction of lithium ions starts.

It is thus extremely important to increase the concentrations of magnesium and nickel to inhibit collapse of the crystal structure due to extraction of lithium caused by charging in the surface having an orientation other than the (001) orientation and the surface portion.

The method for forming a positive electrode active material of one embodiment of the present invention enables the concentrations of magnesium and nickel to be significantly increased in the case where the surface of the surface portion has an orientation other than the (001) orientation. In the method for forming a positive electrode active material of one embodiment of the present invention, magnesium and nickel are added in the same step, whereby the concentration of nickel can also be increased in a region with a high concentration of magnesium; thus, entry of magnesium into cobalt sites can be inhibited, the crystal structure of the positive electrode active material is expected to remain stable, and collapse of the crystal structure of the positive electrode active material due to repeated charging and discharging of a secondary battery can be extremely small.

### [Aluminum]

The positive electrode active material of one embodiment of the present invention can contain aluminum. Aluminum can exist in cobalt sites in a layered rock-salt crystal structure. Note that aluminum can contribute to inhibition of a change in the crystal structure, dissolution of cobalt, and the like, which will be described in detail later.

In the method for forming a positive electrode active material of one embodiment of the present invention, mixing of an aluminum source and heating after the mixing are performed in a step different from that of mixing of a magnesium source and a nickel source and heating after the mixing. Alternatively, the aluminum source may be mixed together with the magnesium source and the nickel source.

### [Fluorine]

In the method for forming a positive electrode active material of one embodiment of the present invention, fluoride is preferably used as an additive element source. Fluoride that can function as a fusing agent in addition to an additive element source can be used. When a positive electrode active material is formed using fluoride, a positive electrode active material containing fluorine can be obtained. When the positive electrode active material contains fluorine, an effect of facilitating extraction and insertion of lithium ions, an effect of inhibiting an excess reaction with an electrolyte solution, and the like can be obtained, which will be described in detail later. In the method for forming a positive electrode active material of one embodiment of the present invention, fluorine may be used instead of or in addition to fluoride. When fluorine is contained in a surface portion of the positive electrode active material of one embodiment of the present invention, ignition or heating of a lithium-ion secondary battery can be inhibited and thermal safety can be further improved. Moreover, when fluorine is contained in the surface portion of the positive electrode active material of one embodiment of the present invention, oxygen in the positive electrode active material is less likely to be released and a thermal decomposition reaction can be inhibited in some cases.

### [Other Additive Elements]

The positive electrode active material of one embodiment of the present invention can contain titanium. The positive electrode active material that contains titanium oxide in the surface portion can have good wettability with respect to a high-polarity solvent.

The positive electrode active material of one embodiment of the present invention can contain phosphorus. When phosphorus is contained in the surface portion, a short circuit can sometimes be inhibited in the case where the positive electrode active material is held in a charged state. Hydrogen fluoride generated by decomposition of an electrolyte solution or an electrolyte reacts with phosphorus contained in the positive electrode active material, decreasing the concentration of hydrogen fluoride in the electrolyte in some cases. In the case where the positive electrode active material has a crack on its surface, crack development can be inhibited by a compound containing phosphorus contained in the inner portion of the positive electrode active material.

### [Initial Heating]

It is further preferable that heating be performed between synthesis of lithium cobalt oxide and mixing of the additive elements. This heating is referred to as initial heating in some cases.

Since lithium is extracted from part of the surface portion of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion by the initial heating. Next, lithium cobalt oxide including the surface portion that is deficient in lithium and the additive element sources such as a nickel source, an aluminum source, and a magnesium source are mixed and heated. Among the additive elements, magnesium is a divalent representative element, and nickel is a transition metal but is likely to be a divalent ion. Therefore, in part of the surface portion, a rock-salt phase containing Co²⁺, which is reduced due to lithium deficiency, Mg²⁺, and Ni²⁺ is formed. Note that this phase is formed in part of the surface portion, and thus is sometimes not clearly observed in an electron microscope image, such as a STEM (scanning transmission electron microscope) image, and an electron diffraction pattern.

Among the additive elements, nickel is likely to form a solid solution and is diffused to the inner portion in the case where the surface portion is the lithium cobalt oxide that has a layered rock-salt crystal structure, but nickel is likely to remain in the surface portion in the case where part of the surface portion has a rock-salt crystal structure. Thus, the initial heating can make it easy for a divalent additive element such as nickel to remain in the surface portion. The effect of this initial heating is large particularly at the surface having an orientation other than the (001) orientation of the positive electrode active material and the surface portion thereof.

Furthermore, in such a rock-salt crystal structure, the bond distance between a metal Me and oxygen (Me-O distance) tends to be longer than that in a layered rock-salt crystal structure.

For example, Me-O distance is 2.09 Å and 2.11 Å in Ni_{0.5}Mg_{0.5}O having a rock-salt crystal structure and MgO having a rock-salt crystal structure, respectively. Even when a spinel phase is formed in part of the surface portion 100a, Me-O distance is 2.0125 Å and 2.02 Å in NiAl₂O₄ having a spinel structure and MgAl₂O₄ having a spinel structure, respectively. In each case, Me-O distance is longer than 2 Å. Note that 1 Å=10⁻¹⁰ m.

Meanwhile, in a layered rock-salt crystal structure, the bond distance between oxygen and a metal other than lithium is shorter than the above-described distance. For example, Al—O distance is 1.905 Å (Li—O distance is 2.11 Å) in LiAlO₂ having a layered rock-salt crystal structure. In addition, Co—O distance is 1.9224 Å (Li—O distance is 2.0916 Å) in LiCoO₂ having a layered rock-salt crystal structure.

According to Shannon's ionic radii (Shannon et al., Acta A 32 (1976) 751.), the ion radius of hexacoordinated aluminum and the ion radius of hexacoordinated oxygen are 0.535 Å and 1.4 Å, respectively, and the sum of those values is 1.935 Å.

From the above, aluminum can be considered to exist at sites other than lithium sites more stably in a layered rock-salt crystal structure than in a rock-salt crystal structure. Thus, in the surface portion, aluminum is more likely to be distributed in a region having a layered rock-salt phase at a larger depth and/or the inner portion than in a region having a rock-salt phase that is close to the surface.

Moreover, the initial heating can be expected to have an effect of increasing the crystallinity of the layered rock-salt crystal structure of the inner portion.

For this reason, the initial heating is preferably performed in order to fabricate the positive electrode active material that has the monoclinic O1(15) type crystal structure particularly when x in LixCoO₂ is, for example, greater than or equal to 0.15 and less than or equal to 0.17.

However, the initial heating is not necessarily performed. In some cases, by controlling the atmosphere, temperature, time, or the like in another heating step, e.g., annealing, a positive electrode active material 100 that has the O3′ type structure and/or the monoclinic O1(15) type structure when x in LixCoO₂ is small can be formed.

### <<Formation Method 1 of Positive Electrode Active Material>>

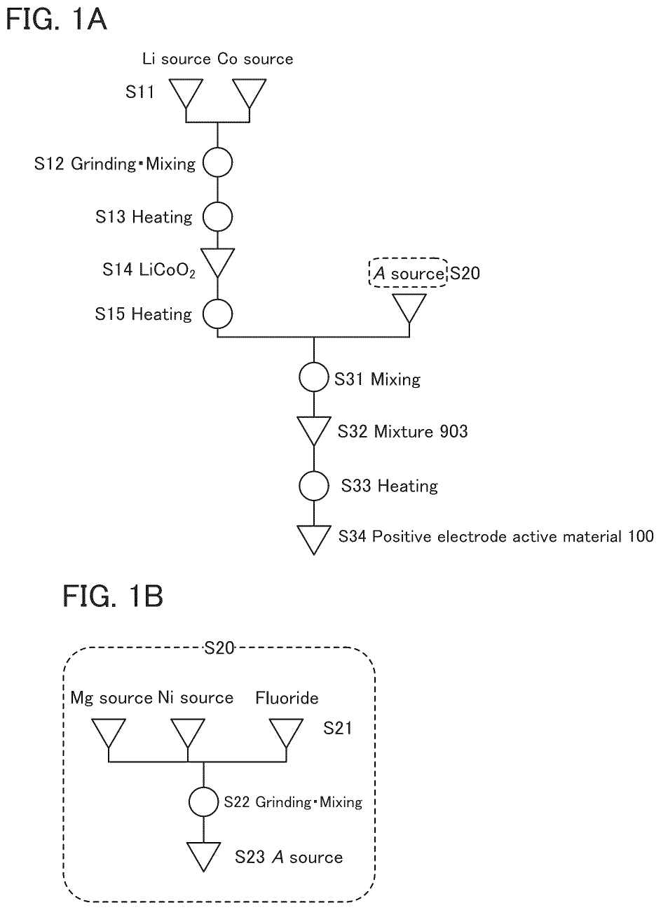

A formation method 1 of the positive electrode active material 100, in which annealing and the initial heating are performed, will be described with reference to FIG. 1A and FIG. 1B.

### <Step S11>

In Step S11 shown in FIG. 1A, a lithium source (Li source) and a cobalt source (Co source) are prepared as materials for lithium and a transition metal that are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide, cobalt hydroxide, or the like can be used.

The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and/or improved reliability can be obtained.

Furthermore, the cobalt source preferably has high crystallinity, and preferably includes single crystal particles, for example. The crystallinity of the cobalt source can be evaluated with a TEM (transmission electron microscope) image, a STEM image, a HAADF-STEM (high-angle annular dark-field scanning transmission electron microscope) image, or an ABF-STEM (annular bright-field scanning transmission electron microscope) image or by X-ray diffraction (XRD), electron diffraction, neutron diffraction, or the like. Note that the above methods for evaluating crystallinity can also be employed to evaluate the crystallinity of other materials in addition to the cobalt source.

### <Step S12>

Next, in Step S12 shown in FIG. TA, the lithium source and the cobalt source are ground and mixed to form a mixed material. The grinding and mixing can be performed by a dry method or a wet method. A wet method is preferable because it can crush a material into a smaller size. When a wet method is employed, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% for the grinding and mixing. With the use of dehydrated acetone with the above-described purity, impurities that might be mixed can be reduced.

A ball mill, a bead mill, or the like can be used as a means of the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. TA, the above mixed material is heated. The heating is preferably performed at a temperature higher than or equal to 800° C. and lower than or equal to 1100° C., further preferably at a temperature higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. A method of continuously introducing oxygen into a reaction chamber to make oxygen flow therein is referred to as flowing.

In the case where the heating atmosphere is an oxygen-containing atmosphere, flowing is not necessarily performed. For example, a method may be employed in which the pressure in the reaction chamber is reduced, the reaction chamber is filled (which may also be referred to as purged) with oxygen, and the oxygen is prevented from entering or exiting from the reaction chamber. For example, the pressure in the reaction chamber may be reduced to −970 hPa and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

This heating step may be performed with a rotary kiln or a roller hearth kiln. Heating with stirring can be performed in either case of a sequential rotary kiln or a batch-type rotary kiln.

As a crucible used at the time of the heating, a crucible made of aluminum oxide is preferable. A crucible made of aluminum oxide has a material property that hardly releases impurities. In this embodiment, a crucible made of aluminum oxide with a purity of 99.9% is used. The heating is preferably performed with the crucible covered with a lid. This can prevent volatilization of a material.

A crucible that has been used a plurality of times is preferred to a new crucible. In this specification and the like, a new crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. The reason is that, in the case where a new crucible is used, some materials such as lithium fluoride might be absorbed by, diffused in, transferred to, and/or attached to the crucible. By contrast, such a risk is low in the case of a used crucible.

The heated material is ground as needed and may be made to pass through a sieve. Before collection of the heated material, the material may be moved from the crucible to a mortar. As the mortar, a mortar made of zirconium oxide or agate is suitably used. As the mortar, an aluminum oxide mortar can be suitably used. An aluminum oxide mortar has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized as Step S14 shown in FIG. TA.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, as Step S15 shown in FIG. 1A, the lithium cobalt oxide is heated. The heating in Step S15 is the first heating performed on the lithium cobalt oxide and thus is sometimes referred to as initial heating. The heating is performed before Step S20 described below and thus is sometimes referred to as preheating or pretreatment.

By the initial heating, lithium is extracted from part of the surface portion of the lithium cobalt oxide as described above. In addition, an effect of increasing the crystallinity of the inner portion can be expected. The lithium source and/or the cobalt source prepared in Step S11 and the like might contain impurities. The initial heating can reduce impurities in the lithium cobalt oxide completed in Step S14.

Through the initial heating, an effect of smoothing the surface of the lithium cobalt oxide is obtained. A smooth surface of lithium cobalt oxide refers to a state where the composite oxide has little unevenness and is rounded as a whole and its corner portion is rounded. A smooth surface also refers to a surface to which few foreign substances are attached. Foreign substances are deemed to cause unevenness and are preferably not attached to a surface.

For the initial heating, there is no need to prepare a lithium compound source. For the initial heating, there is no need to prepare the additive element source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected to perform the heating. As a supplementary explanation of the heating conditions, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the inner portion is, for example, an effect of reducing distortion, a shift, or the like derived from differential shrinkage or the like of the lithium cobalt oxide formed in Step S13.

The heating in Step S13 might cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it can be deemed that Step S15 reduces the shift in a crystal or the like which is caused in the composite oxide and makes the surface of the composite oxide smooth.

In a secondary battery including lithium cobalt oxide with a smooth surface as a positive electrode active material, degradation by charging and discharging is inhibited and a crack in the positive electrode active material can be prevented.

Note that pre-synthesized lithium cobalt oxide may be used in Step S14. In that case, Step S11 to Step S13 can be omitted. When Step S15 is performed on the pre-synthesized lithium cobalt oxide, lithium cobalt oxide with a smooth surface can be obtained.

### <Step S20>

Next, as shown in Step S20, an additive element A source (A source) is preferably added to the lithium cobalt oxide that has been subjected to the initial heating. Here, magnesium and nickel are preferably added as the additive element A. When the additive element is added to the lithium cobalt oxide that has been subjected to the initial heating, the additive element can be uniformly added. It is thus preferable that the initial heating precede the addition of the additive element. The step of adding the additive element A is described with reference to FIG. 1B.

### <Step S21>

In Step S21 shown in FIG. 1B, a magnesium source (Mg source) and a nickel source (Ni source) to be added to the lithium cobalt oxide are prepared. Fluoride is preferably prepared together with the magnesium source and the nickel source.

As the magnesium source, magnesium fluoride, magnesium oxide, magnesium hydroxide, magnesium carbonate, or the like can be used. Two or more of these magnesium sources may be used.

As the nickel source, nickel fluoride, nickel oxide, nickel hydroxide, or the like can be used. Two or more of these nickel sources may be used.

As the fluoride, for example, lithium fluoride (LiF), magnesium fluoride (MgF₂), nickel fluoride (NiF₂), aluminum fluoride (AlF₃), titanium fluoride (TiF₄), cobalt fluoride (CoF₂ and CoF₃), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C. Note that the fluoride can function as a fluorine source.

Magnesium fluoride can be used as both the magnesium source and the fluorine source. Nickel fluoride can be used as both the nickel source and the fluorine source. Lithium fluoride can be used as both the lithium source and the fluorine source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluoride, magnesium fluoride (MgF₂) is prepared as the magnesium source, and nickel fluoride (NiF₂) is prepared as the nickel source.

When lithium fluoride and magnesium fluoride are mixed at approximately LiF:MgF₂=65:35 (molar ratio), the effect of lowering the melting point is maximized.

Lithium fluoride and nickel fluoride can have a favorably low melting point and exist stably as a liquid without NiF₂ being excessive when mixed at LiF:NiF₂=0.8:0.2 (molar ratio) and the neighborhood thereof.

Meanwhile, when the proportion of lithium fluoride increases, an excessive amount of lithium might degrade cycle performance.

The molar ratio of lithium fluoride to magnesium fluoride and nickel fluoride is LiF:MgF₂:NiF₂=x:1:y. For example, x is greater than or equal to 0 and less than or equal to 10, greater than or equal to 0 and less than or equal to 5, greater than or equal to 0 and less than or equal to 3, greater than or equal to 0 and less than or equal to 2, greater than or equal to 0 and less than or equal to 1, or greater than or equal to 0 and less than or equal to 0.5. For example, y is greater than 0 and less than or equal to 3 or greater than or equal to 0.2 and less than or equal to 2.

### <Step S22>

Next, in Step S22 shown in FIG. 1B, the magnesium source, the nickel source, and the fluoride are ground and mixed. Any of the conditions for grinding and mixing that are described for Step S12 can be selected to perform this step.

### <Step S23>

Next, in Step S23 shown in FIG. 1B, the materials ground and mixed in the above step are collected to obtain the additive element A source (A source). Note that the additive element A source shown in Step S23 contains a plurality of starting materials and can be referred to as a mixture.

As for the particle diameter of the mixture, D50 (median diameter) is preferably greater than or equal to 600 nm and less than or equal to 10 μm, further preferably greater than or equal to 1 μm and less than or equal to 5 μm. Also when one kind of material is used as the additive element source, D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of lithium cobalt oxide particles uniformly in a later step of mixing with the lithium cobalt oxide. The mixture is preferably attached uniformly to the surface of the lithium cobalt oxide particles, in which case the additive element is easily distributed or dispersed uniformly in the surface portion of the composite oxide after heating.

### <Step S31>

Next, in Step S31 shown in FIG. TA, the lithium cobalt oxide and the additive element A source (A source) are mixed. The atomic ratio of cobalt Co in the lithium cobalt oxide to magnesium Mg in the additive element A source is preferably Co:Mg=100:z (0.1≤z≤6), further preferably M:Mg=100:z (0.3≤z≤3).

The conditions of the mixing in Step S31 are preferably milder than those of the mixing in Step S12 in order not to damage the shape of the lithium cobalt oxide particles. For example, conditions with a lower rotational frequency or a shorter time than those for the mixing in Step S12 are preferable. In addition, it can be said that a dry method has a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. TA, the materials mixed in the above step are collected to give a mixture 903. At the time of the collection, the materials may be crushed as needed and made to pass through a sieve.

Note that although FIG. TA and FIG. 1B illustrate the formation method in which addition of the additive element is performed only after the initial heating, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. Then, lithium cobalt oxide containing the additive element can be obtained in Step S13. In that case, there is no need to separately perform Step S11 to Step S14 and Step S21 to Step S23. This method can be regarded as being simple and highly productive.

Alternatively, lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

Alternatively, after the heating in Step S15 is performed, to lithium cobalt oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. TA, the mixture 903 is heated. Any of the heating conditions described for Step S13 can be selected to perform the heating. The heating time is preferably longer than or equal to 2 hours. In that case, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is given. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements contained in the lithium cobalt oxide and the additive element source occurs, and may be lower than the melting temperatures of these materials. It is known that in the case of an oxide as an example, solid phase diffusion occurs at the temperature 0.757 times the melting temperature Tₘ (the Tamman temperature T_{d}). Accordingly, the heating temperature in Step S33 is higher than or equal to 650° C.

Needless to say, the reaction proceeds more easily at a temperature higher than or equal to the temperature at which one or two or more selected from the materials contained in the mixture 903 are melted. For example, in the case where LiF, MgF₂, and NiF₂ are contained in the additive element source, the eutectic point of LiF and MgF₂ is around 742° C. and the eutectic point of LiF and NiF₂ has an extremum at, for example, around 790° C. In the case where three compounds of LiF, MgF₂, and NiF₂ are mixed, a further reduction in the eutectic point is expected; thus, the lower limit of the heating temperature in Step S33 is preferably higher than or equal to 700° C., for example, and may be higher than or equal to 740° C. or higher than or equal to 790° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C.

Note that the heating temperature in Step S33 is preferably higher than that in Step S13.

In addition, at the time of heating the mixture 903, the partial pressure of fluorine or fluoride originating from the fluorine source or the like is preferably controlled to be within an appropriate range.

In the formation method described in this embodiment, some of the materials, e.g., lithium fluoride as the fluorine source, function as a fusing agent in some cases. Owing to this function, the heating temperature can be lower than the decomposition temperature of the lithium cobalt oxide, which allows distribution of the additive element such as magnesium in the surface portion and formation of the positive electrode active material having favorable characteristics.

However, since lithium fluoride in a gas phase has a specific gravity less than that of oxygen, heating might volatilize lithium fluoride and in that case, lithium fluoride in the mixture 903 decreases. As a result, the function of a fusing agent deteriorates. Therefore, heating needs to be performed while volatilization of lithium fluoride is inhibited. Note that even when lithium fluoride is not used as the fluorine source or the like, Li at the surface of LiCoO₂ and F of the fluorine source might react to produce lithium fluoride, which might be volatilized. Thus, such inhibition of volatilization is needed also when fluoride having a higher melting point than lithium fluoride is used.

In view of this, the mixture 903 is preferably heated in an atmosphere containing lithium fluoride, i.e., the mixture 903 is preferably heated in a state where the partial pressure of lithium fluoride in a heating furnace is high. Such heating can inhibit volatilization of lithium fluoride in the mixture 903.

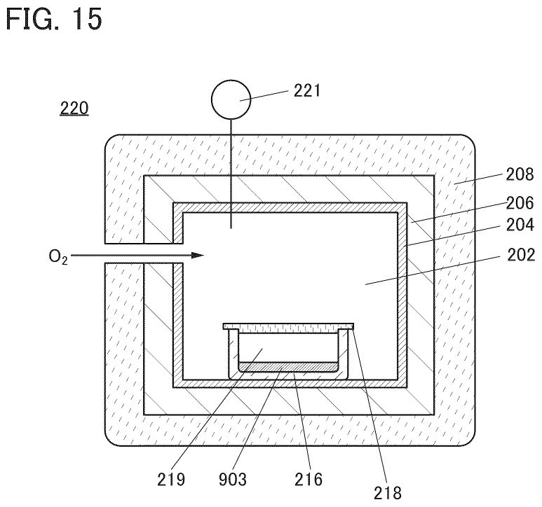

FIG. 15 illustrates an example of a heating furnace that can be used for heating. A heating furnace 220 illustrated in FIG. 15 includes a space 202 in the heating furnace, a hot plate 204, a pressure gauge 221, a heater unit 206, and a heat insulator 208. It is further preferable to perform annealing with a lid 218 put on a container 216. With this structure, a space 219 enclosed by the container 216 and the lid 218 can have an atmosphere containing fluoride. During the annealing, the state of the space 219 is maintained with the lid put on so that the concentration of the gasified fluoride inside the space 219 can be constant or cannot be reduced, in which case fluorine and magnesium can be contained in the vicinity of the particle surface. The atmosphere in the space 219, which is smaller in capacity than the space 202 in the heating furnace, can contain fluoride through volatilization of a smaller amount of fluoride. This means that the atmosphere in the reaction system can contain fluoride without a significant reduction in the amount of fluoride contained in the mixture 903. Accordingly, LiMeO₂ can be produced efficiently. In addition, the use of the lid 218 allows annealing of the mixture 903 in an atmosphere containing fluoride to be simply and inexpensively performed.

Before heating in the space 202 in the heating furnace is performed, a step of providing an atmosphere containing oxygen in the space 202 in the heating furnace and a step of placing the container 216 in which the mixture 903 is placed in the space 202 in the heating furnace are performed. The steps performed in this order enable the mixture 903 to be annealed in an atmosphere containing oxygen and fluoride. For example, flowing of a gas is performed during the annealing. During the annealing, the space 202 in the heating furnace can be sealed to prevent the gas from being discharged to the outside.

Although there is no particular limitation on the method of providing an atmosphere containing oxygen in the space 202 in the heating furnace, examples of the method include a method in which air is exhausted from the space 202 in the heating furnace and an oxygen gas or a gas containing oxygen such as dry air is then introduced and a method in which an oxygen gas or a gas containing oxygen such as dry air is fed into the space 202 in the heating furnace for a certain period of time. In particular, introducing an oxygen gas after exhausting air from the space 202 in the heating furnace (oxygen displacement) is preferably performed. Note that the air of the space 202 in the heating furnace may be regarded as an atmosphere containing oxygen.

The fluoride or the like attached to inner walls of the container 216 and the lid 218 can be fluttered again by the heating to be attached to the mixture 903.

There is no particular limitation on the step of heating the heating furnace 220. The heating may be performed using a heating mechanism included in the heating furnace 220.

Although there is no particular limitation on the way of placing the mixture 903 in the container 216, as illustrated in FIG. 15, the mixture 903 is preferably placed such that the top surface of the mixture 903 is flat on the bottom surface of the container 216, in other words, the level of the top surface of the mixture 903 is uniform.

The heating in Step S33 described above is preferably performed with the pressure in the furnace controlled using the pressure gauge 221. The furnace is preferably in an atmospheric pressure state or a pressurized state. When heating is performed under pressure, the surface of the positive electrode active material 100 becomes smooth; such a positive electrode active material may be less likely to be physically broken by pressure application or the like than a positive electrode active material whose surface is not smooth. For example, the positive electrode active material 100 is unlikely to be broken in a test involving pressure application such as a nail penetration test, meaning that the positive electrode active material 100 has high safety.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing lithium fluoride with the container containing the mixture 903 covered with a lid, for example.

A supplementary explanation of the heating time is given here. The heating time depends on conditions such as the heating temperature and the size and composition of the lithium cobalt oxide in Step S14. In the case where the lithium cobalt oxide is small, the heating is preferably performed at a lower temperature or for a shorter time than in the case where the lithium cobalt oxide is large, in some cases.

In the case where the lithium cobalt oxide in Step S14 in FIG. TA has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the temperature decreasing time after the heating is, for example, preferably longer than or equal to 10 hours and shorter than or equal to 50 hours.

In the case where the lithium cobalt oxide in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the temperature decreasing time after the heating is, for example, preferably longer than or equal to 10 hours and shorter than or equal to 50 hours.

### <Step S34>

Next, in Step S34 shown in FIG. 1A, the heated material is collected and then crushed as need to give the positive electrode active material 100. Here, the collected particles are preferably made to pass through a sieve. Through the above steps, the positive electrode active material 100 of one embodiment of the present invention can be formed. The positive electrode active material of one embodiment of the present invention has a smooth surface.

### <<Formation Method 2 of Positive Electrode Active Material>>

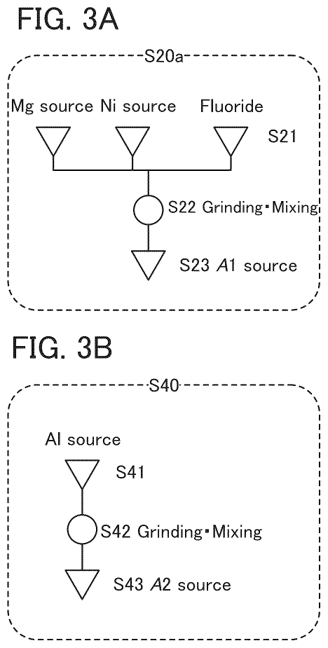

Next, as one embodiment of the present invention, a formation method 2 of a positive electrode active material, which is different from the formation method 1 of a positive electrode active material, will be described with reference to FIG. 2 to FIG. 3B. The formation method 2 of a positive electrode active material is different from the formation method 1 mainly in the number of times of adding additive elements and a mixing method. For the description except for the above, the description of the formation method 1 can be referred to.

Steps S11 to S15 in FIG. 2 are performed as in FIG. 1A to prepare lithium cobalt oxide that has been subjected to the initial heating.

### <Step S20a>

Next, as shown in Step S20a, an additive element A1 is preferably added to the lithium cobalt oxide that has been subjected to the initial heating.

### <Step S21>

In Step S21 shown in FIG. 3A, a magnesium source, a nickel source, and fluoride are prepared. Step S21 to Step S23 shown in FIG. 3A can be performed under the conditions similar to those in Step S21 to Step S23 shown in FIG. 1B. As a result, the additive element source (A1 source) can be obtained in Step S23.

Steps S31 to S33 shown in FIG. 2 can be performed in a manner similar to that of Steps S31 to S33 shown in FIG. 1A.

### <Step S34a>

Next, the material heated in Step S33 is collected to form lithium cobalt oxide containing the additive element A1 in step S34a. This composite oxide is also called a second composite oxide to be distinguished from the composite oxide in Step S14.

### <Step S40>

In Step S40 shown in FIG. 2, an additive element A2 is added. FIG. 3B is referred to in the following description.

### <Step S41>

In Step S41 shown in FIG. 3B, a second additive element source is prepared. As the second additive element source, one or two or more selected from magnesium, fluorine, nickel, aluminum, titanium, zirconium, vanadium, iron, manganese, chromium, niobium, arsenic, zinc, silicon, sulfur, phosphorus, boron, and beryllium is preferably used. Furthermore, one or two selected from bromine and beryllium can be used. For example, one or more selected from aluminum, titanium, boron, and zirconium can be suitably used as the additive element A2.

FIG. 3B shows an example of using an aluminum source (Al source) as the second additive element source. As the aluminum source, aluminum fluoride, aluminum hydroxide, aluminum oxide, or the like can be used.

Here, Ni:Al=w:1 (2≤w≤5) is preferably satisfied.

Step S41 to Step S43 shown in FIG. 3B can be performed under the conditions similar to those in Step S21 to Step S23 shown in FIG. 1B. As a result, the additive element source (A2 source) can be obtained in Step S43.

Note that the A2 source may contain the same additive element as the A1 source.

### <Step S51 to Step S53>

Next, Step S51 to Step S53 shown in FIG. 2 can be performed under the conditions similar to those in Step S31 to Step S34 shown in FIG. 1A. The heating in Step S53 can be performed at a lower temperature and for a shorter time than those of the heating in Step S33. Through the above steps, the positive electrode active material 100 of one embodiment of the present invention can be formed in Step S54.

The concentration distribution of the additive element in the depth direction changes depending on, for example, the heating temperature, the heating time, the temperature rising rate, and the temperature decreasing rate.

As shown in FIG. 2 to FIG. 3B, in the formation method 2, introduction of the additive element to the lithium cobalt oxide is divided into introduction of the additive element A1 and that of the additive element A2. When the additive elements are separately introduced, the additive elements can have different concentration distributions in the depth direction. For example, the additive element A1 can be distributed such that its concentration is higher in the surface portion than in the inner portion, and the additive element A2 can be widely distributed in a deeper region.

Specifically, for example, magnesium and nickel can be distributed in the surface portion at a high concentration, and aluminum can be widely distributed in a deeper region.

Alternatively, for example, the additive element A2 can be distributed such that its concentration is higher in the surface portion than in the inner portion, and the additive element A1 can be widely distributed in a deeper region.

In the case where the additive element A1 and the additive element A2 contain the same element, the element can be distributed in the surface portion at a high concentration and in a deeper region, e.g., widely in a region ranging from the surface of the positive electrode active material to the inner portion. For example, in the case where nickel is contained in both the additive element A1 and the additive element A2, nickel can exist in the surface portion at a high concentration and in a deeper region, e.g., widely in a region ranging from the surface of the positive electrode active material to the inner portion.

### <<Formation Method 3 of Positive Electrode Active Material>>

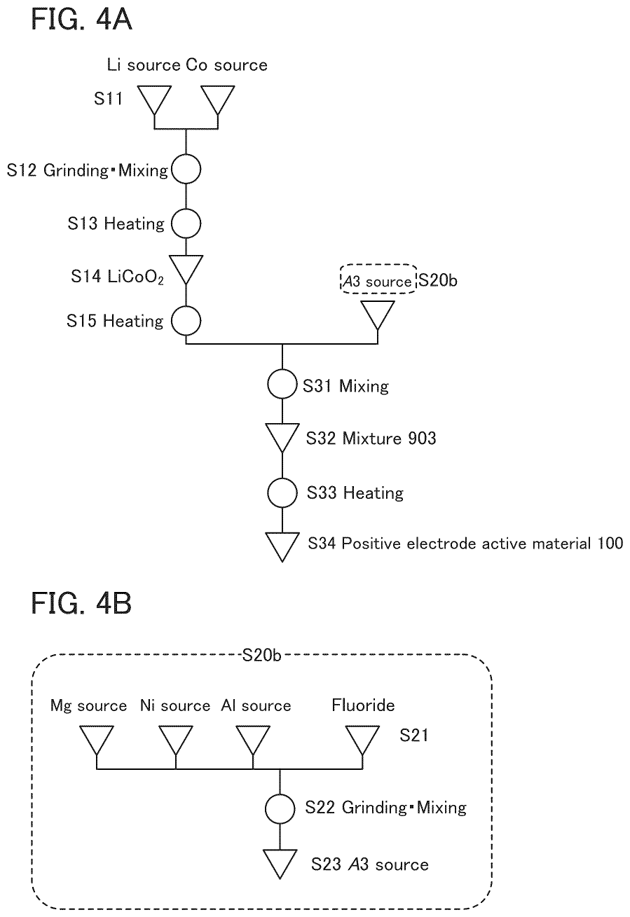

Next, as one embodiment of the present invention, a formation method 3 of a positive electrode active material, which is different from the formation method 1 of a positive electrode active material, will be described with reference to FIG. 4A and FIG. 4B. The formation method 3 of a positive electrode active material is different from the formation method 1 mainly in that a step shown in FIG. 4B is used instead of Step S20 shown in FIG. 1B.

Steps S11 to Step S15 in FIG. 4A are performed to prepare lithium cobalt oxide that has been subjected to the initial heating. For Step S11 to Step S15, the description of FIG. 1A can be referred to.

### <Step S20b>

Next, as shown in Step S20b, an additive element A3 is preferably added to the lithium cobalt oxide that has been subjected to the initial heating.

### <Step S21>

In Step S21 shown in FIG. 4B, as the element added to the lithium cobalt oxide, magnesium, nickel, and one or two or more selected from aluminum, fluorine, titanium, zirconium, vanadium, iron, manganese, chromium, niobium, arsenic, zinc, silicon, sulfur, phosphorus, and boron are used. Furthermore, one or two or more selected from bromine and beryllium may be used.

Here, a magnesium source (Mg source), a nickel source (Ni source), and an aluminum source (Al source) are prepared. Fluoride is preferably prepared together with the magnesium source, the nickel source, and the aluminum source.

Lithium fluoride is used as the fluoride, magnesium fluoride is used as the magnesium source, and nickel fluoride is used as the nickel source. For the mixing ratio of the lithium fluoride to the magnesium fluoride and the nickel fluoride, the description of FIG. 1B can be referred to, for example.

Step S21 to Step S23 shown in FIG. 4B can be performed under the conditions similar to those in Step S21 to Step S23 shown in FIG. 1B. As a result, the additive element source (A3 source) can be obtained in Step S23.

Next, Step S31 to Step S34 in FIG. 4A are performed. For Step S31 to Step S34, the description of FIG. 1A can be referred to. As a result, the positive electrode active material 100 can be obtained in Step S34.

The use of the flow chart shown in FIG. 4A can simplify the process as compared with the use of the process shown in FIG. 2. By contrast, in the case where the process shown in FIG. 2 is used, the steps of adding the Al source and the A2 source as the additive elements can be separately performed, resulting in different concentration distributions of the additive elements.

### <<Formation Method 4 of Positive Electrode Active Material>>

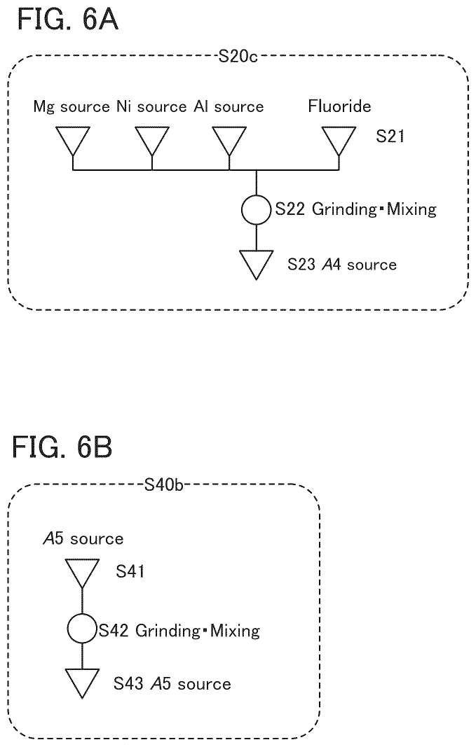

Next, as one embodiment of the present invention, a formation method 4 of a positive electrode active material, which is different from the formation method 3 of a positive electrode active material, will be described with reference to FIG. 5 to FIG. 6B. The formation method 4 of a positive electrode active material is different from the formation method 3 mainly in the number of times of adding additive elements and a mixing method. For the description except for the above, the description of the formation method 1 can be referred to.

Steps S11 to S15 in FIG. 5 are performed as in FIG. 1A to prepare lithium cobalt oxide that has been subjected to the initial heating.

### <Step S20c>

Next, as shown in Step S20c, an additive element A4 is preferably added to the lithium cobalt oxide that has been subjected to the initial heating.

### <Step S21>

In Step S21 shown in FIG. 6A, as the element added to the lithium cobalt oxide, magnesium, nickel, and one or two or more selected from aluminum, fluorine, titanium, zirconium, vanadium, iron, manganese, chromium, niobium, arsenic, zinc, silicon, sulfur, phosphorus, and boron are used. Furthermore, one or two or more selected from bromine and beryllium may be used.

Here, a magnesium source (Mg source), a nickel source (Ni source), and an aluminum source (Al source) are prepared. Fluoride is preferably prepared together with the magnesium source, the nickel source, and the aluminum source.

Step S21 to Step S23 shown in FIG. 6A can be performed under the conditions similar to those in Step S21 to Step S23 shown in FIG. 1B. As a result, the additive element source (A4 source) can be obtained in Step S23.

Steps S31 to S33 shown in FIG. 5 can be performed in a manner similar to that of Steps S31 to S33 shown in FIG. 1A.

### <Step S34b>

Next, the material heated in Step S33 is collected to form lithium cobalt oxide containing the additive element A4 in step S34b. This composite oxide is also called a second composite oxide to be distinguished from the composite oxide in Step S14.

### <Step S40b>

In Step S40b shown in FIG. 5, an additive element A5 is added. FIG. 6B is referred to in the following description.

### <Step S41>

In Step S41 shown in FIG. 6B, a second additive element source is prepared. As the second additive element source, one or two or more selected from magnesium, fluorine, nickel, aluminum, titanium, zirconium, vanadium, iron, manganese, chromium, niobium, arsenic, zinc, silicon, sulfur, phosphorus, and boron is preferably used. Furthermore, one or two selected from bromine and beryllium can be used. For example, one or more selected from titanium, boron, and zirconium can be suitably used as the additive element A5.

Step S41 to Step S43 shown in FIG. 6B can be performed under the conditions similar to those in Step S21 to Step S23 shown in FIG. 1B. As a result, the additive element source (A5 source) can be obtained in Step S43.

Note that the additive element contained in the A5 source may be the same as that contained in the A4 source.

### <Step S51 to Step S53>

Next, Step S51 to Step S53 shown in FIG. 5 can be performed under the conditions similar to those in Step S31 to Step S34 shown in FIG. TA. The heating in Step S53 can be performed at a lower temperature and for a shorter time than those of the heating in Step S33. Through the above steps, the positive electrode active material 100 of one embodiment of the present invention can be formed in Step S54.

As shown in FIG. 5 to FIG. 6B, in the formation method 2, introduction of the additive element to the lithium cobalt oxide is divided into introduction of the additive element A4 and that of the additive element A5. When the additive elements are separately introduced, the elements can have different concentration distributions in the depth direction. For example, the additive element A4 can be distributed such that its concentration is higher in the surface portion than in the inner portion, and the additive element A5 can be widely distributed in a deeper region. Alternatively, for example, the additive element A5 can be distributed such that its concentration is higher in the surface portion than in the inner portion, and the additive element A4 can be widely distributed in a deeper region.

In the case where the additive element A4 and the additive element A5 contain the same element, the element can be distributed in the surface portion at a high concentration and can be widely distributed in a deeper region.

### <<Formation Method A of Positive Electrode Active Material>>

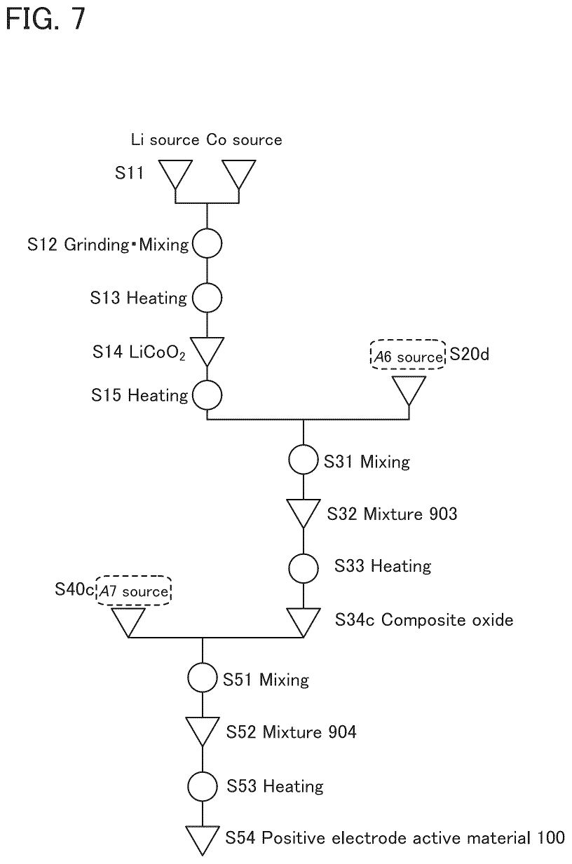

One embodiment of the present invention will be described with reference to FIG. 7 to FIG. 11B.

Steps S11 to Step S15 in FIG. 7 are performed to prepare lithium cobalt oxide that has been subjected to the initial heating. For Step S11 to Step S15, the description of FIG. 1A can be referred to.

### <Step S20d>

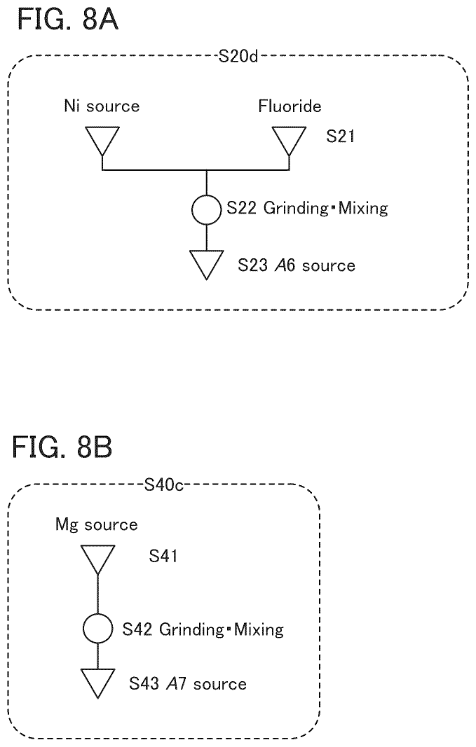

Next, in Step S20d, an additive element A6 is preferably added to the lithium cobalt oxide that has been subjected to the initial heating. The details of Step S20d are shown in FIG. 8A.

### <Step S21>

In Step S21 shown in FIG. 8A, as the element added to the lithium cobalt oxide, magnesium, nickel, and one or two or more selected from aluminum, fluorine, titanium, zirconium, vanadium, iron, manganese, chromium, niobium, arsenic, zinc, silicon, sulfur, phosphorus, and boron are used. Furthermore, one or two or more selected from bromine and beryllium may be used.

Here, a nickel source (Ni source) is prepared. Fluoride is preferably prepared together with the nickel source.

As the nickel source, nickel fluoride, nickel oxide, nickel hydroxide, or the like can be used. Two or more of these nickel sources may be used.

As the fluoride, for example, lithium fluoride (LiF), magnesium fluoride (MgF₂), nickel fluoride (NiF₂), aluminum fluoride (AlF₃), titanium fluoride (TiF₄), cobalt fluoride (CoF₂ and CoF₃), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C. Note that the fluoride can function as a fluorine source.

Nickel fluoride can be used as both the nickel source and the fluorine source. Lithium fluoride can be used as both the lithium source and the fluorine source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluoride, and nickel fluoride (NiF₂) is prepared as the nickel source.

Lithium fluoride and nickel fluoride can have a favorably low melting point and exist stably as a liquid without NiF2 being excessive when mixed at LiF:NiF₂=0.8:0.2 (molar ratio) and the neighborhood thereof.

Meanwhile, when the proportion of lithium fluoride increases, an excessive amount of lithium might degrade cycle performance.

The molar ratio of lithium fluoride to nickel fluoride is LiF:NiF₂=k:1. For example, k is greater than or equal to 0 and less than or equal to 10, greater than or equal to 0 and less than or equal to 5, greater than or equal to 0 and less than or equal to 3, greater than or equal to 0 and less than or equal to 2, greater than or equal to 0 and less than or equal to 1, or greater than or equal to 0 and less than or equal to 0.5.

### <Step S22>

Next, in Step S22 shown in FIG. 7, the magnesium source, the nickel source, and the fluoride are ground and mixed. Any of the conditions for grinding and mixing that are described for Step S12 can be selected to perform this step.

### <Step S23>

Next, in Step S23 shown in FIG. 7, the materials ground and mixed in the above step are collected to obtain the additive element A source (A source). Note that the additive element A source shown in Step S23 contains a plurality of starting materials and can be referred to as a mixture.

As for the particle diameter of the mixture, D50 (median diameter) is preferably greater than or equal to 600 nm and less than or equal to 10 μm, further preferably greater than or equal to 1 μm and less than or equal to 5 μm. Also when one kind of material is used as the additive element source, D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of lithium cobalt oxide particles uniformly in a later step of mixing with the lithium cobalt oxide. The mixture is preferably attached uniformly to the surface of the lithium cobalt oxide particles, in which case the additive element is easily distributed or dispersed uniformly in the surface portion of the composite oxide after heating.

Through the above steps, the additive element source (A6 source) can be obtained in Step S23.

### <Step S31>

Next, in Step S31 shown in FIG. 7, the lithium cobalt oxide and the additive element A source (A source) are mixed. The atomic ratio of cobalt Co in the lithium cobalt oxide to nickel Ni in the additive element A source is preferably Co:Ni=100:m (0.1≤m≤20).

The conditions of the mixing in Step S31 are preferably milder than those of the mixing in Step S12 in order not to damage the shape of the lithium cobalt oxide particles. For example, conditions with a lower rotational frequency or a shorter time than those for the mixing in Step S12 are preferable. In addition, it can be said that a dry method has a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 7, the materials mixed in the above step are collected to give a mixture 903. At the time of the collection, the materials may be crushed as needed and made to pass through a sieve.

Note that although FIG. 7 illustrates the formation method in which addition of the additive element is performed only after the initial heating, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. Then, lithium cobalt oxide containing the additive element can be obtained in Step S13. In that case, there is no need to separately perform Step S11 to Step S14 and Step S21 to Step S23. This method can be regarded as being simple and highly productive.

### <Step S33>

Then, in Step S33 shown in FIG. 7, the mixture 903 is heated. Any of the heating conditions described for Step S13 can be selected to perform the heating. The heating time is preferably longer than or equal to 2 hours. In that case, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is given. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements contained in the lithium cobalt oxide and the additive element source occurs, and may be lower than the melting temperatures of these materials. It is known that in the case of an oxide as an example, solid phase diffusion occurs at the temperature 0.757 times the melting temperature Tₘ (the Tamman temperature T_{d}). Accordingly, the heating temperature in Step S33 is higher than or equal to 650° C.

Needless to say, the reaction proceeds more easily at a temperature higher than or equal to the temperature at which one or two or more selected from the materials contained in the mixture 903 are melted. For example, in the case where LiF and NiF₂ are contained in the additive element source, the eutectic point of LiF and NiF₂ has an extremum at, for example, around 790° C. The lower limit of the heating temperature in Step S33 is preferably higher than or equal to 700° C., for example, and may be higher than or equal to 790° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C.

Note that the heating temperature in Step S33 is preferably higher than that in Step S13.

In addition, at the time of heating the mixture 903, the partial pressure of fluorine or fluoride originating from the fluorine source or the like is preferably controlled to be within an appropriate range.

In the formation method described in this embodiment, some of the materials, e.g., lithium fluoride as the fluorine source, function as a fusing agent in some cases. Owing to this function, the heating temperature can be lower than the decomposition temperature of the lithium cobalt oxide, which allows distribution of the additive element such as magnesium in the surface portion and formation of the positive electrode active material having favorable characteristics.

However, since lithium fluoride in a gas phase has a specific gravity less than that of oxygen, heating might volatilize lithium fluoride and in that case, lithium fluoride in the mixture 903 decreases. As a result, the function of a fusing agent deteriorates. Therefore, heating needs to be performed while volatilization of lithium fluoride is inhibited. Note that even when lithium fluoride is not used as the fluorine source or the like, Li at the surface of LiCoO₂ and F of the fluorine source might react to produce lithium fluoride, which might be volatilized. Thus, such inhibition of volatilization is needed also when fluoride having a higher melting point than lithium fluoride is used.

In view of this, the mixture 903 is preferably heated in an atmosphere containing lithium fluoride, i.e., the mixture 903 is preferably heated in a state where the partial pressure of lithium fluoride in a heating furnace is high. Such heating can inhibit volatilization of lithium fluoride in the mixture 903.

FIG. 15 illustrates an example of a heating furnace that can be used for the heating. The heating in Step S33 described above is preferably performed with the pressure in the furnace controlled using the pressure gauge 221. The furnace is preferably in an atmospheric pressure state or a pressurized state. When heating is performed under pressure, the surface of the positive electrode active material 100 becomes smooth; such a positive electrode active material may be less likely to be physically broken by pressure application or the like than a positive electrode active material whose surface is not smooth. For example, the positive electrode active material 100 is unlikely to be broken in a test involving pressure application such as a nail penetration test, meaning that the positive electrode active material 100 has high safety.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing lithium fluoride with the container containing the mixture 903 covered with a lid, for example.

A supplementary explanation of the heating time is given here. The heating time depends on conditions such as the heating temperature and the size and composition of the lithium cobalt oxide in Step S14. In the case where the lithium cobalt oxide is small, the heating is preferably performed at a lower temperature or for a shorter time than in the case where the lithium cobalt oxide is large, in some cases.

In the case where the lithium cobalt oxide in Step S14 in FIG. 7 has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the temperature decreasing time after the heating is, for example, preferably longer than or equal to 10 hours and shorter than or equal to 50 hours.

In the case where the lithium cobalt oxide in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the temperature decreasing time after the heating is, for example, preferably longer than or equal to 10 hours and shorter than or equal to 50 hours.

### <Step S34c>

Next, the material heated in Step S33 is collected to form lithium cobalt oxide containing the additive element A6 in step S34c. This composite oxide is also called a second composite oxide to be distinguished from the composite oxide in Step S14.

### <Step S40c>

In Step S40c shown in FIG. 7, an additive element A7 is added. FIG. 8B is referred to in the following description.

### <Step S41>

In Step S41 shown in FIG. 8B, a second additive element source is prepared. As the second additive element source, one or two or more selected from magnesium, nickel, aluminum, fluorine, titanium, zirconium, vanadium, iron, manganese, chromium, niobium, arsenic, zinc, silicon, sulfur, phosphorus, and boron is preferably used. Furthermore, one or two selected from bromine and beryllium can be used. For example, one or more selected from titanium, boron, and zirconium can be suitably used as the additive element A7.

FIG. 8B shows an example of preparing a magnesium source (Mg source) as the second additive element source. As the magnesium source, magnesium fluoride, magnesium oxide, magnesium hydroxide, magnesium carbonate, or the like can be used. Two or more of these magnesium sources may be used. Here, magnesium fluoride is used, for example. Magnesium fluoride can be used as both the magnesium source and the fluorine source.

Fluoride may be prepared in addition to the magnesium source. For example, magnesium fluoride can be used as the magnesium source, and lithium fluoride can be used as the fluoride. When lithium fluoride and magnesium fluoride are mixed at approximately LiF:MgF₂=65:35 (molar ratio), the effect of lowering the melting point is maximized.

Note that an aluminum source (Al source) may be prepared in addition to magnesium. As the aluminum source, aluminum fluoride, aluminum hydroxide, aluminum oxide, or the like can be used.

Step S41 to Step S43 shown in the drawing can be performed under the conditions similar to those in Step S21 to Step S23. As a result, the additive element source (A7 source) can be obtained in Step S43.

Note that the A7 source may contain the same additive element as the A6 source.

### <Step S51 to Step S53>

Next, Step S51 to Step S53 can be performed under the conditions similar to those in Step S31 to Step S34. The heating in Step S53 can be performed at a lower temperature and for a shorter time than those of the heating in Step S33. Through the above steps, the positive electrode active material 100 of one embodiment of the present invention can be formed in Step S54. For example, in the case where LiF, MgF₂, and NiF₂ are contained in the additive element source, the eutectic point of LiF and MgF₂ has an extremum at around 742° C. Thus, the lower limit of the heating temperature in Step S53 is preferably higher than or equal to 700° C., for example, and may be higher than or equal to 740° C.

In the formation method A, introduction of the additive element to the lithium cobalt oxide is divided into introduction of the additive element A6 and that of the additive element A7. When the additive elements are separately introduced, the elements can have different concentration distributions in the depth direction. For example, the additive element A6 can be distributed such that its concentration is higher in the surface portion than in the inner portion, and the additive element A7 can be widely distributed in a deeper region. Alternatively, for example, the additive element A7 can be distributed such that its concentration is higher in the surface portion than in the inner portion, and the additive element A6 can be widely distributed in a deeper region.

Specifically, for example, nickel can be widely distributed in a deeper region, and magnesium can be distributed in the surface portion at a high concentration.

In the case where the additive element A6 and the additive element A7 contain the same element, the element can be distributed in the surface portion at a high concentration and in a deeper region, e.g., widely in a region ranging from the surface of the positive electrode active material to the inner portion. For example, in the case where nickel is contained in both the additive element A6 and the additive element A7, nickel can exist in the surface portion at a high concentration and in a deeper region, e.g., widely in a region ranging from the surface of the positive electrode active material to the inner portion.

### <<Formation Method B of Positive Electrode Active Material>>

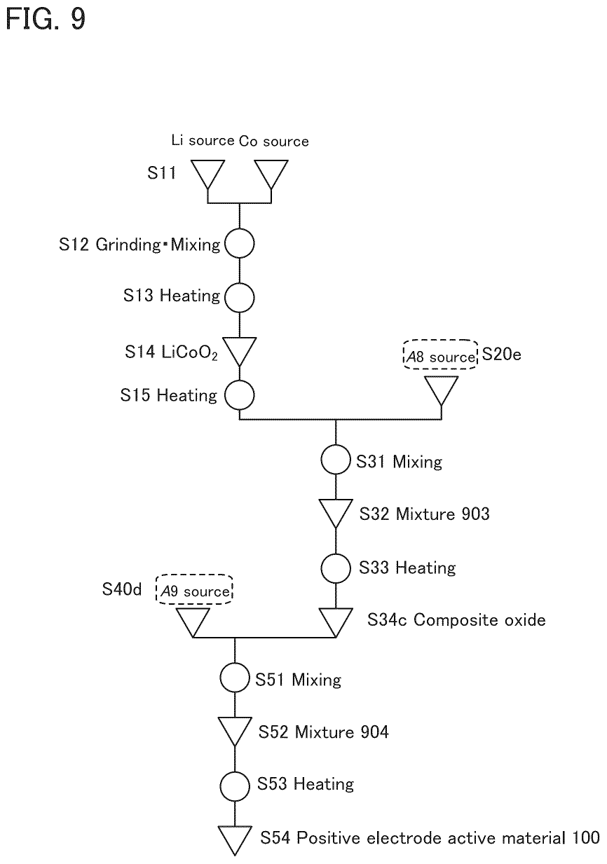

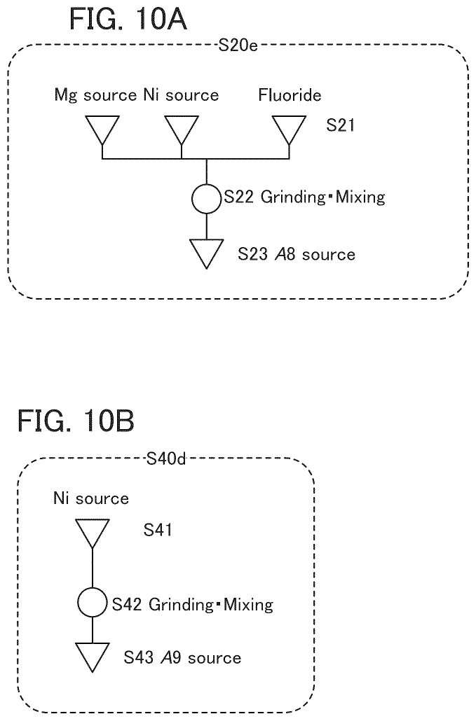

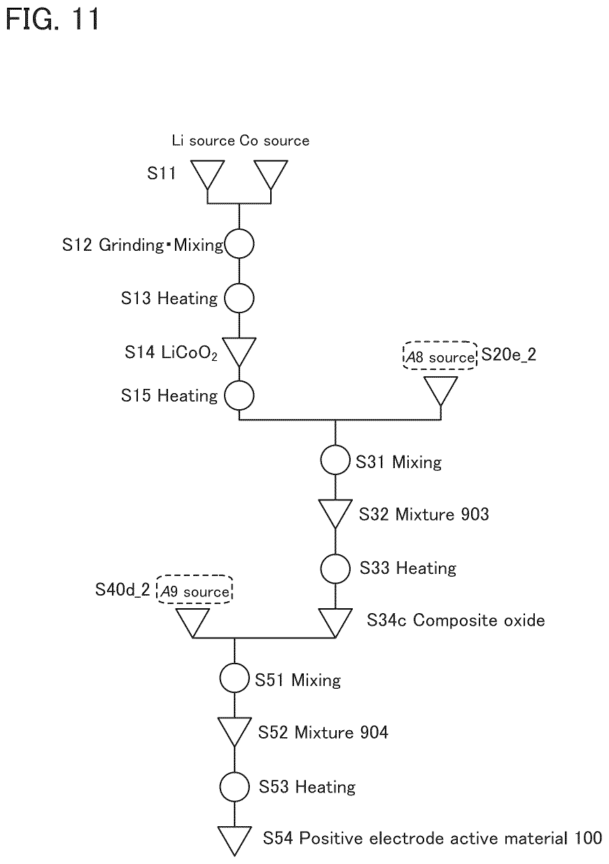

Next, as one embodiment of the present invention, a formation method B of a positive electrode active material, which is different from the formation method A of a positive electrode active material, will be described with reference to FIG. 9, FIG. 10A, FIG. 10B, FIG. 11A, and FIG. 11B.

Steps S11 to S15 in FIG. 9 are performed as in FIG. 7 to prepare lithium cobalt oxide that has been subjected to the initial heating.

### <Step S20e>

Next, as shown in Step S20e, an additive element A8 is preferably added to the lithium cobalt oxide that has been subjected to the initial heating.

### <Step S21>

In Step S21 shown in FIG. 10A, as the element added to the lithium cobalt oxide, magnesium, nickel, and one or two or more selected from aluminum, fluorine, titanium, zirconium, vanadium, iron, manganese, chromium, niobium, arsenic, zinc, silicon, sulfur, phosphorus, and boron are used. Furthermore, one or two or more selected from bromine and beryllium may be used.

Here, a magnesium source (Mg source) and a nickel source (Ni source) are prepared. Fluoride is preferably prepared together with the magnesium source and the nickel source.

Step S21 to Step S23 shown in FIG. 9 can be performed under the conditions similar to those in Step S21 to Step S23 shown in FIG. 7. As a result, the additive element source (A8 source) can be obtained in Step S23.

Steps S31 to S33 shown in FIG. 9 can be performed in a manner similar to that of Steps S31 to S33 shown in FIG. 7.

### <Step S34e>

Next, the material heated in Step S33 is collected to form lithium cobalt oxide containing the additive element A8 in step S34e. This composite oxide is also called a second composite oxide to be distinguished from the composite oxide in Step S14.

### <Step S40d>

In Step S40d shown in FIG. 9, an additive element A9 is added. FIG. 10B is referred to in the following description.

### <Step S41>

In Step S41 shown in FIG. 10B, a second additive element source is prepared. As the second additive element source, one or two or more selected from magnesium, nickel, aluminum, fluorine, titanium, zirconium, vanadium, iron, manganese, chromium, niobium, arsenic, zinc, silicon, sulfur, phosphorus, and boron is preferably used. Furthermore, one or two selected from bromine and beryllium can be used. For example, one or more selected from titanium, boron, and zirconium can be suitably used as the additive element A5.

Step S41 to Step S43 shown in FIG. 10B can be performed under the conditions similar to those in Step S21 to Step S23 shown in FIG. 7. As a result, the additive element source (A9 source) can be obtained in Step S43.

Here, at least one of the elements contained in the additive element A8 is preferably selected as the additive element A9. Here, nickel is selected as the additive element A9. As the additive element A9, aluminum or the like may be selected in addition to nickel.

In Step S41, a nickel source is prepared. Here, nickel fluoride is used as the nickel source. In addition to the nickel source, fluoride such as lithium fluoride may be prepared in Step S41.

### <Step S51 to Step S53>

Next, Step S51 to Step S53 shown in FIG. 9 can be performed under the conditions similar to those in Step S31 to Step S34 shown in FIG. 7. The heating in Step S53 can be performed at a lower temperature and for a shorter time than those of the heating in Step S33. Through the above steps, the positive electrode active material 100 of one embodiment of the present invention can be formed in Step S54.

As shown in FIG. 9, in the formation method B, introduction of the additive element to the lithium cobalt oxide is divided into introduction of the additive element A8 and that of the additive element A9. When the additive elements are separately introduced, the elements can have different concentration distributions in the depth direction. For example, the additive element A8 can be distributed such that its concentration is higher in the surface portion than in the inner portion, and the additive element A9 can be widely distributed in a deeper region. Alternatively, for example, the additive element A9 can be distributed such that its concentration is higher in the surface portion than in the inner portion, and the additive element A8 can be widely distributed in a deeper region.

Both the additive element A8 and the additive element A9 contain nickel here; thus, in the positive electrode active material of one embodiment of the present invention, nickel can be distributed such that its concentration is high in the surface portion and can be widely distributed in a deeper region, for example.

### <<Formation Method C of Positive Electrode Active Material>>

FIG. 11 shows an example in which Step S20e_2 is used instead of Step S20e in FIG. 9 and Step 40d_2 is used instead of Step S40d in FIG. 9.

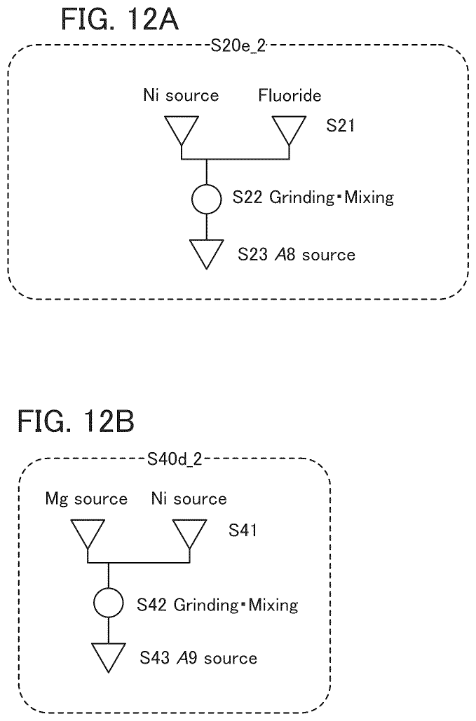

When Step S20e_2 shown in FIG. 12A is used as Step S20e_2 and Step S40d_2 shown in FIG. 12B is used as Step 40d_2, nickel can be selected as the additive element A8 and magnesium and nickel can be selected as the additive element A9.

### <Step S21>

In Step S21 shown in FIG. 12A, as the element added to the lithium cobalt oxide, magnesium, nickel, and one or two or more selected from aluminum, fluorine, titanium, zirconium, vanadium, iron, manganese, chromium, niobium, arsenic, zinc, silicon, sulfur, phosphorus, and boron are used. Furthermore, one or two or more selected from bromine and beryllium may be used.

Here, a nickel source (Ni source) is prepared. Fluoride such as lithium fluoride is preferably prepared together with the nickel source.

### <Step S41>

In Step S41 shown in FIG. 12B, a second additive element source is prepared. As the second additive element source, one or two or more selected from magnesium, nickel, aluminum, fluorine, titanium, zirconium, vanadium, iron, manganese, chromium, niobium, arsenic, zinc, silicon, sulfur, phosphorus, and boron is preferably used. Furthermore, one or two selected from bromine and beryllium can be used. For example, one or more selected from titanium, boron, and zirconium can be suitably used as the additive element A5.

Here, at least one of the elements contained in the additive element A8 is preferably selected as the additive element A9. Here, nickel and magnesium are selected as the additive elements A9. As the additive element A9, aluminum or the like may be selected in addition to nickel and magnesium. In Step S41, fluoride such as lithium fluoride may be prepared.

The positive electrode active material of one embodiment of the present invention has a smooth surface.

The initial heating described in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. The steps are preferably performed in such an order to maintain the smoothness of the surface achieved by the initial heating.

The positive electrode active material with a smooth surface may be less likely to be physically broken by pressure application or the like than a positive electrode active material without a smooth surface. For example, the positive electrode active material 100 is unlikely to be broken in a test involving pressure application such as a nail penetration test, meaning that the positive electrode active material 100 has high safety.

This embodiment can be used in combination with the other embodiments.

### Embodiment 2

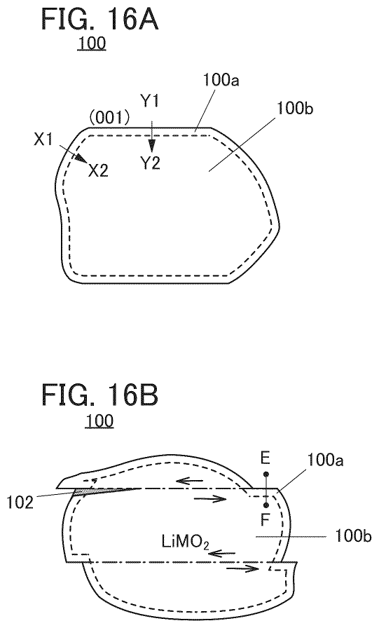

In this embodiment, the positive electrode active material 100 of one embodiment of the present invention will be described with reference to FIG. 16 to FIG. 30.

FIG. 16A and FIG. 16B are each a cross-sectional view of the positive electrode active material 100 of one embodiment of the present invention. As illustrated in FIG. 16A, the positive electrode active material 100 includes a surface portion 100a and an inner portion 100b. In each drawing, the dashed line denotes a boundary between the surface portion 100a and the inner portion 100b. FIG. 16A illustrates an arrow X1-X2 as an example of the depth direction of a crystal plane of lithium cobalt oxide of the positive electrode active material 100 that is not the (001) plane and an arrow Y1-Y2 as an example of the depth direction of a crystal plane that is the (001) plane. In FIG. 16B, the dashed-dotted line denotes part of a crystal grain boundary 101. FIG. 16B illustrates the positive electrode active material 100 including a filling portion 102. In FIG. 16B, E-F is a line drawn to intersect with the surface portion 100a that is newly generated due to a shift along the directions of arrows. In the drawing, (001) refers to the (001) plane of lithium cobalt oxide. LiCoO₂ belongs to the space group R-3m.

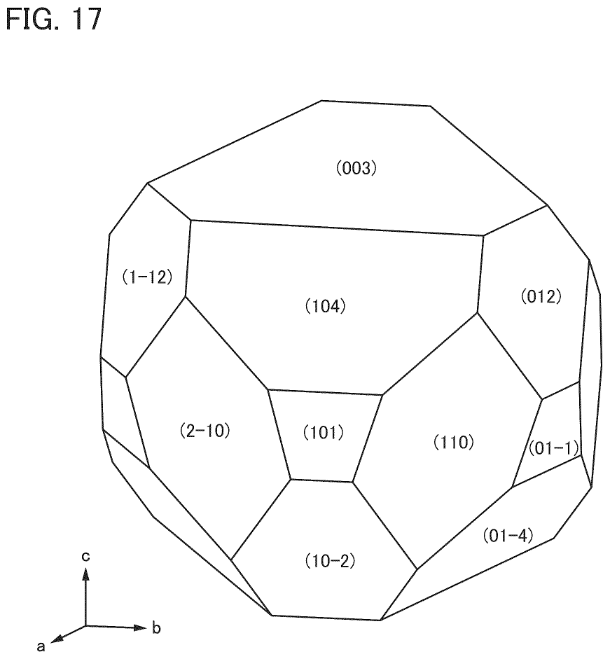

FIG. 17 illustrates the (003) plane, the (104) plane, the (012) plane, the (1-12) plane, the (101) plane, the (110) plane, the (2-10) plane, the (01-1) plane, the (10-2) plane, and the (01-4) plane as the planes in the crystal structure of LiMeO₂ belonging to the space group R-3m. Examples of a surface having an orientation other than the (001) orientation include the (104) plane, the (012) plane, the (1-12) plane, the (101) plane, the (110) plane, the (2-10) plane, the (01-1) plane, the (10-2) plane, the (01-4) plane, planes parallel to these planes, and planes equivalent to these planes. The amount of additive element detected from the surface having an orientation other than the (001) orientation and the surface portion 100a thereof is smaller than the amount of additive element detected from a surface having the (001) orientation in some cases.

In this specification and the like, the surface portion 100a of the positive electrode active material 100 refers to, for example, a region within 50 nm from the surface toward the inner portion, preferably within 35 nm from the surface toward the inner portion, further preferably within 20 nm from the surface toward the inner portion, most preferably a region within 10 nm in a direction perpendicular or substantially perpendicular from the surface toward the inner portion. Note that “substantially perpendicular” refers to a state where an angle is greater than or equal to 80° and less than or equal to 100°. A plane generated by a split and/or a crack can be regarded as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

The surface of the positive electrode active material 100 refers to a surface of a composite oxide including the surface portion 100a and the inner portion 100b. Thus, the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal structure different from that of the inner portion 100b.

Furthermore, an electrolyte, an organic solvent, a binder, a conductive material, and a compound originating from any of these that are attached to the positive electrode active material 100 are not contained either.

The crystal grain boundary 101 refers to, for example, a portion where particles of the positive electrode active material 100 adhere to each other or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a hollow, or the like. The crystal grain boundary 101 can be regarded as a type of plane defect. The vicinity of the crystal grain boundary 101 refers to a region within 10 nm from the crystal grain boundary 101.

### <Contained Element>

The positive electrode active material 100 contains lithium, cobalt, oxygen, and an additive element.

The positive electrode active material 100 is a composite oxide represented by LiMeO₂ (Me is a metal) to which an additive element is added. Alternatively, the positive electrode active material 100 contains a composite oxide represented by LiMeO₂ (Me is a metal) to which an additive element is added. Here, the metal Me is cobalt, for example. That is, the composite oxide containing lithium, cobalt, and oxygen is lithium cobalt oxide represented by LiCoO₂, for example. Alternatively, as the metal Me, one or two selected from nickel and manganese may be used in addition to cobalt. In the metal Me, cobalt is preferably is contained at higher than or equal to 75 at %, further preferably higher than or equal to 90 at %. Here, the positive electrode active material 100 has a crystal structure described later, and the composition of LiMeO₂ is not strictly limited to Li:Me:O=1:1:2.

Specifically, lithium cobalt oxide (LiCoO₂) to which an additive element is added can be used as the positive electrode active material 100, for example. Alternatively, the positive electrode active material 100 contains lithium cobalt oxide (LiCoO₂) to which an additive element is added, for example. Here, the composition of the lithium cobalt oxide is not strictly limited to Li:Co:O=1:1:2.

A positive electrode active material of a lithium-ion secondary battery needs to contain a transition metal which can be oxidized or reduced in order to maintain a neutrally charged state even when lithium ions are inserted and extracted. It is preferable that the positive electrode active material 100 of one embodiment of the present invention mainly contain cobalt as the transition metal taking part in an oxidation-reduction reaction. In addition to cobalt, one or two selected from nickel and manganese may be used. Cobalt is preferably used at higher than or equal to 75 at %, further preferably higher than or equal to 90 at %, still further preferably higher than or equal to 95 at % as the transition metal contained in the positive electrode active material 100, in which case many advantages such as relatively easy synthesis, easy handling in a synthesis process, and excellent cycle performance are offered.

When cobalt is used as the transition metal contained in the positive electrode active material 100 at higher than or equal to 75 at %, preferably higher than or equal to 90 at %, further preferably higher than or equal to 95 at %, LixCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the orbital of the d transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium is preferably used. The total percentage of the transition metal among the additive elements is preferably lower than 25 at %, further preferably lower than 10 at %, still further preferably lower than 5 at %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element preferably forms a solid solution with the positive electrode active material 100. In the case where the additive element forms a solid solution with the positive electrode active material 100, the additive element is also detected at the depth at which the metal Me is detected as a main component, for example. Thus, in STEM-EDX line analysis, for example, a depth at which the amount of detected additive element increases is preferably at a deeper position than a depth at which the amount of detected transition metal Me increases, i.e., on the inner portion side of the positive electrode active material 100. Here, in analysis conducted from a given position outside the surface of the positive electrode active material 100 toward the inner portion of the positive electrode active material 100, when the analysis reaches the surface, the metal Me that is a main component is detected, i.e., the amount of detected metal Me increases.

In this specification and the like, a depth at which the amount of detected element increases in STEM-EDX line analysis refers to a depth at which a measured value, which can be determined not to be a noise in terms of intensity, spatial resolution, and the like, is successively obtained.

These additive elements further stabilize the crystal structure of the positive electrode active material 100 as described later. In this specification and the like, the additive element can be rephrased as part of a raw material or a mixture.

Note that the additive elements given above as examples are not contained in the positive electrode active material of one embodiment of the present invention and the concentration of the additive element is extremely low in some cases. For example, when the positive electrode active material 100 is substantially free from manganese, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

### <Crystal Structure>

<<x in LixCoO₂ being 1>>

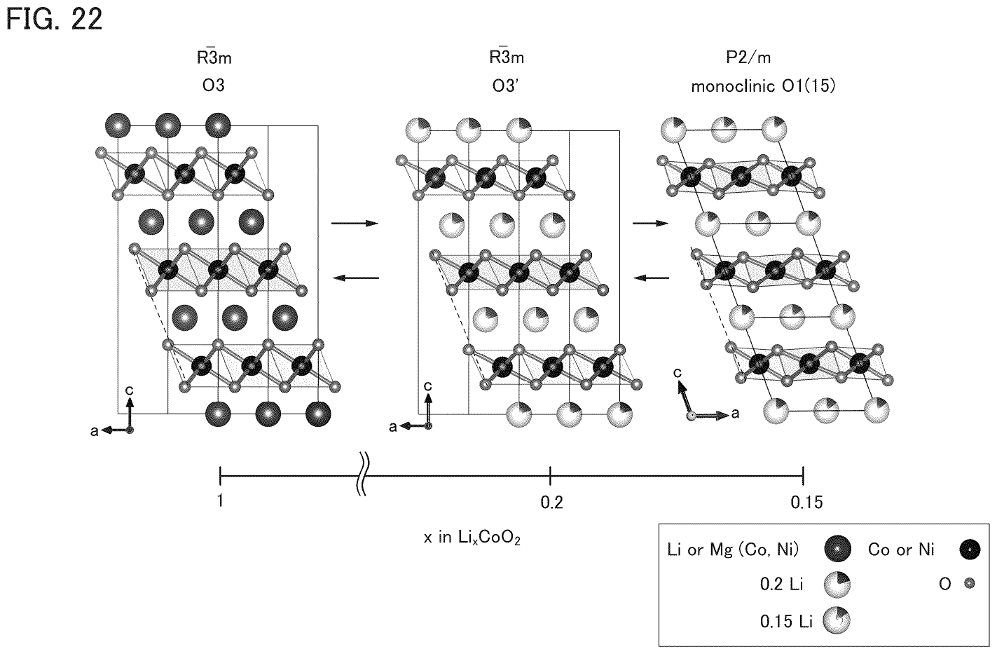

The positive electrode active material 100 of one embodiment of the present invention preferably has a layered rock-salt crystal structure belonging to the space group R-3m in a discharged state, i.e., a state where x in LixCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that an inner portion 100b, which accounts for the majority of the volume of the positive electrode active material 100, have a layered rock-salt crystal structure. In FIG. 22, the layered rock-salt crystal structure is denoted by R-3m O3. In the R-3m O3 structure, the lattice constants are as follows: a=2.81610, b=2.81610, c=14.05360, α=90.0000, β=90.0000, and γ=120.0000; the coordinates of lithium, cobalt, and oxygen in a unit cell are represented by Li (0, 0, 0), Co (0, 0, 0.5), and O (0, 0, 0.23951), respectively (Non-Patent Document 6).

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of extraction of oxygen and/or a structural change of the surface portion 100a and the inner portion 100b of the positive electrode active material 100 such as a shift in the layered structure formed of octahedrons of cobalt and oxygen, and/or inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charging, and is a region that tends to have a lower concentration of lithium than the inner portion 100b. It can be said that bonds between atoms are partly cut on the surface of the particle of the positive electrode active material 100 included in the surface portion 100a. Thus, the surface portion 100a is regarded as a region that tends to be unstable and tends to start deterioration of the crystal structure. For example, it is presumable that a shift in the crystal structure of the layered structure formed of octahedrons of cobalt and oxygen in the surface portion 100a has an influence on the inner portion 100b to cause a shift in the crystal structure of the layered structure in the inner portion 100b, leading to degradation of the crystal structure in the whole positive electrode active material 100. Meanwhile, when the surface portion 100a can be made sufficiently stable, the layered structure, which is formed of octahedrons of cobalt and oxygen, of the inner portion 100b is difficult to break even when x in LixCoO₂ is small, e.g., 0.24 or less. Furthermore, a shift in layers, which are formed of octahedrons of cobalt and oxygen, of the inner portion 100b can be inhibited.

### [Distribution]

In order that the surface portion 100a can have a stable composition and a stable crystal structure, the surface portion 100a preferably contains an additive element, further preferably contains a plurality of additive elements. The surface portion 100a preferably has a higher concentration of one or two or more selected from the additive elements than the inner portion 100b. The one or two or more selected from the additive elements contained in the positive electrode active material 100 preferably have a concentration gradient. It is further preferable that the additive elements contained in the positive electrode active material 100 be differently distributed. For example, it is further preferable that peaks of the detected amounts of the added elements in the surface portion be exhibited at different depths from the surface or the reference point in EDX line analysis described later. The peak of the detected amount here refers to the local maximum value of the detected amount in the surface portion 100a or a region ranging from the surface to a depth of 50 nm or less. The detected amount refers to counts in EDX line analysis, for example.

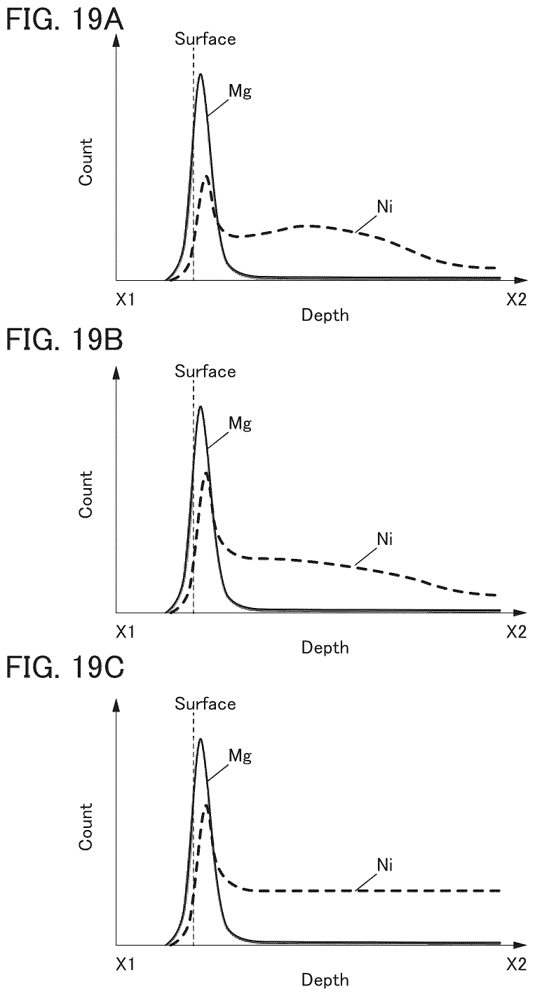

The arrow X1-X2 is shown in FIG. 16 as an example of depth direction of a crystal plane, which is not the (001) plane, of lithium cobalt oxide of the positive electrode active material 100 of one embodiment of the present invention. FIG. 18A to FIG. 19C show examples of profiles of the additive elements obtained by an EDX line analysis performed along the arrow X1-X2.

FIG. 18A shows the distribution D1 (dashed line) and the distribution D2 (dashed-dotted line) as examples of profiles of the additive elements. The distribution D1 has a peak of the detected amount with a small width in a region of the surface portion 100a that is closer to the surface. The distribution D2 has a wider distribution of the detected amount than the distribution D2. The distribution D2 has a peak of the detected amount in a deeper region than the distribution D1, for example. The distribution of the detected amount of the distribution D2 may also be extended to the inner portion 100b. The distribution D2 may have a peak of the detected amount in the surface portion 100a or may have a peak of the detected amount in the inner portion 100b.

FIG. 18B and FIG. 18C show examples of profiles of magnesium and nickel. As shown in FIG. 18B and FIG. 18C, the detected amounts of magnesium and nickel are preferably larger in the surface portion 100a than in the inner portion 100b. Peaks of the detected amounts with small widths are preferably observed in a region of the surface portion 100a that is closer to the surface. For example, the peaks of the detected amounts are preferably observed in a region within 3 nm from the surface or the reference point. Here, the surface corresponds to a position where the spectrum of the metal Me, which is a main component of lithium cobalt oxide, rises in the EDX line analysis performed toward the inner portion of the positive electrode active material 100 from a given position outside the surface of the positive electrode active material 100.

The distribution of magnesium and that of nickel preferably overlap with each other. The peak of the detected amount of magnesium and that of the detected amount of nickel may be observed at the same depth, the peak of magnesium may be observed closer to the surface, or the peak of nickel may be observed closer to the surface as shown in FIG. 18C. The difference in depth between the peak of the detected amount of nickel and the peak of the detected amount of magnesium is preferably less than or equal to 3 nm, further preferably less than or equal to 1 nm.

In some cases, the detected amount of nickel in the inner portion 100b is much smaller than that in the surface portion 100a or no nickel is detected in the inner portion, i.e., lower than or equal to the lower detection limit.

Although not shown, as in the case of magnesium or nickel, the detected amount of fluorine is preferably larger in the surface portion 100a than in the inner portion. A peak of the detected amount of fluorine is preferably observed in a region of the surface portion 100a that is closer to the surface. For example, the peak of the detected amount is preferably observed in a region from the surface or the reference point to a depth of less than or equal to 3 nm. Similarly, the detected amounts of titanium, silicon, phosphorus, boron, and/or calcium are/is also preferably larger in the surface portion 100a than in the inner portion. Peaks of the detected amounts are preferably observed in a region of the surface portion 100a that is closer to the surface. For example, the peaks of the detected amounts are preferably observed in a region from the surface or the reference point to a depth of less than or equal to 3 nm.

A peak of the detected amount of at least aluminum among the additive elements is preferably observed in a region that is located inward from a region in which a peak of the detected amount of magnesium is observed. The distribution of magnesium and that of aluminum may overlap with each other, or there may be almost no overlap between the distribution of magnesium and that of aluminum. A peak of the detected amount of aluminum may be located in the surface portion 100a or may be located deeper than the surface portion 100a. For example, the peak is preferably observed in a region ranging from the surface or the reference point toward the inner portion to a depth of greater than equal to 5 nm and less than or equal to 30 nm. For the distribution of aluminum, the distribution D2 shown in FIG. 18A can be referred to, for example.

The distribution of aluminum is not normal distribution in some cases. For example, when the distribution of aluminum is divided by the maximum value Max_{A1}, the length of the tail on the surface side is sometimes different from that of the tail on the inner portion side. Specifically, when the peak width at the height (⅕ Max_{A1}) that is ⅕ of the maximum value (Max_{A1}) of the detected amount of aluminum is divided into two parts by a perpendicular extending from the maximum value to the horizontal axis, the peak width Wₑ on the inner portion side is sometimes larger than the peak width Wₛ on the surface side.

It is presumed that aluminum has a higher diffusion rate than magnesium and is distributed more inwardly than magnesium. Meanwhile, the detected amount of aluminum is small in the region that is closest to the surface presumably because aluminum is more stable in a region other than the region where magnesium or the like forms a solid solution at a high concentration.

To be specific, in a region having a layered rock-salt crystal structure belonging to the space group R-3m or a cubic rock-salt crystal structure, the distance between a cation and oxygen in a region where magnesium at a high concentration forms a solid solution is longer than the distance between a cation and oxygen in LiAlO₂ having a layered rock-salt crystal structure, and aluminum is thus likely to be unstable. In the vicinity of cobalt, valence change due to replacement of Li⁺ with Mg²⁺ can be offset by Co²⁺ which is changed from Co³⁺, so that cation balance can be maintained. By contrast, Al is always trivalent and is thus presumed to be unlikely to coexist with magnesium in a rock-salt or layered rock-salt crystal structure.

Although not shown, as in the case of aluminum, a peak of the detected amount of manganese is preferably observed in a region that is located inward from a region where a peak of the detected amount of magnesium is observed.

Note that the additive element may have a peak of the detected amount in the surface portion and may also be widely distributed in the inner portion. The additive element may have a first peak of the detected amount in the surface portion and a second peak of the detected amount in the inner portion. FIG. 19A shows an example in which nickel has a first peak of the detected amount in the surface portion, is also widely distributed in the inner portion, and has a second peak of the detected amount in the inner portion. The profile of nickel shown in FIG. 19A can be represented by, for example, the sum of the distribution D1 and the distribution D2 shown in FIG. 18A.

In some cases, the additive element has a first peak of the detected amount in the surface portion and is also widely distributed in the inner portion, the detected amount gradually decreases from the surface portion, and the additive element does not have a clear peak in the inner portion. FIG. 19B shows an example in which nickel has a first peak of the detected amount in the surface portion and is also widely distributed in the inner portion, the detected amount gradually decreases from the surface portion, and nickel does not have a clear peak in the inner portion.

The additive element may have a first peak of the detected amount in the surface portion, be also widely distributed in the inner portion, and have a small change in the concentration or substantially uniformity concentration in the inner portion. FIG. 19C shows an example in which nickel has a first peak of the detected amount in the surface portion, is also widely distributed in the inner portion, and has a small change in the concentration or substantially uniform concentration in the inner portion.

Note that magnesium may have a first peak of the detected amount in the surface portion and a second peak of the detected amount in the inner portion. Alternatively, magnesium may have a first peak of the detected amount in the surface portion and be widely distributed in the inner portion, the detected amount may gradually decrease from the surface portion, and magnesium does not necessarily have a clear peak in the inner portion. Alternatively, magnesium may have a first peak of the detected amount in the surface portion and be widely distributed in the inner portion, and have a small change in the concentration or substantially uniform concentration in the inner portion.

Magnesium may be widely distributed in the inner portion and the detected amount of magnesium in a region closest to the surface may be small.

Nickel may be widely distributed in the inner portion and the detected amount of nickel may be small in a region closest to the surface.

Note that aluminum may have a first peak of the detected amount in the surface portion and a second peak of the detected amount in the inner portion. Alternatively, aluminum may have a first peak of the detected amount in the surface portion and be widely distributed in the inner portion, the detected amount may gradually decrease from the surface portion, and magnesium does not necessarily have a clear peak in the inner portion. Alternatively, aluminum may have a first peak of the detected amount in the surface portion and be widely distributed in the inner portion, and have a small change in the concentration or substantially uniform concentration in the inner portion.

The distribution of the additive element at the surface having a (001) orientation may be different from that at other surfaces. For example, the surface having the (001) orientation and the surface portion 100a thereof may have smaller detected amount of one or two or more selected from the additive elements than a surface having an orientation other than the (001) orientation. Specifically, the detected amount of nickel may be smaller. Alternatively, at the surface having the (001) orientation and the surface portion 100a thereof, the detected amount of one or two or more selected from the additive elements may be lower than or equal to the lower detection limit. Specifically, the detected amount of nickel may be lower than or equal to the lower detection limit. Especially in the case of an analysis method by which characteristic X-rays are detected, e.g., EDX, the energy of KP for cobalt is close to that of Kα for nickel and it is thus difficult to detect a slight amount of nickel in a material whose main element is cobalt. Alternatively, the peaks of the detected amounts of one or two or more selected from the additive elements at the surface having the (001) orientation and the surface portion 100a thereof may be positioned shallower from the surface than the peaks at the surface having an orientation other than the (001) orientation. Specifically, the peaks of the detected amounts of magnesium and aluminum may be positioned shallower than the peaks at the surface having an orientation other than the (001) orientation.

In a layered rock-salt crystal structure belonging to R-3m, cations are arranged parallel to the (001) plane. In other words, CoO₂ layers and lithium layers are alternately stacked parallel to the (001) plane. Accordingly, a diffusion path of lithium ions also exists parallel to the (001) plane.

The CoO₂ layer is relatively stable and thus, the surface of the positive electrode active material 100 is more stable when having a (001) orientation. A main diffusion path of lithium ions in charging and discharging is not exposed at the (001) plane.

By contrast, a diffusion path for lithium ions is exposed at a surface having an orientation other than the (001) orientation. Thus, the surface having an orientation other than the (001) orientation and the surface portion 100a thereof easily lose stability because they are regions where extraction of lithium ions starts as well as important regions for maintaining a diffusion path of lithium ions. It is thus extremely important to reinforce the surface having an orientation other than the (001) orientation and the surface portion 100a thereof so that the crystal structure of the whole positive electrode active material 100 is maintained.

Thus, in the positive electrode active material 100 of another embodiment of the present invention, the additive element is preferably detected at the surface having an orientation other than the (001) orientation and the surface portion 100a thereof. In particular, among the additive elements, nickel is preferably detected at the surface having an orientation other than the (001) orientation and the surface portion 100a thereof. By contrast, at the surface having the (001) orientation and the surface portion 100a thereof, the concentration of the additive element may be low as described above or the additive element may be absent.

For example, the half width of the distribution of magnesium at the surface having the (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface not having the (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface not having the (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

### [Magnesium]

Magnesium is divalent, and a magnesium ion is more stable in lithium sites than in cobalt sites in a layered rock-salt crystal structure; thus, magnesium is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LixCoO₂ is, for example, 0.24 or less. Magnesium is also expected to increase the density of the positive electrode active material 100. In addition, a high concentration of magnesium in the surface portion 100a probably increases the corrosion resistance to hydrofluoric acid generated by the decomposition of the electrolyte solution.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide and fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. For example, the number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms. The amount of magnesium contained in the entire positive electrode active material 100 here may be a value obtained by element analysis on the entire positive electrode active material 100 using GD-MS, ICP-MS, or the like, or may be a value based on the ratio of the raw materials mixed in the formation process of the positive electrode active material 100, for example.

### [Nickel]

Nickel in a layered rock-salt crystal structure of LiMeO₂ can exist in both the cobalt sites and the lithium sites. Since nickel has a lower oxidation-reduction potential than cobalt, the existence of nickel at a cobalt site can facilitate release of lithium and electrons during charging, for example. As a result, the charge and discharge speed is expected to be increased. Accordingly, at the same charge voltage, the charge capacity in the case of the transition metal M being nickel can be higher than that in the case of the transition metal M being cobalt.

In addition, when nickel exists in the lithium sites, a shift in the layered structure formed of octahedrons of cobalt and oxygen might be inhibited. Moreover, a change in volume in charging and discharging is inhibited. Furthermore, an elastic modulus becomes large, i.e., hardness increases. This is probably because nickel in the lithium sites serves as a column supporting the CoO₂ layers. Thus, in particular, the crystal structure can be expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO having a rock-salt crystal structure and CoO having a rock-salt crystal structure, and the orientations of NiO and LiCoO₂ are likely to be aligned with each other.

Ionization tendency increases in the order of magnesium, aluminum, cobalt, and nickel. Therefore, it can be considered that in charging, nickel is less likely to be dissolved into an electrolyte solution than the other elements described above. Accordingly, nickel can be considered to have a high effect of stabilizing the crystal structure of the surface portion in a charged state.

Furthermore, in nickel, Ni²⁺ is the most stable among Ni²⁺, Ni³⁺, and Ni⁴⁺, and nickel has lower trivalent ionization energy than cobalt. Thus, it is known that a spinel crystal structure does not appear only with nickel and oxygen. Therefore, nickel can be considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the number of nickel atoms contained in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material with GD-MS, ICP-MS, or the like, or may be a value based on the ratio of the raw materials mixed in the formation process of the positive electrode active material, for example.

### [Aluminum]

Aluminum can exist in a cobalt site in a layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. This would reduce degradation of the positive electrode active material 100 if force of expansion and contraction of the positive electrode active material 100 in the c-axis direction operates owing to insertion and extraction of lithium ions, i.e., owing to a change in charge depth or charge rate, as described later.

Furthermore, aluminum has effects of inhibiting dissolution of cobalt around aluminum and improving continuous charge tolerance. Moreover, an Al—O bond is stronger than a Co—O bond; thus, extraction of oxygen around aluminum can be inhibited. These effects improve thermal stability. Thus, a secondary battery that includes the positive electrode active material 100 containing aluminum as the additive element can have higher level of safety. Furthermore, the positive electrode active material 100 can have a crystal structure that is unlikely to be broken even with repeated charging and discharging.

Meanwhile, excess aluminum might adversely affect insertion and extraction of lithium.

Thus, the entire positive electrode active material 100 preferably contains an appropriate amount of aluminum. For example, the number of aluminum atoms contained in the entire positive electrode active material 100 is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the formation process of the positive electrode active material 100, for example.

### [Fluorine]

When fluorine, which is a monovalent anion, is substituted for part of oxygen in the surface portion 100a, the lithium extraction energy is lowered. This is because the oxidation-reduction potential of cobalt ions associated with lithium extraction differs depending on the presence or absence of fluorine. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved large current characteristics, or the like. When fluorine exists at the surface portion 100a including the surface that is in contact with an electrolyte solution, or when fluoride is attached to the surface, an overreaction between the positive electrode active material 100 and the electrolyte solution can be suppressed. In addition, the corrosion resistance to hydrofluoric acid can be effectively increased.

### [Other Additive Elements]

An oxide of titanium is known to have superhydrophilicity. Accordingly, the positive electrode active material 100 that contains titanium oxide in the surface portion 100a presumably has good wettability with respect to a high-polarity solvent. In a secondary battery including the positive electrode active material 100, the positive electrode active material 100 and a high-polarity electrolyte solution can have favorable contact at the interface therebetween, which may inhibit an internal resistance increase.

The surface portion 100a preferably contains phosphorus, in which case a short circuit can be inhibited while a state with small x in LixCoO₂ is maintained in some cases. For example, a compound containing phosphorus and oxygen preferably exists in the surface portion 100a.

When the positive electrode active material 100 contains phosphorus, phosphorus may react with hydrogen fluoride generated by the decomposition of the electrolyte solution or the electrolyte, which can decrease the concentration of hydrogen fluoride in the electrolyte and is thus preferable.

In the case where the electrolyte contains LiPF₆, hydrogen fluoride might be generated by hydrolysis. Furthermore, hydrogen fluoride might be generated by the reaction of polyvinylidene fluoride (PVDF) used as a component of the positive electrode and alkali. The decrease in the concentration of hydrogen fluoride in the electrolyte can inhibit corrosion of a current collector and/or separation of a coating portion 104 in some cases. Furthermore, a reduction in adhesion properties due to gelling and/or insolubilization of PVDF can be inhibited in some cases.

The positive electrode active material 100 preferably contains magnesium and phosphorus, in which case the stability in a state with small x in LixCoO₂ is extremely high. In the case where the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 100 by GD-MS, ICP-MS, or the like, or may be a value based on the ratio of the raw materials mixed in the formation process of the positive electrode active material 100, for example.

In the case where the positive electrode active material 100 has a crack, crack development can be inhibited by phosphorus, more specifically, a compound containing, for example, phosphorus and oxygen being in the inner portion, e.g., a filling portion 102, of the positive electrode active material having the crack on its surface.

### [Synergistic Effect of a Plurality of Additive Elements]

When the surface portion 100a contains both magnesium and nickel, divalent nickel can exist more stably in the vicinity of divalent magnesium. Thus, dissolution of magnesium might be inhibited even when x in LixCoO₂ is small. This can contribute to stabilization of the surface portion 100a.

Additive elements that are differently distributed are preferably contained at a time, in which case the crystal structure of a wider region can be stabilized. For example, the stable crystal structure can be obtained in a wide region in the case where the positive electrode active material 100 contains, in the surface portion 100a, magnesium and nickel distributed in a region closer to the surface and aluminum distributed in a region deeper than magnesium and nickel, as compared with the case where only one or two of the additive elements are contained. In the case where the positive electrode active material 100 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, it is preferable that aluminum be continuously detected in a region ranging from a depth from the surface of 1 nm or more to a depth from the surface of 25 nm or less. Aluminum is preferably widely distributed in a region ranging from a depth from the surface of 0 nm or more to a depth from the surface of 100 nm or less, further preferably a region ranging from a depth from the surface of 0.5 nm or more to a depth from the surface of 50 nm or less, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, it is necessary that the surface portion 100a contain at least cobalt, also contain lithium in a discharged state, and have a path through which lithium is inserted and extracted.

To secure the sufficient path through which lithium is inserted and extracted, the concentration of cobalt is preferably higher than that of magnesium in the surface portion 100a. For example, when measurement by XPS is performed from the surface of the positive electrode active material 100, the ratio of the number of magnesium atoms Mg to the number of cobalt atoms Co (Mg/Co) is preferably less than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is higher than that of fluorine in the surface portion 100a.

Moreover, excess nickel might hinder diffusion of lithium; thus, the concentration of magnesium is preferably higher than that of nickel in the surface portion 100a. For example, when measurement by XPS is performed from the surface of the positive electrode active material 100, the number of nickel atoms is preferably less than or equal to one-sixth that of magnesium atoms.

Some additive elements, in particular, magnesium, nickel, and aluminum preferably exist at higher concentrations in the surface portion 100a than in the inner portion 100b and may exist randomly at low concentrations also in the inner portion 100b. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of suppressing dissolution of magnesium can be expected in a manner similar to the above.

It is preferable that the crystal structure continuously change from the inner portion 100b toward the surface owing to the above-described concentration gradient of the additive element. Alternatively, the crystal orientations of the surface portion 100a and the inner portion 100b are preferably substantially aligned with each other.

For example, a crystal structure preferably changes continuously from the layered rock-salt inner portion 100b toward the surface and the surface portion 100a that have a rock-salt structure or have features of both a rock-salt structure and a layered rock-salt structure. Alternatively, the orientation of the surface portion 100a that has a rock-salt structure or has the features of both a rock-salt structure and a layered rock-salt structure and the orientation of the inner portion 100b having the layered rock-salt structure are preferably substantially aligned with each other.

In this specification and the like, a layered rock-salt crystal structure, which belongs to the space group R-3m, of a composite oxide containing lithium and the transition metal such as cobalt refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be determined from electron diffraction, a TEM image, a cross-sectional STEM image, or the like.

There is no distinction among cation sites in a rock-salt structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, for instance, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ crystal and a monoclinic O1(15) crystal described later are presumed to form a cubic close-packed structure. Thus, when a layered rock-salt crystal and a rock-salt crystal are in contact with each other, there is a crystal plane at which orientations of cubic closest packed structures composed of anions are aligned with each other.

The description can also be made as follows. Anions on the {111}plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111}plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases. In addition, topotaxy refers to having similarity in a three-dimensional structure such that crystal orientations are substantially aligned with each other, or to having the same orientations crystallographically.

The crystal orientations in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an electron diffraction pattern, and an FFT pattern of a TEM image, a STEM image, and the like. For determination, XRD (X-ray Diffraction), electron diffraction, neutron diffraction, and the like can also be used.

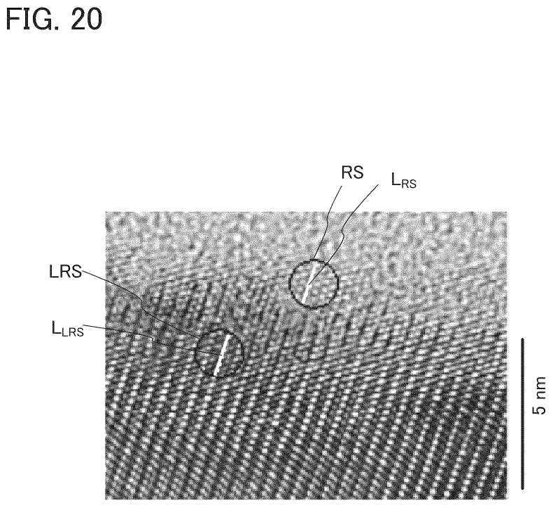

FIG. 20 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 20) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be determined that orientations of the crystals are substantially aligned with each other.

In a HAADF-STEM image, a contrast proportional to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be determined that arrangements of the atoms are substantially aligned with each other, that is, orientations of the crystals are substantially aligned with each other. Similarly, when the angle between the dark lines is 5° or less or 2.5° or less, it can be determined that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be determined as in a HAADF-STEM image.

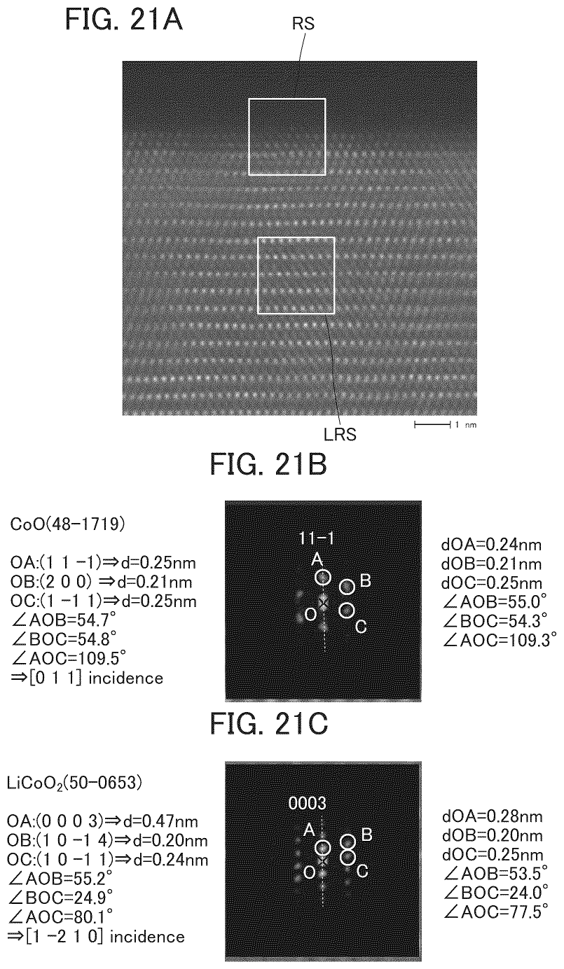

FIG. 21A shows an example of a STEM image in which orientations of the layered rock-salt crystal LRS and the rock-salt crystal RS are substantially aligned with each other. FIG. 21B shows an FFT pattern of a region of the rock-salt crystal RS, and FIG. 21C shows an FFT pattern of a region of the layered rock-salt crystal LRS. In FIG. 21B and FIG. 21C, the composition, the JCPDS card number, and d values and angles to be calculated are shown on the left. The measured values are shown on the right. A spot denoted by O is zero-order diffraction.

A spot denoted by A in FIG. 21B is derived from 11-1 reflection of a cubic structure. A spot denoted by A in FIG. 21C is derived from 0003 reflection of a layered rock-salt structure. It is found from FIG. 21B and FIG. 21C that the direction of the 11-1 reflection of the cubic structure and the direction of the 0003 reflection of the layered rock-salt structure are substantially aligned with each other. That is, a straight line passing through AO in FIG. 21B is substantially parallel to a straight line passing through AO in FIG. 21C. Here, the terms “substantially aligned” and “substantially parallel” mean that the angle is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 21C is derived from 1014 reflection of the layered rock-salt structure. This is sometimes observed at a position where the difference in orientation from the reciprocal lattice point derived from the 0003 reflection of the layered rock-salt structure (A in FIG. 21C) is greater than or equal to 52° and less than or equal to 56° (i.e., ∠AOB is greater than or equal to 52° and less than or equal to 56°) and d is greater than or equal to 0.19 nm and less than or equal to 0.21 nm. Note that these indices are just examples, and the spot does not necessarily correspond with them. For example, the spot may be a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 21B is derived from 200 reflection of the cubic structure. This diffraction spot is sometimes observed at a position where the difference in orientation from the spot derived from the 11-1 reflection of the cubic structure (A in FIG. 21B) is greater than or equal to 54° and less than or equal to 56° (i.e., ∠AOB is greater than or equal to 54° and less than or equal to 56°). Note that these indices are just examples, and the spot does not necessarily correspond with them. For example, the spot may be a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To determine whether crystal orientations are aligned, a sample is preferably processed to be thin so that the (0003) plane of the layered rock-salt structure is easily observed.

<<State where x in LixCoO₂ is Small>>

The crystal structure in a state where x in LixCoO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

A conventional positive electrode active material and the positive electrode active material 100 of one embodiment of the present invention are compared and changes in crystal structures owing to a change in x in LixCoO₂ will be described with reference to FIG. 22 to FIG. 27.

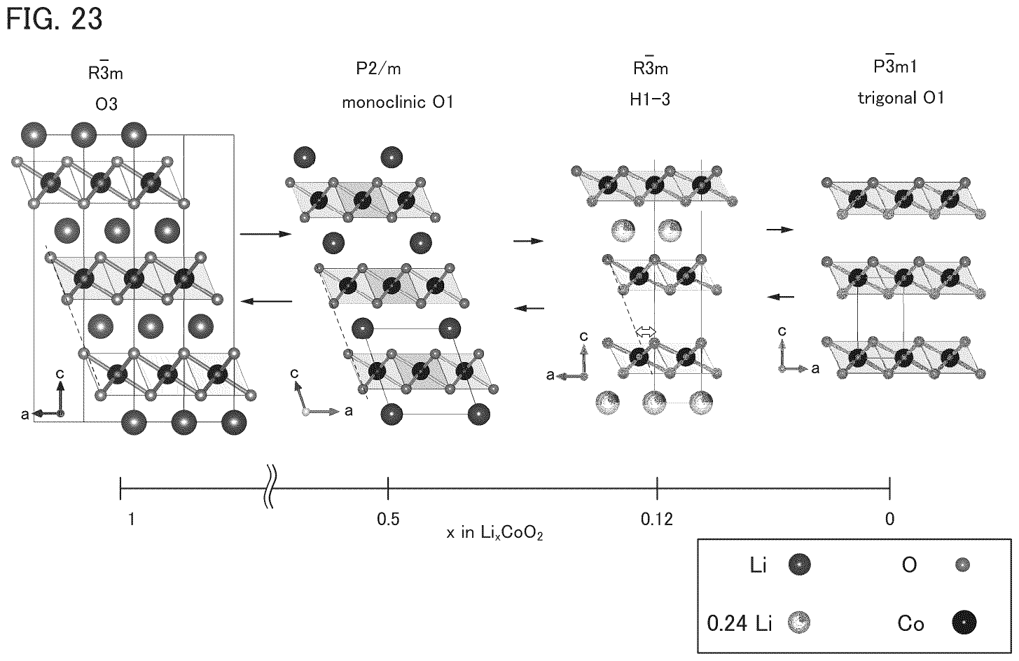

A change in the crystal structure of the conventional positive electrode active material is illustrated in FIG. 23. The conventional positive electrode active material shown in FIG. 23 is lithium cobalt oxide (LiCoO₂) without an additive element in particular. A change in the crystal structure of lithium cobalt oxide containing no additive element is described in Non-Patent Document 1 to Non-Patent Document 4 and the like.

In FIG. 23, the crystal structure of lithium cobalt oxide with x in LixCoO₂ of 1 is denoted by R-3m O3. In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure (“monoclinic” in the drawing) belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure (“trigonal in the drawing) belonging to the space group P-3m1 and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x of approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in the positive electrode active material in reality, the lithium concentrations can vary; thus, the H1-3 type crystal structure is started to be observed when x is approximately 0.25 experimentally. The number of cobalt atoms per unit cell in the actual H1-3 type crystal structure is twice that in other structures. However, in this specification including FIG. 23, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150+0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small.

When charging that makes x in LixCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrows in FIG. 23, the CoO₂ layer in the H1-3 type crystal structure largely shifts from that in R-3m O3 in a discharged state. Such a dynamic structural change can adversely affect the stability of the crystal structure.

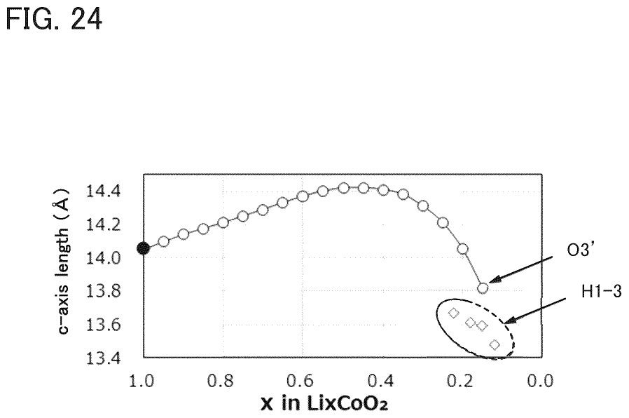

A difference in volume between these two crystal structures is also large. The crystal structure and the volume of the unit cell of lithium cobalt oxide change in accordance with a change in charge depth, i.e., a change in x in LixCoO₂. FIG. 24 shows a change in c-axis length of conventional lithium cobalt oxide described in Non-Patent Document 4. A circle indicates a hexagonal phase and a rhombus indicates a monoclinic phase. The c-axis length contracts in an H1-3 phase as shown by the rhombuses in FIG. 24. The phase transition from an O3 phase to an H1-3 phase is due to extraction of lithium ions, whereby a phase transition probably occurs from a surface of a positive electrode active material from which lithium ions are extracted first and eventually spreads to the entire positive electrode active material. In the case where the additive element is distributed insufficiently, H1-3 is formed when x in LixCoO₂ is approximately 0.2. For example, when the maximum value of the magnesium concentration in the surface portion is lower than 1 at %, the c-axis length contracts; thus, O3′ is probably not formed.

A change in c-axis length of lithium cobalt oxide corresponds to a change in the angle at which a peak of, for example, the (003) plane of lithium cobalt oxide appears in an XRD pattern. It is known that a peak of the (003) plane of lithium cobalt oxide appears at around 20=19° to 20° in XRD using CuKα₁ radiation.

Thus, when the H1-3 type structure and the R-3m O3 type structure in a discharged state contain the same number of cobalt atoms, these structures have a difference in volume of greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

On the other hand, in the positive electrode active material 100 of one embodiment of the present invention illustrated in FIG. 22, a change in the crystal structure between a discharged state with x in LixCoO₂ being 1 and a state with x being 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging that makes x be 0.24 or less and discharging are repeated, and can enable excellent cycle performance. In addition, the positive electrode active material 100 of one embodiment of the present invention with x in LixCoO₂ being 0.24 or less can have a more stable crystal structure than a conventional positive electrode active material. Thus, the positive electrode active material 100 of one embodiment of the present invention with x in LixCoO₂ being kept at 0.24 or less inhibits a short circuit. This is preferable because the safety of the secondary battery is improved.

FIG. 22 shows crystal structures of the inner portion 100b of the positive electrode active material 100 in a state where x in LixCoO₂ is approximately 1, in a state where x in LixCoO₂ is approximately 0.2, and in a state where x in LixCoO₂ is approximately 0.15. The inner portion 100b, accounting for the majority of the volume of the positive electrode active material 100, largely contributes to charging and discharging and is accordingly a portion where a shift in CoO₂ layers and a volume change matter most.

The positive electrode active material 100 with x being 1 has the R-3m O3 type crystal structure, which is the same as that of conventional lithium cobalt oxide.

However, the positive electrode active material 100 has a crystal structure different from the H1-3 type crystal structure when x is 0.24 or less, e.g., approximately 0.2 or approximately 0.15, with which conventional lithium cobalt oxide has the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 22, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (A), further preferably 2.807≤a≤2.827 (A), typically a=2.817 (A). The lattice constant of the c-axis is preferably 13.681≤c≤13.881 (A), further preferably 13.751≤c≤13.811 (A), typically c=13.781 (A).

The positive electrode active material 100 of one embodiment of the present invention with x being approximately 0.15 has a monoclinic crystal structure belonging to the space group P2/m. This structure includes one CoO₂ layer in a unit cell. Here, lithium in the positive electrode active material 100 is approximately 15 at % of that in a discharged state. Thus, this crystal structure is referred to as a monoclinic O1(15) type crystal structure. In FIG. 22, this crystal structure is denoted by P2/m monoclinic O1(15).

In the unit cell of the monoclinic O1(15) type crystal structure, the coordinates of cobalt and oxygen can be represented by Co1 (0.5, 0, 0.5), Co2 (0, 0.5, 0.5), O1 (X_{O1}, 0, Z_{O1}) within the ranges of 0.23≤X_{O1}≤0.24 and 0.61≤Z_{O1}≤0.65, and O2 (X_{O2}, 0.5, Z_{O2}) within the ranges of 0.75≤X_{O2}≤0.78 and 0.68≤Z_{O2}≤0.71. The unit cell has lattice constants of a=4.880±0.05 Å, b=2.817±0.05 Å, c=4.839±0.05 Å, α=90°, β=109.6±0.1°, and γ=90°.

Note that this crystal structure can have the lattice constants even when belonging to the space group R-3m if a certain error is allowed. In this case, the coordinates of cobalt and oxygen in the unit cell can be represented by Co (0, 0, 0.5) and O (0, 0, Z_{O}) within the range of 0.21≤Z_{O}≤0.23. The unit cell has lattice constants of a=2.817±0.02 Å and c=13.68±0.1 Å.

In both of the O3′ type crystal structure and the monoclinic O1(15) type crystal structure, an ion of cobalt, nickel, magnesium, or the like occupies a site coordinated to six oxygen atoms. Note that light elements such as lithium and magnesium sometimes occupy a site coordinated to four oxygen atoms.

As denoted by the dotted lines in FIG. 22, the CoO₂ layers hardly shift between the R-3m O3 type crystal structure in a discharged state, the O3′ type crystal structure, and the monoclinic O1(15) type crystal structure.

The R-3m O3 type crystal structure in a discharged state and the O3′ type crystal structure that contain the same number of cobalt atoms have a difference in volume of 2.5% or less, specifically 2.2% or less, typically 1.8%.

The R-3m O3 type crystal structure in a discharged state and the monoclinic O1(15) type crystal structure that contain the same number of cobalt atoms have a difference in volume of 3.3% or less, specifically 3.0% or less, typically 2.5%.

Table 1 shows a difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m O3 type structure in a discharged state and the trigonal O1 type structure in Table 1, which are used for the calculation, the literature values can be referred to (ICSD coll. code. 172909 and 88721). For the lattice constants of the H1-3 type structure, Non-Patent Document 3 can be referred to. In the case of the O3′ type structure and the monoclinic O1(15) type structure, the lattice constants thereof can be calculated from the experimental values of XRD.

TABLE 1

| | Lattice constant | | | | Volume of | Volume per | Volume change |
|---|---|---|---|---|---|---|---|
| Crystal structure | a (Å) | b (Å) | c (Å) | β (°) | unit cell (Å³) | Co atom (Å³) | percentage (%) |
| R-3m O3 | 2.816 | 2.816 | 14.05 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 | 2.805 | 2.805 | 4.251 | 90 | 28.96 | 28.96 | 10.0 |
| (CoO_{1.92}) | | | | | | | |

As described above, in the positive electrode active material 100 of one embodiment of the present invention, a change in the crystal structure caused when x in LiXCoO₂ is small, i.e., when a large amount of lithium is extracted, is smaller than that in a conventional positive electrode active material. In addition, a change in the volume between the compared structures having the same number of cobalt atoms is inhibited. Thus, the crystal structure of the positive electrode active material 100 is less likely to break even when charging that makes x be 0.24 or less and discharging are repeated. Thus, the positive electrode active material 100 inhibits a decrease in charge and discharge capacity of in charge and discharge cycles. Furthermore, the positive electrode active material 100 can stably use a larger amount of lithium than a conventional positive electrode active material and thus enables high discharge capacity per weight and per volume. Thus, with the use of the positive electrode active material 100, a secondary battery with high discharge capacity per weight and per volume can be fabricated.

Note that the positive electrode active material 100 is confirmed to have the O3′ type crystal structure in some cases when x in LixCoO₂ is greater than or equal to 0.15 and less than or equal to 0.24, and is assumed to have the O3′ type crystal structure even when x is greater than 0.24 and less than or equal to 0.27. In addition, the positive electrode active material 100 is confirmed to have the monoclinic O1(15) type crystal structure in some cases when x in LixCoO₂ is greater than 0.1 and less than or equal to 0.2, typically greater than or equal to 0.15 and less than or equal to 0.17. However, the crystal structure is influenced by not only λ in LixCoO₂ but also the number of charge and discharge cycles, a charge current and a discharge current, temperature, an electrolyte, and the like, so that the range of x is not limited to the above.

Thus, when x in LixCoO₂ is greater than 0.1 and less than or equal to 0.24, the positive electrode active material 100 may have only the O3′ type crystal structure, only the monoclinic O1(15) type crystal structure, or both of them. Not all particles of the inner portion 100b of the positive electrode active material 100 necessarily have the O3′ type crystal structure and/or the monoclinic O1(15) type crystal structure. The positive electrode active material may have another crystal structure or may be partly amorphous.

In order to make x in LixCoO₂ small, charging at a high charge voltage is necessary in general. Thus, the state where x in LixCoO₂ is small can be rephrased as a state where charging at a high charge voltage has been performed. For example, when CC/CV charging is performed at 25° C. and 4.6 V or higher with reference to the potential of a lithium metal, the H1-3 type crystal structure appears in a conventional positive electrode active material. Thus, a charge voltage of 4.6 V or higher can be regarded as a high charge voltage with reference to the potential of lithium metal. In this specification and the like, unless otherwise specified, a charge voltage is shown with reference to the potential of lithium metal.

Thus, in other words, the positive electrode active material 100 of one embodiment of the present invention is preferable because the crystal structure with the symmetry of R-3m O3 can be maintained even when charging at a high charge voltage of 4.6 V or higher is performed at 25° C., for example. In other words, the positive electrode active material 100 of one embodiment of the present invention is preferable because the O3′ type crystal structure can be obtained when charging at a higher charge voltage, e.g., a voltage higher than or equal to 4.65 V and lower than or equal to 4.7 V is performed at 25° C. In other words, the positive electrode active material 100 of one embodiment of the present invention is preferable because the monoclinic O1(15) type crystal structure can be obtained when charging at an even higher charge voltage, e.g., a voltage higher than 4.7 V and lower than or equal to 4.8 V is performed at 25° C.

In the positive electrode active material 100, when the charge voltage is increased, the H1-3 type crystal structure is eventually observed in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C. Similarly, the positive electrode active material 100 may sometimes have the monoclinic O1(15) type crystal structure at a charge voltage higher than or equal to 4.65 V and lower than or equal to 4.7 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ and monoclinic O1(15) in FIG. 22, one embodiment of the present invention is not limited thereto. Lithium may exist unevenly in only some of the lithium sites; for example, lithium may symmetrically exist as in the monoclinic O1 (Li_{0.5}CoO₂) shown in FIG. 23. Distribution of lithium can be analyzed by neutron diffraction, for example.

The O3′ type crystal structure and the monoclinic O1(15) crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide when charged to be Li_{0.06}NiO₂; however, pure lithium cobalt oxide or a layered rock-salt positive electrode active material containing a large amount of cobalt is known not to have the CdCl₂ type crystal structure in general.

### <<Crystal Grain Boundary>>

It is further preferable that the additive element contained in the positive electrode active material 100 of one embodiment of the present invention have the above-described distribution and be at least partly unevenly distributed at the crystal grain boundary 101 and the vicinity thereof.

Note that in this specification and the like, uneven distribution means that the concentration of an element in a certain region differs from that in another region. This may be rephrased as segregation, deposition, unevenness, deviation, or a mixture of a high-concentration portion and a low-concentration portion.

For example, the concentration of magnesium at the crystal grain boundary 101 and the vicinity thereof in the positive electrode active material 100 is preferably higher than that in the other regions in the inner portion 100b. In addition, the concentration of fluorine at the crystal grain boundary 101 and the vicinity thereof is preferably higher than that in the other regions in the inner portion 100b. In addition, the concentration of nickel at the crystal grain boundary 101 and the vicinity thereof is preferably higher than that in the other regions in the inner portion 100b. In addition, the concentration of aluminum at the crystal grain boundary 101 and the vicinity thereof is preferably higher than that in the other regions in the inner portion 100b.

The crystal grain boundary 101 is a type of plane defect. Thus, the crystal grain boundary 101 tends to be unstable and the crystal structure easily starts to change like the surface of the particle. Thus, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as an overreaction with the electrolyte solution. Thus, the median diameter (D50) is preferably greater than or equal to 1 μm and less than or equal to 100 μm, further preferably greater than or equal to 2 μm and less than or equal to 40 μm, still further preferably greater than or equal to 5 m and less than or equal to 30 μm. Alternatively, it is preferably greater than or equal to 1 μm and less than or equal to 40 μm. Alternatively, it is preferably greater than or equal to 1 μm and μless than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

A positive electrode is preferably formed using a mixture of particles having different particle diameters, in which case the electrode density can be increased, leading to a secondary battery with a high energy density. The positive electrode active material 100 with a relatively small particle diameter is expected to enable favorable charge-discharge rate characteristics. The positive electrode active material 100 with a relatively large particle diameter is expected to enable the charge and discharge cycle performance to be excellent and the discharge capacity to be maintained high.

### <Analysis Method>

Whether or not a given positive electrode active material is the positive electrode active material 100 of one embodiment of the present invention, which has the O3′ type crystal structure and/or monoclinic O1(15) type crystal structure when x in LixCoO₂ is small, can be determined by analyzing a positive electrode including the positive electrode active material with small x in LixCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is measured by powder XRD, the measurement is preferably performed while the influence of orientation due to pressure or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100 of one embodiment of the present invention has a feature of a small change in the crystal structure between when x in LixCoO₂ is 1 and when x is less than or equal to 0.24. A material 50% or more of which has the crystal structure to be largely changed by high-voltage charging is not preferable because the material cannot withstand high-voltage charging and discharging.

It should be noted that the O3′ type crystal structure or the monoclinic O1(15) type crystal structure is not obtained in some cases only by addition of the additive element. For example, when x in LixCoO₂ is less than or equal to 0.24, lithium cobalt oxide containing magnesium and fluorine or lithium cobalt oxide containing magnesium and aluminum has the O3′ type crystal structure and/or the monoclinic O1(15) type crystal structure at 60% or more in some cases, and has the H1-3 type crystal structure at 50% or more in other cases, depending on the concentration and distribution of the additive element.

In addition, in the case where x is too small, e.g., 0.1 or less, or under the condition where charge voltage is higher than 4.9 V, even the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether the distribution of the additive element contained in a positive electrode active material is in the above-described state can be determined by, for example, analysis using XPS, energy dispersive X-ray spectroscopy (EDX), EPMA (Electron Probe Micro Analysis), or the like.

The crystal structure of the surface portion 100a, the crystal grain boundary 101, or the like can be analyzed by electron diffraction of a cross section of the positive electrode active material 100, for example.

### <<Charging Method>>

Charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of slurry in which the positive electrode active material, a conductive material, and a binder are mixed to a positive electrode current collector made of aluminum foil.

Lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated under the above conditions is charged with a given voltage (e.g., 4.5 V, 4.55 V, 4.6 V, 4.65 V, 4.7 V, 4.75 V, or 4.8 V). The charging method is not particularly limited as long as charging with a given voltage can be performed for sufficient time. In the case of CC/CV charging, for example, CC charging can be performed with a current higher than or equal to 20 mA/g and lower than or equal to 100 mA/g. CV charging can be ended with a current higher than or equal to 2 mA/g and lower than or equal to 10 mA/g. To observe a phase change of the positive electrode active material, charging with such a small current value is preferably performed. Meanwhile, in the case where a current does not reach higher than or equal to 2 mA/g and lower than or equal to 10 mA/g even when CV charge is performed for a long time, the CV charge may be ended after the sufficient time passes from the start because the current is probably consumed not for charging the positive electrode active material but for decomposing the electrolyte solution. The sufficient time in that case can be longer than or equal to 1.5 hours and shorter than or equal to 3 hours. The temperature is set to 25° C. or 45° C. After charging is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charging is completed, the positive electrode is preferably taken out and subjected to the analysis immediately. Specifically, the positive electrode is preferably subjected to analysis within an hour, further preferably within 30 minutes after the completion of charging.

In the case where the crystal structure in a charged state after charging and discharging are performed multiple times is analyzed, the conditions of the charging and discharging performed multiple times may be different from the above-described charge conditions. For example, the charging can be performed by constant current charging with a current value greater than or equal to 20 mA/g and less than or equal to 100 mA/g to a given voltage (e.g., 4.6 V, 4.65 V, 4.7 V, 4.75 V, or 4.8 V) and then constant voltage charging until the current value becomes greater than or equal to 2 mA/g and less than or equal to 10 mA/g. The discharging can be performed by constant current discharging with greater than or equal to 20 mA/g and less than or equal to 100 mA/g to 2.5 V.

Also in the case where the crystal structure in a discharged state after the charging and discharging are performed multiple times is analyzed, constant current discharging can be performed with a current value greater than or equal to 20 mA/g and less than or equal to 100 mA/g to 2.5 V, for example.

### <<XRD>>

The apparatus and conditions for the XRD measurement are not particularly limited. For example, the measurement can be performed using the following apparatus and conditions.
XRD apparatus: D8 ADVANCE produced by Bruker AXS
X-ray source: CuKα₁ radiation
Output: 40 kV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

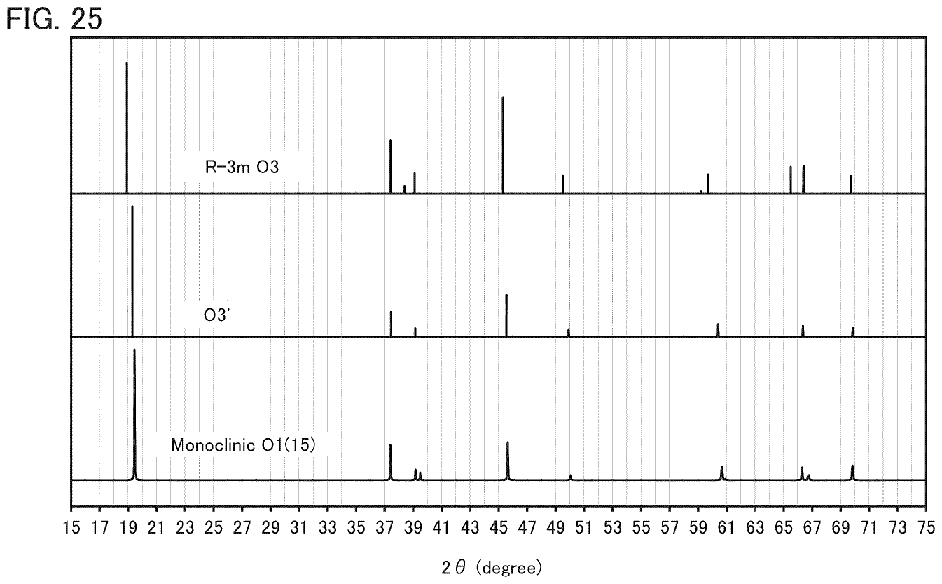

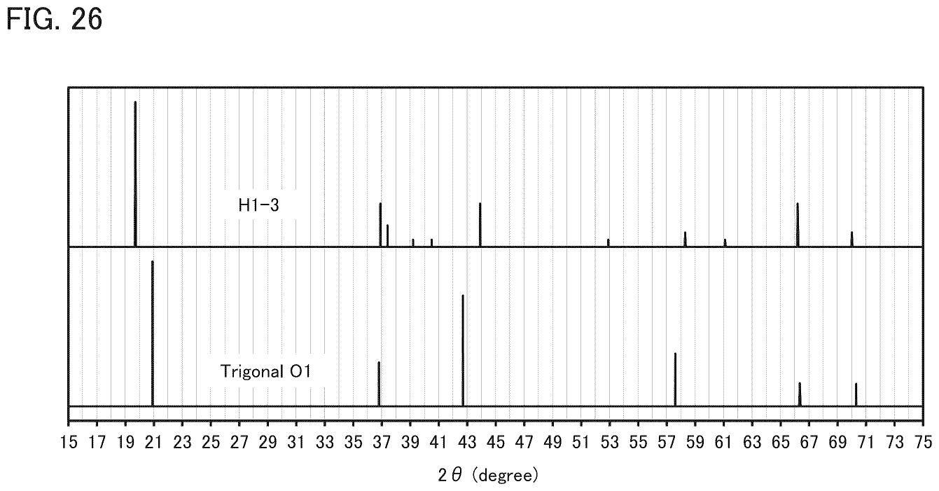

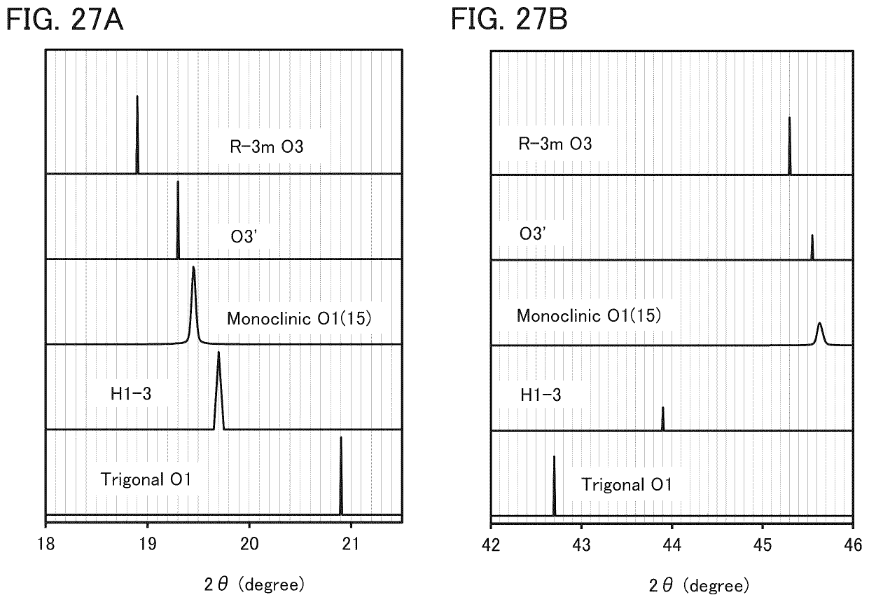

FIG. 25, FIG. 26, FIG. 27A, and FIG. 27B show ideal powder XRD patterns with CuKα₁ radiation that are calculated from models of the O3′ type crystal structure, the monoclinic O1(15) type crystal structure, and the H1-3 type crystal structure. For comparison, ideal XRD patterns calculated from the crystal structure of LiCoO₂ O₃ with x=1 in LixCoO₂ and the crystal structure of the trigonal O1 with x=0 are also shown. FIG. 27A and FIG. 27B each show the XRD patterns of the O3′ type crystal structure, the monoclinic O1(15) type crystal structure, and the H1-3 type crystal structure, and FIG. 27A and FIG. 27B are enlarged diagrams showing, respectively, a range of 2θ greater than or equal to 18° and less than or equal to 21° and a range of 20 greater than or equal to 42° and less than or equal to 46°. Note that the patterns of LiCoO₂ (O3) and CoO₂ (O1) are made from crystal structure data obtained from the ICSD (Inorganic Crystal Structure Database) (see Non-Patent Document 5) with Reflex Powder Diffraction, which is a module of Materials Studio (BIOVIA). The 20 range is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 3. The O3′ type crystal structure and the monoclinic O1(15) type crystal structure are estimated from the XRD pattern of the positive electrode active material of one embodiment of the present invention, the crystal structure is fitted with TOPAS ver. 3 (crystal structure analysis software produced by Bruker Corporation), and the XRD patterns of the O3′ type crystal structure and the monoclinic O1(15) type crystal structure are made in a manner similar to that for other structures.

As shown in FIG. 25, FIG. 27A, and FIG. 27B, the O3′ type crystal structure exhibits diffraction peaks at 2θ=19.25±0.12° (greater than or equal to 19.13° and less than 19.37°) and 2θ=45.47±0.10° (greater than or equal to 45.37° and less than 45.57°).

Furthermore, the monoclinic O1(15) type crystal structure exhibits diffraction peaks at 2θ=19.47±0.10° (greater than or equal to 19.37° and less than or equal to 19.57°) and 2θ=45.62±0.05° (greater than or equal to 45.57° and less than or equal to 45.67°).

However, as shown in FIG. 26, FIG. 27A, and FIG. 27B, the H1-3 type crystal structure and the trigonal O1 do not exhibit peaks at these positions. Thus, it can be said that exhibiting peaks at greater than or equal to 19.13° and less than 19.37° and/or greater than or equal to 19.37° and less than or equal to 19.57° and at greater than or equal to 45.37° and less than 45.57° and/or greater than or equal to 45.57° and less than or equal to 45.67° in a state with small x in LixCoO₂ is the feature of the positive electrode active material 100 of one embodiment of the present invention.

It can also be said that in the positive electrode active material 100 of one embodiment of the present invention, the positions of the XRD diffraction peaks exhibited by the crystal structure with x=1 and the crystal structure with x≤0.24 are close to each other. More specifically, it can be said that a difference in 20 between the main diffraction peak exhibited by the crystal structure with x=1 and the main diffraction peak exhibited by the crystal structure with x≤0.24, which are exhibited at 20 of greater than or equal to 42° and less than or equal to 46°, is 0.7+θ or less, preferably 0.5° or less.

Although the positive electrode active material 100 of one embodiment of the present invention has the O3′ type crystal structure and/or the monoclinic O1(15) type crystal structure when x in LiₓCoO₂ is small, not all particles necessarily have the O3′ type crystal structure and/or the monoclinic O1(15) type crystal structure. The particles may include another crystal structure or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% can enable sufficiently good cycle performance.

In addition, the H1-3 type structure and the O1 type structure account for preferably less than or equal to 50%, further preferably less than or equal to 34%, in the Rietveld analysis performed in a similar manner. It is still further preferable that substantially no H1-3 type structure and substantially no O1 type structure be observed.

Furthermore, even after 100 or more cycles of charging and discharging after the measurement starts, the O3′ type crystal structure and/or the monoclinic O1(15) type crystal structure preferably account(s) for greater than or equal to 35%, further preferably greater than or equal to 40%, still further preferably greater than or equal to 43% when the Rietveld analysis is performed.

Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity contributes to stability of the crystal structure after sufficient charging.

The crystallite sizes of the O3′ type crystal structure and the monoclinic O1(15) type crystal structure included in the positive electrode active material 100 are only decreased to approximately one-twentieth that of LiCoO₂ (O3) in a discharged state. Thus, a clear peak of the O3′ type crystal structure and/or the monoclinic O1(15) type crystal structure can be observed when x in LixCoO₂ is small, even under the same XRD measurement conditions as those of a positive electrode before charging and discharging. In contrast, conventional LiCoO₂ has a small crystallite size and a broad and small peak even when it can have a structure part of which is similar to the O3′ type crystal structure and/or the monoclinic O1(15) type crystal structure. The crystallite size can be calculated from the half width of the XRD peak.

As described above, the influence of the Jahn-Teller effect is preferably small in the positive electrode active material 100 of one embodiment of the present invention. The positive electrode active material 100 may contain a transition metal such as nickel or manganese as the additive element in addition to cobalt as long as the influence of the Jahn-Teller effect is small.

The proportions of nickel and manganese and the range of the lattice constants in each of which the influence of the Jahn-Teller effect is presumed to be small in the positive electrode active material are examined by XRD analysis.

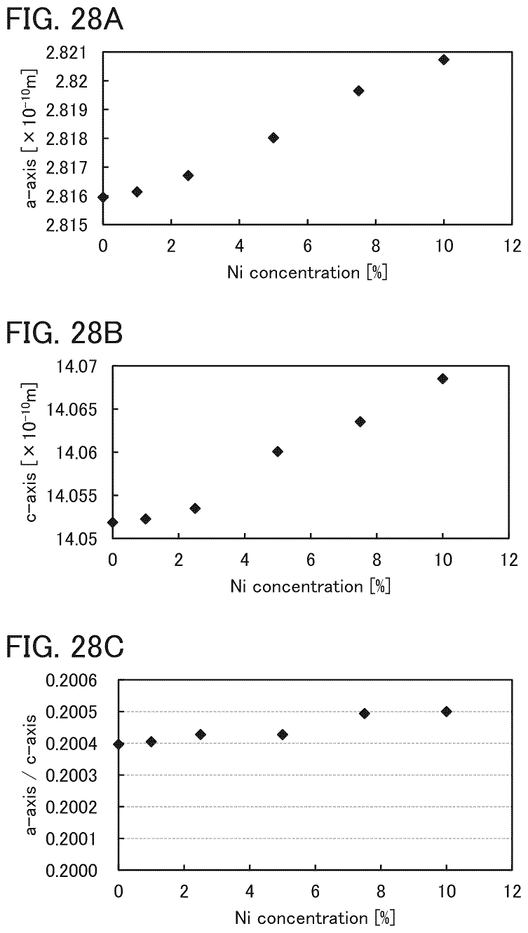

FIG. 28 shows the calculation results of the lattice constants of the a-axis and the c-axis by XRD analysis in the case where the positive electrode active material 100 of one embodiment of the present invention has a layered rock-salt crystal structure and contains cobalt and nickel. FIG. 28A shows the results of the a-axis, and FIG. 28B shows the results of the c-axis. Note that the XRD patterns of a powder after the synthesis of the positive electrode active material before incorporation into a positive electrode are used for the calculation. The nickel concentration on the horizontal axis represents a nickel concentration with the sum of cobalt atoms and nickel atoms assumed as 100%. The positive electrode active material was formed in accordance with the formation method in FIG. 23 except that the aluminum source was not used.

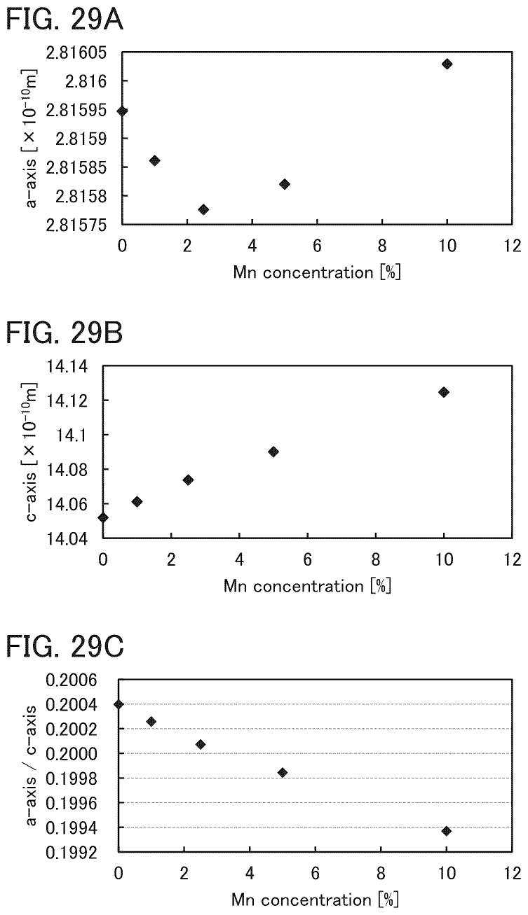

FIG. 29 shows the estimation results of the lattice constants of the a-axis and the c-axis by XRD in the case where the positive electrode active material 100 of one embodiment of the present invention has a layered rock-salt crystal structure and contains cobalt and manganese. FIG. 29A shows the results of the a-axis, and FIG. 29B shows the results of the c-axis. Note that the lattice constants shown in FIG. 29 were obtained by XRD of a powder after the synthesis of the positive electrode active material before incorporation into a positive electrode. The manganese concentration on the horizontal axis represents a manganese concentration with the sum of cobalt atoms and manganese atoms assumed as 100%. The positive electrode active material was formed in accordance with the formation method of FIG. 23 except that a manganese source was used instead of the nickel source and the aluminum source was not used.

FIG. 28C shows values obtained by dividing the lattice constants of the a-axis by the lattice constants of the c-axis (a-axis/c-axis) in the positive electrode active material, whose results of the lattice constants are shown in FIG. 28A and FIG. 28B. FIG. 29C shows values obtained by dividing the lattice constants of the a-axis by the lattice constants of the c-axis (a-axis/c-axis) in the positive electrode active material, whose results of the lattice constants are shown in FIG. 29A and FIG. 29B.

As shown in FIG. 28C, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. It is suggested that an excellent positive electrode active material with small Jahn-Teller distortion can be obtained at a nickel concentration of lower than 7.5%.

FIG. 29A indicates that the lattice constant changes differently at manganese concentrations of 5% or higher and does not follow the Vegard's law. This suggests that the crystal structure changes at a manganese concentration of 5% or higher. Thus, the manganese concentration is preferably 4% or lower, for example.

Note that the nickel concentration and the manganese concentration in the surface portion 100a are not limited to the above ranges. In other words, the nickel concentration and the manganese concentration in the surface portion 100a may be higher than the above concentrations.

Preferable ranges of the lattice constants of the positive electrode active material of one embodiment of the present invention are examined above. In the layered rock-salt crystal structure of the positive electrode active material 100 in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be, for example, the state of a powder before the fabrication of a positive electrode of a secondary battery.

Alternatively, in the layered rock-salt crystal structure of the positive electrode active material 100 in the discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charging and discharging are not performed is subjected to XRD analysis, a first peak is observed at 2θ of greater than or equal to 18.50° and less than or equal to 19.30° and a second peak is observed at 2θ of greater than or equal to 38.00° and less than or equal to 38.80°, in some cases.

### <<XPS>>

In an inorganic oxide, a region that extends from the surface to a depth of approximately 2 to 8 nm (normally, less than or equal to 5 nm) can be analyzed by X-ray photoelectron spectroscopy (XPS) using monochromatic aluminum Kα radiation as an X-ray source; thus, the concentrations of elements in a region extending to approximately half the depth of the surface portion 100a can be quantitatively analyzed by XPS. The bonding states of the elements can be analyzed by narrow scanning. Note that in many cases, the quantitative accuracy of XPS is approximately ±1 at %, and the lower detection limit is approximately 1 at % but depends on the element.

In the positive electrode active material 100 of one embodiment of the present invention, the concentration of one or two or more selected from the additive elements is preferably higher in the surface portion 100a than in the inner portion 100b. This means that the concentration of one or two or more selected from the additive elements in the surface portion 100a is preferably higher than the average concentration of the selected element(s) in the entire positive electrode active material 100. For this reason, for example, it can be said that it is preferable that the concentration of one or two or more additive elements selected from the surface portion 100a, which is measured by XPS or the like, be higher than the average concentration of the additive element(s) in the entire positive electrode active material 100, which is measured by ICP-MS (inductively coupled plasma-mass spectrometry), GD-MS (glow discharge mass spectrometry), or the like. For example, the concentration of magnesium in at least part of the surface portion 100a, which is measured by XPS or the like, is preferably higher than the concentration of magnesium in the entire positive electrode active material 100. The concentration of nickel in at least part of the surface portion 100a is preferably higher than the concentration of nickel in the entire positive electrode active material 100. The concentration of aluminum in at least part of the surface portion 100a is preferably higher than the concentration of aluminum in the entire positive electrode active material 100. The concentration of fluorine in at least part of the surface portion 100a is preferably higher than the concentration of fluorine in the entire positive electrode active material 100.

Note that the surface and the surface portion 100a of the positive electrode active material 100 of one embodiment of the present invention do not contain a carbonate, a hydroxy group, or the like which is chemically adsorbed after fabrication of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material or a positive electrode active material layer or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The ratio of the additive element to cobalt is preferably used, in which case comparison can be performed while reducing the influence of a carbonate or the like that is chemically adsorbed after formation of the positive electrode active material. For example, in the XPS analysis, the atomic ratio of magnesium to cobalt Mg/Co is preferably greater than or equal to 0.4 and less than or equal to 1.5. In the ICP-MS analysis, Mg/Co is preferably greater than or equal to 0.001 and less than or equal to 0.06.

Similarly, to secure the sufficient path through which lithium is inserted and extracted, the concentrations of lithium and cobalt are preferably higher than those of the additive elements in the surface portion 100a of the positive electrode active material 100. It can be said that the concentrations of lithium and cobalt in the surface portion 100a are preferably higher than that of one or two or more selected from the additive elements contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium is preferably higher the concentration of fluorine.

It is further preferable that aluminum be widely distributed in a deep region, e.g., a region from the surface or the reference point to a depth of greater than or equal to 5 nm and less than or equal to 50 nm. Thus, aluminum is detected by analysis on the entire positive electrode active material 100 by ICP-MS, GD-MS, or the like, but the concentration of the additive element Y such as aluminum is preferably lower than or equal to the lower detection limit in XPS or the like.

Furthermore, when XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the number is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray source, for example. An extraction angle is, for example, 45°. For example, the measurement can be performed using the following apparatus and conditions.

Measurement apparatus: Quantera II produced by PHI, Inc.

X-ray source: monochromatic Al Kα (1486.6 eV)

Detection area: 100 μmφ

Detection depth: approximately 4 to 5 nm (extraction angle 45°)

Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <<EDX>>

The one or two or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium are present and a region where oxygen and the transition metal M are absent is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, when the depth direction in a STEM-EDX line analysis or the like is mentioned, a reference point is a point where a value of the amount of the detected transition metal M is equal to 50% of the sum of the average value M_{AVE} of the amount of the detected transition metal Min the inner portion and the average value M_{BG} of the amount of the background transition metal M and a point where a value of the amount of the detected oxygen is equal to 50% of the sum of the average value O_{AVE} of the amount of detected oxygen in the inner portion and the average value O_{BG} of the amount of background oxygen. Note that in the case where the positions of the points differ between the transition metal M and oxygen, the difference is probably due to the influence of a carbonate, a metal oxide containing oxygen, or the like, which is attached to the surface. Thus, the point that is equal to 50% of the sum of the average value M_{AVE} of the amount of the detected transition metal Min the inner portion and the average value M_{BG} of the amount of the background transition metal M can be used. In the case of a positive electrode active material containing a plurality of transition metals M, the reference point can be determined using M_{AVE} and M_{BG} of an element whose count number is the largest in the inner portion 100b.

The average value M_{BG} of the amount of background transition metal M can be calculated by averaging the amounts of detected transition metal Min the range greater than or equal to 2 nm, preferably greater than or equal to 3 nm, which is outside a portion of the positive electrode active material in the vicinity of the portion at which the amount of detected transition metal M begins to increase, for example. The average value M_{AVE} of the amount of detected transition metal Min the inner portion can be calculated by averaging the amounts of detected transition metal Min the range greater than or equal to 2 nm, preferably greater than or equal to 3 nm in a region where the count numbers of transition metal M and oxygen atoms are saturated and stabilized, e.g., a portion that is greater than or equal to 30 nm, preferably greater than 50 nm in depth from the portion where the amount of detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. Alternatively, the surface refers to an intersection of a tangent drawn at a luminance profile from the surface toward the bulk and an axis in the depth direction in a STEM image. The surface in a STEM image or the like may be judged in combination with analysis with higher spatial resolution.

The spatial resolution of STEM-EDX is approximately 1 nm. Thus, the maximum value of an additive element profile may be shifted by approximately 1 nm. For example, even when the maximum value of the profile of an additive element such as magnesium is outside the surface determined in the above-described manner, it can be said that a difference between the maximum value and the surface can be referred to as within the margin of error as long as the difference is less than 1 nm.

A peak in STEM-EDX line analysis refers to the maximum value of the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by measurement by scanning six times can be used as the profile of each element. The number of scanning is not limited to six and an average obtained by performing scanning seven or more times can be used as the profile of each element.

STEM-EDX line analysis can be performed as follows, for example. First, a protective film is deposited over a surface of a positive electrode active material. For example, carbon can be deposited with an ion sputter apparatus (MC1000, produced by Hitachi High-Tech Corporation).

Next, the positive electrode active material is thinned to fabricate a cross-section sample to be subjected to STEM analysis. For example, the positive electrode active material can be thinned with an FIB-SEM apparatus (XVision 200TBS, produced by Hitachi High-Tech Corporation). Here, picking up can be performed by a micro probing system (MPS), and an accelerating voltage at final processing condition can be, for example, 10 kV.

The STEM-EDX line analysis can be performed using (HD-2700 produced by Hitachi High-Tech Corporation) as a STEM apparatus and Octane T Ultra W (with two detectors) produced by EDAX Inc as EDX detectors. In the EDX line analysis, the emission current of the STEM apparatus is set to be in the range of 6 μA to 10 μA, both inclusive, and a portion of the thinned sample, which is not positioned at a deep level and has little unevenness, is measured. The magnification is 150,000 times, for example. The EDX line analysis can be performed under conditions where drift correction is performed, the line width is 42 nm, the pitch is 0.2 nm, and the number of frames is six or more.

EDX area analysis or EDX point analysis of the positive electrode active material 100 of one embodiment of the present invention preferably reveals that the concentration of each additive element, in particular, the additive element Xin the surface portion 100a is higher than that in the inner portion 100b.

For example, EDX area analysis or EDX point analysis of the positive electrode active material 100 containing magnesium as the additive element preferably reveals that the concentration of magnesium in the surface portion 100a is higher than that in the inner portion 100b. In the EDX line analysis, a peak of the concentration of magnesium in the surface portion 100a preferably exists in a region from the surface or the reference point of the positive electrode active material 100 to a depth of 3 nm, further preferably 1 nm, still further preferably 0.5 nm toward the center. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak of concentration” refers to the local maximum value of concentration.

In the EDX line analysis, the magnesium concentration (the detected amount of magnesium/the sum of the detected amounts of magnesium, oxygen, cobalt, fluorine, aluminum, and silicon) in the surface portion 100a is preferably higher than or equal to 0.5 at % and lower than or equal to 10 at %, further preferably higher than or equal to 1 at % and lower than or equal to 5 at %.

When the positive electrode active material 100 contains magnesium and fluorine as the additive elements, the distribution of fluorine preferably overlaps with the distribution of magnesium. For example, a difference in the depth direction between the peak concentration of fluorine and the peak concentration of magnesium is preferably within 10 nm, further preferably within 3 nm, still further preferably within 1 nm.

In the EDX line analysis, a peak of the concentration of fluorine in the surface portion 100a preferably exists in a region from the surface or the reference point of the positive electrode active material 100 to a depth of 3 nm, further preferably 1 nm, still further preferably 0.5 nm toward the center. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

When the positive electrode active material 100 contains nickel as the additive element, a peak of the concentration of nickel in the surface portion 100a preferably exists in a region from the surface of the positive electrode active material 100 or the reference point to a depth of 3 nm, further preferably 1 nm, still further preferably 0.5 nm toward the center. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 3 nm, further preferably within 1 nm.

In the case where the positive electrode active material 100 contains aluminum as the additive element, the peak of the concentration of magnesium, nickel, or fluorine is preferably closer to the surface than the peak of the concentration of aluminum is in the surface portion 100a in the EDX line analysis. For example, the peak of the concentration of aluminum preferably exists in a region from the surface of the positive electrode active material 100 or the reference point to a depth of greater than or equal to 0.5 nm and less than or equal to 50 nm, further preferably greater than or equal to 5 nm and less than or equal to 50 nm toward the center.

When EDX line, area, or point analysis is performed on the positive electrode active material 100, the atomic ratio of magnesium Mg to cobalt Co (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the concentration of aluminum is preferably greater than or equal to 0.05 and less than or equal to 0.6, further preferably greater than or equal to 0.1 and less than or equal to 0.45. The atomic ratio of nickel Ni to cobalt Co (Ni/Co) at a peak of the concentration of nickel is preferably greater than or equal to 0 and less than or equal to 0.2, further preferably greater than or equal to 0.01 and less than or equal to 0.1. The atomic ratio of fluorine F to cobalt Co (F/Co) at a peak of the concentration of fluorine is preferably greater than or equal to 0 and less than or equal to 1.6, further preferably greater than or equal to 0.1 and less than or equal to 1.4.

When the line analysis or the area analysis is performed on the positive electrode active material 100, the atomic ratio of the additive element A to cobalt Co (A/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100 containing magnesium as the additive element, the atomic ratio of magnesium to cobalt (Mg/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<EPMA>>

Quantitative analysis of elements can be conducted also by EPMA (electron probe microanalysis). In area analysis, distribution of each element can be analyzed.

EPMA area analysis of a cross section of the positive electrode active material 100 of one embodiment of the present invention preferably reveals that one or two or more selected from the additive elements have a concentration gradient, as in the EDX analysis results. For example, it is further preferable that the additive elements exhibit concentration peaks at different depths from a surface. The preferred ranges of the concentration peaks of the additive elements are the same as those of the case of EDX.

Note that in EPMA, a region from a surface to a depth of approximately 1 μm is analyzed. Thus, the quantitative value of each element is sometimes different from measurement results obtained by other analysis methods. For example, when area analysis is performed by EPMA on the positive electrode active material 100, the concentrations of the additive elements present in the surface portion 100a might be lower than the results obtained in XPS.

### <<Raman Spectroscopy>>

As described above, at least part of the surface portion 100a of the positive electrode active material 100 of one embodiment of the present invention preferably has the rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that exists at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to the Co—O bond can be observed in some cases. Furthermore, since Raman spectroscopy can measure a range with an area of several square micrometers and a depth of approximately 1 μm of a surface portion, a Co—O bond only at the surface of a particle can be observed with high sensitivity.

When a laser wavelength is 532 nm, for example, peaks (vibration mode: E_{g}, A_{1g}) of LiCoO₂ having a layered rock-salt crystal structure are observed in ranges from 470 cm⁻¹ to 490 cm⁻¹ and from 580 cm⁻¹ to 600 cm⁻¹. Meanwhile, a peak (vibration mode: A_{1g}) of cubic CoOₓ (0<x<1) (Co_{1-y}O having a rock-salt crystal structure (0<y<1) or Co₃O₄ having a spinel crystal structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that a preferable range of the surface portion 100a of the positive electrode active material 100 has a rock-salt crystal structure.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a portion from the surface to a depth of 1 nm). This is because a diffusion path of lithium can be secured and a function of stabilizing a crystal structure can be enhanced in the case where the additive element such as magnesium exists in the lithium layer while the outermost surface has a layered rock-salt crystal structure as compared with the case where the outermost surface is covered with a rock-salt crystal structure.

Therefore, for example, when a nanobeam electron diffraction pattern of a region ranging from the surface to a depth of 1 nm or less and a nanobeam electron diffraction pattern of a region ranging from a depth from the surface of 3 nm or more to a depth from the surface of 10 nm or less are obtained, a difference between lattice constants calculated from the patterns is preferably small.

For example, a difference between lattice constants calculated from a measured portion from the surface to a depth of 1 nm or less and a measured portion ranging from a depth from the surface of 3 nm or more to a depth from the surface of 10 nm or less is preferably less than or equal to 0.1 Å for the a-axis and less than or equal to 1.0 Å for the c-axis. The difference is further preferably less than or equal to 0.05 Å for the a-axis and further preferably less than or equal to 0.6 Å for the c-axis. The difference is still further preferably less than or equal to 0.04 Å for the a-axis and still further preferably less than or equal to 0.3 Å for the c-axis.

### <<Surface Roughness and Specific Surface Area>>

The positive electrode active material 100 of one embodiment of the present invention preferably has a smooth surface with little unevenness. A smooth surface with little unevenness indicates that a fusing agent described later is fully effective and the surfaces of the additive element source and lithium cobalt oxide melt. Thus, a smooth surface with little unevenness indicates favorable distribution of the additive element in the surface portion 100a.

A smooth surface with little unevenness can be determined from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the surface of the particle of the positive electrode active material 100 of this embodiment, root-mean-square surface roughness (RMS), which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Document 8 to Non-Patent Document 10 can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area S_{R} measured by a constant-volume gas adsorption method to an ideal specific surface area Sᵢ.

The ideal specific surface area Sᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area S_{R} to the ideal specific surface area Sᵢ obtained from the median diameter D50 (S_{R}/Sᵢ) is preferably lower than or equal to 2.1.

Alternatively, the level of the surface smoothness of the positive electrode active material 100 can be quantified from its cross-sectional SEM image by the following method.

First, a surface SEM image of the positive electrode active material 100 is obtained. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The quantified value is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <Additional Features>

The positive electrode active material 100 has a depression, a crack, a concave, a V-shaped cross section, or the like in some cases. These are examples of defects, and when charging and discharging are repeated, dissolution of cobalt, breakage of a crystal structure, cracking of the positive electrode active material 100, extraction of oxygen, or the like might be derived from these defects. However, when there is the filling portion 102 illustrated in FIG. 1B that fills such defects, dissolution of cobalt or the like can be inhibited. Thus, the positive electrode active material 100 can have excellent reliability and enable excellent cycle performance.

As described above, an excessive amount of the additive element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b of the positive electrode active material 100, so that the additive element concentration can be appropriate in the inner portion 100b. This can inhibit an internal resistance increase, a charge and discharge capacity decrease, and the like when a secondary battery is fabricated. A feature of inhibiting an internal resistance increase in a secondary battery is extremely preferable especially in charging and discharging with a large amount of current such as charging and discharging at 400 mA/g or more.

In the positive electrode active material 100 including the region where the additive element is unevenly distributed, mixing of excess additive elements to some extent in the formation process is acceptable. This is preferable because the margin of production can be increased.

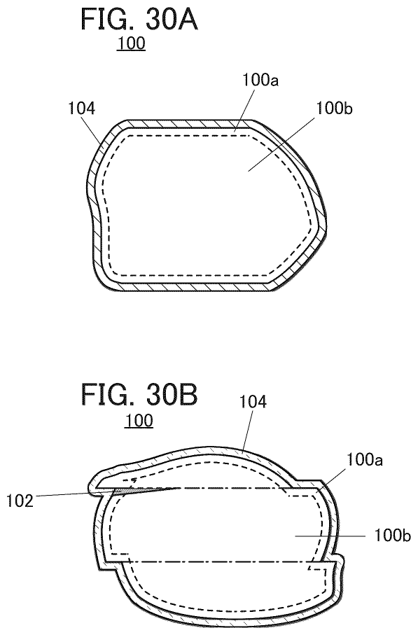

A coating portion may be attached to at least part of the surface of the positive electrode active material 100. FIG. 30A and FIG. 30B illustrate examples of the positive electrode active material 100 to which the coating portion 104 is attached.

The coating portion 104 is preferably formed by deposition of a decomposition product of an electrolyte and an organic electrolyte solution due to charging and discharging, for example. A coating portion originating from an electrolyte solution, which is formed on the surface of the positive electrode active material 100, is expected to improve charge and discharge cycle performance particularly when charging that makes x in LixCoO₂ be 0.24 or less is repeated. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution includes LiBOB and/or suberonitrile (SUN), for example. Accordingly, the coating portion 104 preferably contains one or two or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100.

This embodiment can be used in combination with the other embodiments.

### Embodiment 3

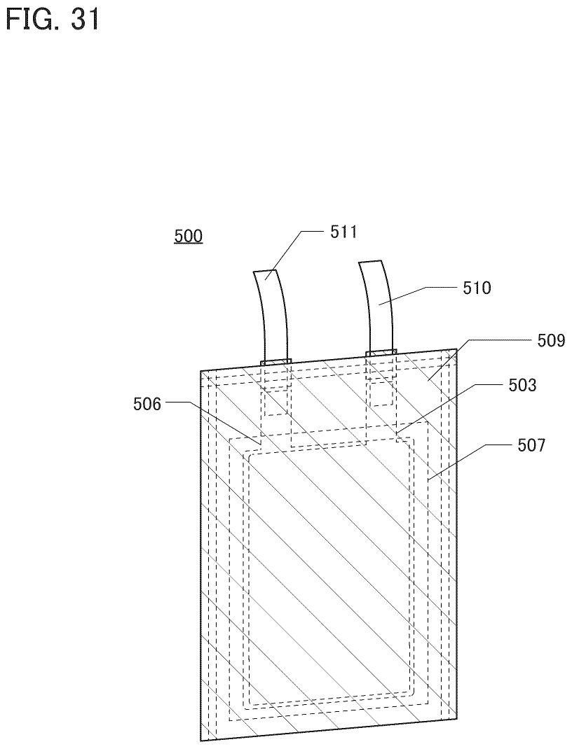

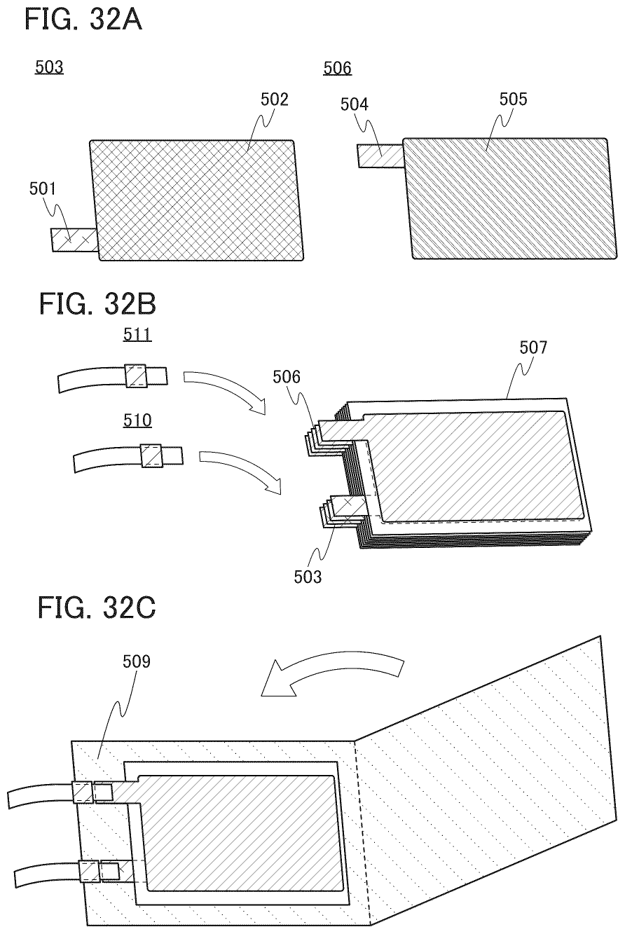

In this embodiment, an example of a secondary battery of one embodiment of the present invention will be described with reference to FIG. 31 and FIG. 32.

### <Structure Example of Secondary Battery>

Hereinafter, a secondary battery illustrated in FIG. 31 in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer contains a positive electrode active material and may contain a conductive material (synonymous with a conductive additive) and a binder. As the positive electrode active material, the positive electrode active material formed by the formation method described in the above embodiments is used.

The positive electrode active material described in the above embodiments and another positive electrode active material may be mixed to be used.

Examples of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ is given.

As the another positive electrode active material, it is preferable to mix lithium nickel oxide (LiNiO₂, LiNi₁₋ₓMₓO₂ (0<x<1) (M=Co, Al, or the like), or the like) with a lithium-containing material that has a spinel crystal structure and contains manganese, such as LiMn₂O₄. This composition can improve the characteristics of the secondary battery.

As the conductive material, a carbon-based material such as acetylene black can be used. In addition, carbon nanotube, graphene, or a graphene compound can be used as the conductive material.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring of carbon is referred to as a carbon sheet in some cases. A graphene compound may include a functional group. The graphene compound is preferably bent. The graphene compound may be rounded like carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 at % and the oxygen concentration is higher than or equal to 2 at % and lower than or equal to 15 at %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. The graphene compound has a sheet-like shape. The graphene compound has a curved surface in some cases, thereby enabling low-resistant surface contact. Furthermore, the graphene compound has extremely high conductivity even with a small thickness in some cases and thus allows a conductive path to be formed in an active material layer efficiently even with a small amount. Hence, when the graphene compound is used as the conductive material, the area where the active material and the conductive material are in contact with each other can be increased. The graphene compound preferably covers 80% or more of the active material. Note that the graphene compound preferably clings to at least part of an active material particle. The graphene compound preferably overlays at least part of the active material particle. The shape of the graphene compound preferably conforms to at least part of the shape of the active material particle. The shape of an active material particle means, for example, an uneven surface of a single active material particle or an uneven surface formed by a plurality of active material particles. The graphene compound preferably surrounds at least part of an active material particle. The graphene compound may have a hole.

In the case where an active material particle with a small particle diameter, e.g., 1 μm or less, is used, the specific surface area of the active material particle is large and thus more conductive paths for connecting the active material particles are needed. In such a case, a graphene compound that can efficiently form a conductive path even with a small amount is preferably used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have rapid charge and rapid discharge characteristics in some cases. In addition, a mobile electronic device or the like is required to have rapid charge characteristics in some cases. Fast charging and discharging are referred to as charging and discharging at, for example, 200 mA/g, 400 mA/g, or 1000 mA/g or more.

A plurality of sheets of graphene or graphene compounds are formed to partly coat or adhere to surfaces of a plurality of particles of a positive electrode active material, so that the plurality of sheets of graphene or graphene compounds preferably make surface contact with the particles of the positive electrode active material.

Here, the plurality of sheets of graphene or graphene compounds can be bonded to each other to form a net-like graphene compound sheet (hereinafter, referred to as a graphene compound net or a graphene net). A graphene net that covers the active material can function also as a binder for bonding the active materials. Accordingly, the amount of the binder can be reduced, or the binder does not have to be used. This can increase the proportion of the active material in the electrode volume and the electrode weight. That is to say, the discharge capacity of the secondary battery can be increased.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination as the binder.

### [Current Collector]

The current collector can be formed using a material that has high conductivity, such as a metal like stainless steel, gold, platinum, aluminum, or titanium, or an alloy thereof. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may include a conductive material and a binder.

### [Negative Electrode Active Material]

As the negative electrode active material, an alloy-based material and/or a carbon-based material can be used, for example.

As the negative electrode active material, an element that enables charge and discharge reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, SiO refers, for example, to silicon monoxide. Alternatively, SiO can be expressed as SiOₓ. Here, x is preferably an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

The use of one or more kinds of ionic liquids (room temperature molten salts) which have features of non-flammability and non-volatility as the solvent of the electrolyte solution can prevent a secondary battery from exploding and/or catching fire even when the internal temperature increases due to an internal short circuit or overcharging of the secondary battery, for example. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

As the electrolyte solution used for the secondary battery, it is preferable to use an electrolyte solution that is highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. It is particularly preferable to use VC or LiBOB because it facilitates formation of a favorable coating portion.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Laminated Secondary Battery and Manufacturing Method Thereof>

FIG. 31 and FIG. 32 illustrate an example of an external view of a laminated secondary battery 500. In FIG. 31 and FIG. 32, a positive electrode 503, a negative electrode 506, a separator 507, an exterior body 509, a positive electrode lead electrode 510, and a negative electrode lead electrode 511 are included. When the laminated secondary battery has flexibility and is used in an electronic device at least part of which is flexible, the secondary battery can be bent as the electronic device is bent. An example of a method for manufacturing the laminated secondary battery will be described with reference to FIG. 32A to FIG. 32C.

FIG. 32A illustrates external views of the positive electrode 503 and the negative electrode 506. The positive electrode 503 includes a positive electrode current collector 501 and a positive electrode active material layer 502 provided over the positive electrode current collector 501. The negative electrode 506 includes a negative electrode current collector 504 and a negative electrode active material layer 505 over the negative electrode current collector 504. First, the negative electrode 506, the separator 507, and the positive electrode 503 are stacked. FIG. 32B illustrates the negative electrode 506, the separator 507, and the positive electrode 503 that are stacked. Here, an example in which five negative electrodes and four positive electrodes are used is shown. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion indicated by a dashed line as illustrated in FIG. 32C. Then, the outer edges of the exterior body 509 are bonded to each other. The bonding is performed by thermocompression, for example. At this time, an unbonded region (hereinafter referred to as an inlet) is provided for part (or one side) of the exterior body 509 so that an electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is sealed by bonding. In this manner, the laminated secondary battery 500 can be manufactured.

When the positive electrode active material described in the above embodiment is used in the positive electrode 503, the secondary battery 500 with high discharge capacity and excellent cycle performance can be obtained.

### <Thermal Runaway of Secondary Battery>

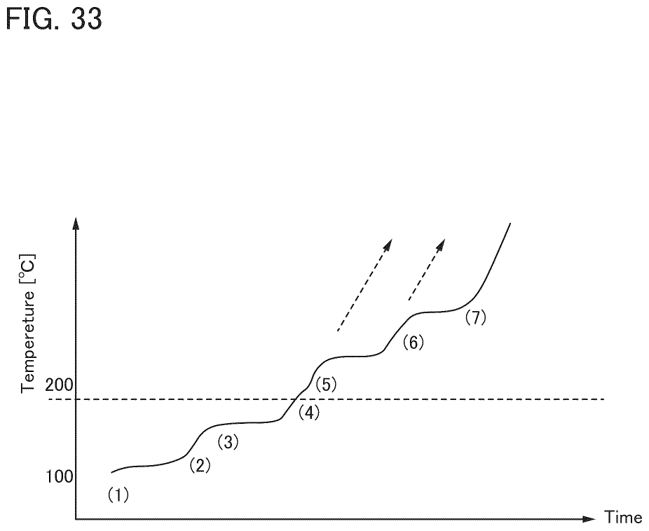

FIG. 33 is a graph obtained by partly modifying the graph cited from [FIG. 2-11] on page 69 of Non-Patent Document 15. The graph of FIG. 33 shows the internal temperature (hereinafter simply referred to as temperature) of a secondary battery with respect to time and demonstrates that when the temperature increases, the secondary battery enters thermal runaway after going through several states.

In general, when the temperature of the secondary battery reaches 100° C. or the vicinity thereof, (1) collapse of SEI (Solid Electrolyte Interphase) of a negative electrode and heat generation are caused. When the temperature of the secondary battery exceeds 100° C., (2) reduction of an electrolyte solution by the negative electrode (the negative electrode is C₆Li when graphite is used) and heat generation are caused, and (3) oxidation of the electrolyte solution by a positive electrode and heat generation are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change in a positive electrode active material) are caused. After that, when the temperature of the secondary battery exceeds 200° C., (6) decomposition of the negative electrode is caused, and finally, (7) the positive electrode and the negative electrode come into direct contact with each other. The secondary battery enters thermal runaway after passing through the state (5), the state (6), the state (7), or the like. Thus, to prevent thermal runaway, the temperature increase of the secondary battery is preferably inhibited and the negative electrode, the positive electrode, and/or the electrolyte solution is/are preferably kept stable at high temperatures exceeding 100° C.

The positive electrode active material 100, which is one embodiment of the present invention described in Embodiment 1, has a stable crystal structure and an effect of inhibiting release of oxygen. Thus, the secondary battery including the positive electrode active material 100 probably does not come into a state of after at least the state (5) and the temperature increase of the secondary battery is probably inhibited, leading to a significant effect that thermal runaway is less likely to occur.

### <Nail Penetration Test>

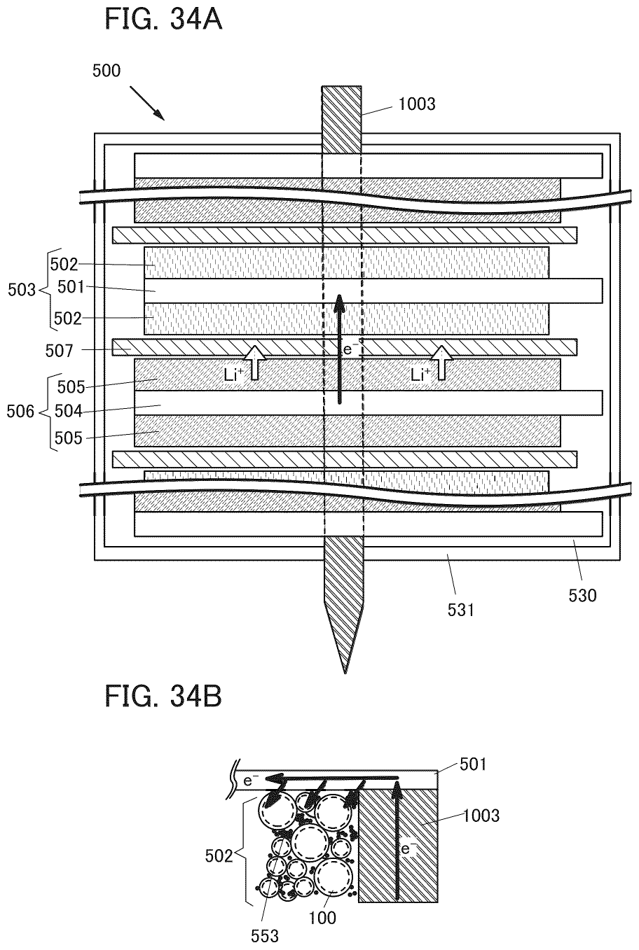

Next, a nail penetration test will be described with reference to FIG. 34A, FIG. 34B, and the like. In the nail penetration test, a nail 1003 having a predetermined diameter selected from a range of 2 mm to 10 mm penetrates a secondary battery 500 in a fully charged state (a state equal to 100% States of Charge (SOC)) at a predetermined speed selected from a range of 1 mm/s to 20 mm/s, for example. FIG. 34A is a cross-sectional view illustrating the state where the nail 1003 penetrates the secondary battery 500. The secondary battery 500 has a structure in which the positive electrode 503, the separator 507, the negative electrode 506, and an electrolyte solution 530 are held in an exterior body 531. The positive electrode 503 includes the positive electrode current collector 501 and the positive electrode active material layers 502 formed over both surfaces of the positive electrode current collector 501. The negative electrode 506 includes the negative electrode current collector 504 and the negative electrode active material layers 505 formed over both surfaces of the negative electrode current collector 504. FIG. 34B is an enlarged view of the nail 1003 and the positive electrode current collector 501 and clearly illustrates the positive electrode active material 100 of one embodiment of the present invention and a conductive material 553 that are included in the positive electrode active material layer 502.

In general, an internal short circuit occurs when the nail 1003 penetrates the positive electrode 503 and the negative electrode 506 as illustrated in FIG. 34A and FIG. 34B. This makes the potential of the nail 1003 equivalent to the potential of the negative electrode, so that an electron (e⁻) flows to the positive electrode 503 as indicated by arrows through the nail 1003 or the like and Joule heat is generated in the portion where the internal short circuit has occurred and the vicinity of the portion. The internal short circuit causes carrier ions typified by lithium ions (Li⁺) to be extracted from the negative electrode 506 and to be released into the electrolyte solution as indicated by white arrows. At this time, insufficient anions in the electrolyte solution 530 causes the electrolyte solution 530 to start decomposing because the electrolyte solution 530 cannot receive all the lithium ions extracted from the negative electrode 506. This is a type of electrochemical reaction and is referred to as a reduction reaction of an electrolyte solution by a negative electrode. Then, the electron (e⁻) that has flowed to the positive electrode 503 reduces cobalt, which is tetravalent in the lithium cobalt oxide in the charged state, so that the cobalt becomes trivalent or divalent. This reduction reaction causes oxygen release from the lithium cobalt oxide, and the electrolyte solution 530 is decomposed by the released oxygen or the like. This is a type of electrochemical reaction and is referred to as an oxidation reaction of an electrolyte solution by a positive electrode.

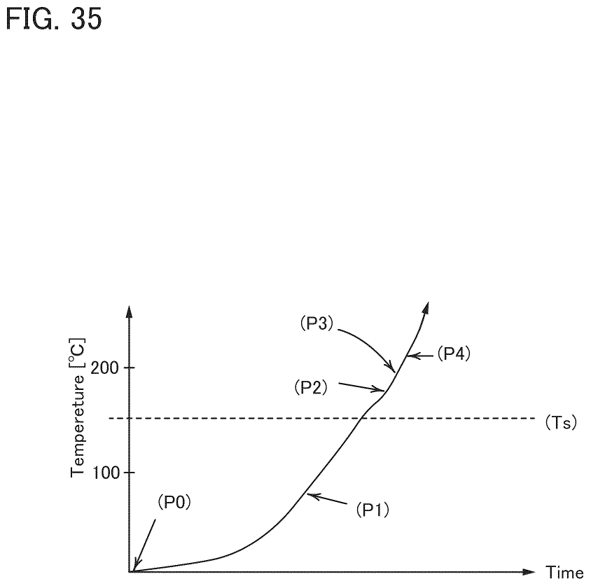

In general, the temperature of a secondary battery changes as shown in the graph of FIG. 35 when an internal short circuit of the secondary battery occurs. FIG. 35 is obtained by partly modifying the graph cited from [FIG. 2-11] on page 70 of Non-Patent Document 15 and is a graph showing the temperature of a secondary battery with respect to time. The graph demonstrates that when an internal short circuit occurs at (P0), the temperature of the secondary battery increases over time. Specifically, when the temperature of the secondary battery reaches 100° C. or the vicinity thereof because of Joule heat as indicated by (P1), the temperature exceeds the reference temperature (Ts) of the secondary battery. Then, reduction of an electrolyte solution by a negative electrode (the negative electrode is C₆Li when graphite is used) and heat generation are caused at (P2), oxidation of the electrolyte solution by a positive electrode and heat generation are caused at (P3), and heat generation due to thermal decomposition of the electrolyte solution is caused at (P4). Accordingly, the secondary battery enters thermal runaway, resulting in ignition or the like.

When a nail penetration test is performed on the secondary battery including the positive electrode active material of one embodiment of the present invention, the positive electrode active material 100 has a unique effect that release of oxygen is inhibited, which presumably inhibits oxidation reaction of the electrolyte solution and suppresses heat generation. Moreover, in the case where the positive electrode active material is a composite compound containing the above-described additive element, the speed of current flowing into the positive electrode in the case of an internal short circuit is probably reduced. In that case, a significant effect that thermal runaway is less likely to occur and thus ignition or the like is less likely to occur can be obtained.

This embodiment can be used in appropriate combination with the other embodiments.

### Embodiment 4

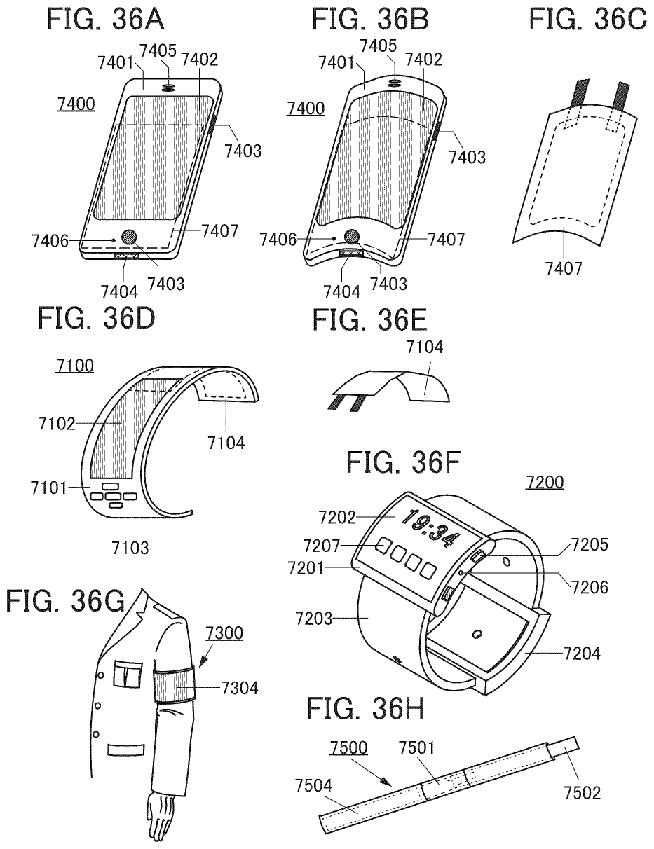

In this embodiment, examples of electronic devices each including the secondary battery of one embodiment of the present invention will be described with reference to FIG. 36A to FIG. 38C.

FIG. 36A to FIG. 36G illustrate examples of electronic devices each including the secondary battery containing a positive electrode active material described in the above embodiment. Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house, a building, or the like or a curved interior/exterior surface of an automobile, for example.

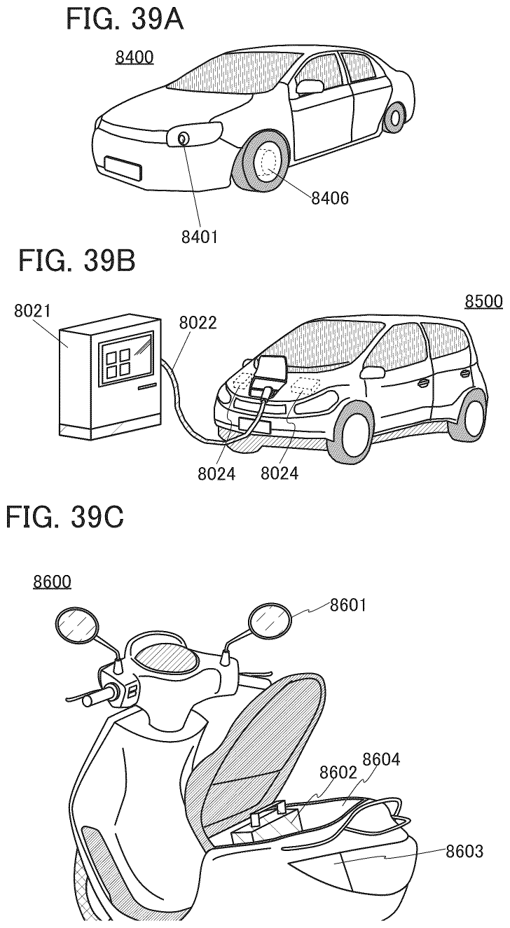

FIG. 39A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 39B illustrates the state where the mobile phone 7400 is bent. When the whole mobile phone 7400 is bent by the external force, the secondary battery 7407 included in the mobile phone 7400 is also bent. FIG. 39C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved, and the secondary battery 7407 can have high reliability even in a state of being bent.

FIG. 36D illustrates an example of a bangle display device. A portable display device 7100 includes a housing 7101, a display portion 7102, operation buttons 7103, and a secondary battery 7104. FIG. 36E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 36F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication with a headset capable of wireless communication enables hands-free calling.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 36E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 36G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. Note that the charging operation may be performed by wireless power feeding without using the input/output terminal.

When the secondary battery of one embodiment of the present invention is used as the secondary battery included in the display device 7300, a lightweight display device with a long lifetime can be provided.

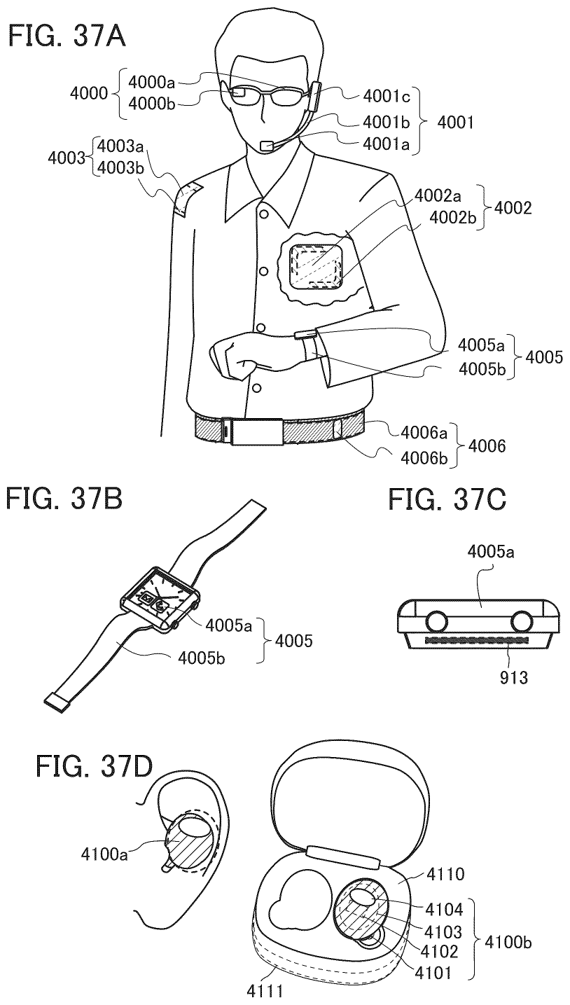

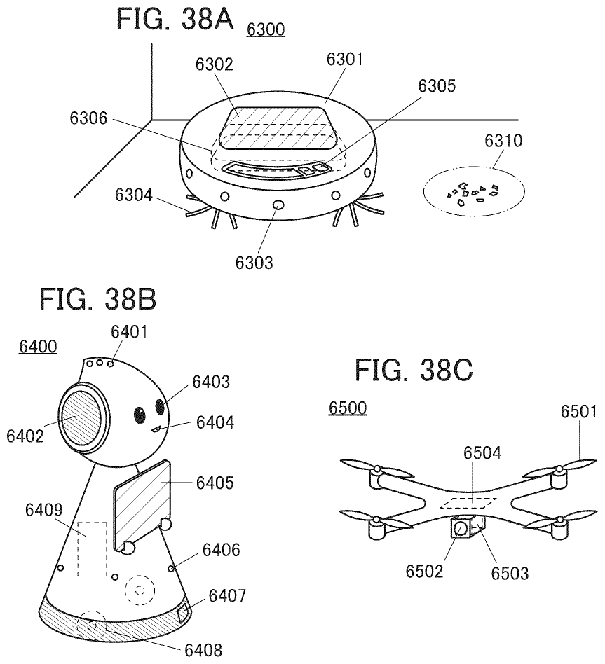

Examples of electronic devices each including the secondary battery with excellent cycle performance described in the above embodiment are described with reference to FIG. 36H, FIG. 37, and FIG. 38.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high discharge capacity are desired in consideration of handling ease for users.

FIG. 36H is a perspective view of a device called a cigarette smoking device (electronic cigarette). In FIG. 36H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharging and overdischarging of the secondary battery 7504 may be electrically connected to the secondary battery 7504. The secondary battery 7504 illustrated in FIG. 36H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

FIG. 37A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 37A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 37B illustrates a perspective view of the watch-type device 4005 that is detached from an arm.

FIG. 37C illustrates a side view. FIG. 37C illustrates a state where the secondary battery 913 is incorporated inside. The secondary battery 913 is the secondary battery described in Embodiment 4. The secondary battery 913, which is small and lightweight, is provided at a position overlapping with the display portion 4005a.

FIG. 37D illustrates an example of wireless earphones. The wireless earphones illustrated here consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charge, and the like are preferably included. Furthermore, a microphone may be included.

A case 4110 includes a secondary battery 4111. Moreover, a substrate where a circuit such as a wireless IC or a charge control IC is provided, and a terminal for charge are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 38A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 38B illustrates an example of a robot. A robot 6400 illustrated in FIG. 38B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 38C illustrates an example of a flying object. A flying object 6500 illustrated in FIG. 38C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 5

In this embodiment, examples of vehicles each including the secondary battery containing a positive electrode active material of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

FIG. 39 illustrates examples of vehicles each including the secondary battery of one embodiment of the present invention. An automobile 8400 illustrated in FIG. 39A is an electric vehicle that runs on the power of an electric motor. Alternatively, the automobile 8400 is a hybrid electric vehicle capable of driving using either an electric motor or an engine as appropriate. The use of one embodiment of the present invention can achieve a high-mileage vehicle. The automobile 8400 includes the secondary battery. For example, the modules of the secondary battery can be arranged in a floor portion in the automobile to be used. The secondary battery can be used not only for driving an electric motor 8406, but also for supplying electric power to a light-emitting device such as a headlight 8401 and a room light (not illustrated).

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 39B can be charged when the secondary battery included in the automobile 8500 is supplied with electric power through external charge equipment by a plug-in system, a contactless power feeding system, and/or the like. FIG. 39B illustrates a state where a secondary battery 8024 included in the automobile 8500 is charged with the use of a ground-based charging apparatus 8021 through a cable 8022. In charging, a given method such as CHAdeMO (registered trademark) or Combined Charging System may be employed as a charging method, the standard of a connector, and the like as appropriate. The charging apparatus 8021 may be a charging station provided in a commerce facility or a power source in a house. For example, with the use of a plug-in technique, the secondary battery 8024 provided in the automobile 8500 can be charged by being supplied with power from outside. Charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 39C is an example of a motorcycle using the secondary battery of one embodiment of the present invention. A motor scooter 8600 illustrated in FIG. 39C includes a secondary battery 8602, side mirrors 8601, and direction indicators 8603. The secondary battery 8602 can supply electricity to the direction indicators 8603.

In the motor scooter 8600 illustrated in FIG. 39C, the secondary battery 8602 can be held in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power supply source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### REFERENCE NUMERALS

100a: surface portion, 100b: inner portion, 100: positive electrode active material, 101: crystal grain boundary, 102: filling portion, 104: coating portion, 200: active material layer, 202: space in heating furnace, 204: hot plate, 206: heater unit, 208: heat insulator, 216: container, 218: lid, 219: space, 220: heating furnace, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte solution, 509: exterior body, 510: positive electrode lead electrode, 511: negative electrode lead electrode, 530: electrolyte solution, 531: exterior body, 553: conductive material, 903: mixture, 913: secondary battery, 1003: nail, 4000a: frame, 4000b: display portion, 4000: glasses-type device, 4001a: microphone portion, 4001b: flexible pipe, 4001c: earphone portion, 4001: headset-type device, 4002a: housing, 4002b: secondary battery, 4002: device, 4003a: housing, 4003b: secondary battery, 4003: device, 4005a: display portion, 4005b: belt portion, 4005: watch-type device, 4006a: belt portion, 4006b: wireless power feeding and receiving portion, 4006: belt-type device, 4100a: main body, 4100b: main body, 4101: driver unit, 4102: antenna, 4103: secondary battery, 4104: display portion, 4110: case, 4111: secondary battery, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 6500: flying object, 6501: propeller, 6502: camera, 6503: secondary battery, 6504: electronic component, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 8021: charging apparatus, 8022: cable, 8024: secondary battery, 8400: automobile, 8401: headlight, 8406: electric motor, 8500: automobile, 8600: motor scooter, 8601: side mirror, 8602: secondary battery, 8603: direction indicator

1. A method for manufacturing a secondary battery comprising a positive electrode comprising a positive electrode active material, a negative electrode, and an electrolyte, the method comprising:
mixing a composite oxide comprising lithium, cobalt, and oxygen, a magnesium source, and a nickel source to form a mixture; and
heating the mixture,
wherein the nickel source is nickel fluoride, and
wherein magnesium, nickel, and fluorine are segregated on a surface portion of the composite oxide heating the mixture.

2. The method for manufacturing a secondary battery according to claim 1,
wherein the magnesium source is magnesium fluoride.

3. A method for manufacturing a secondary battery comprising a positive electrode comprising a positive electrode active material, a negative electrode, and an electrolyte, the method comprising:
mixing a composite oxide comprising lithium, cobalt, and oxygen, magnesium fluoride, nickel fluoride, and lithium fluoride to form a mixture; and
heating the mixture, and
wherein magnesium, nickel, and fluorine are segregated on a surface portion of the composite oxide heating the mixture.

4. The method for manufacturing a secondary battery according to claim 1,
wherein the positive electrode active material has a layered rock-salt crystal structure belonging to R-3m,
wherein the positive electrode active material has a structure in which a CoO₂ layer and a lithium layer are alternately stacked, and
wherein magnesium segregated on the surface portion of the composite oxide inhibits a shift in the CoO₂ layer.

5. The method for manufacturing a secondary battery according to claim 1,
wherein heating the mixture is performed at a temperature higher than or equal to 650° C. and lower than or equal to 1000° C.

6. The method for manufacturing a secondary battery according to claim 1,
wherein heating the mixture is performed at a temperature at which cation mixing is unlikely to occur.

7. A method for manufacturing a secondary battery comprising a positive electrode comprising a positive electrode active material, a negative electrode, and an electrolyte, the method comprising:
mixing a first composite oxide, a magnesium source, and a nickel source to form a first mixture;
performing first heating on the first mixture to form a second composite oxide;
mixing the second composite oxide and an aluminum source to form a second mixture; and
performing second heating on the second mixture,
wherein the first composite oxide comprises lithium, cobalt, and oxygen,
wherein the nickel source is nickel fluoride, and
wherein magnesium, nickel, and fluorine are segregated on a surface portion of the second composite oxide by the first heating.

8. The method for manufacturing a secondary battery according to claim 7,
wherein the magnesium source is magnesium fluoride.

9. The method for manufacturing a secondary battery according to claim 7,
wherein the positive electrode active material has a layered rock-salt crystal structure belonging to R-3m,
wherein the positive electrode active material has a structure in which a CoO₂ layer and a lithium layer are alternately stacked, and
wherein magnesium segregated on the surface portion of the second composite oxide inhibits a shift in the CoO₂ layer.

10. The method for manufacturing a secondary battery according to claim 7,
wherein the first heating is performed at a temperature higher than or equal to 650° C. and lower than or equal to 1000° C., and
wherein the second heating is performed at a lower temperature than the first heating.

11. A method for manufacturing a secondary battery comprising a positive electrode comprising a positive electrode active material, a negative electrode, and an electrolyte, the method comprising:
mixing a first composite oxide, a first nickel source, and lithium fluoride to form a first mixture;
performing first heating on the first mixture to form a second composite oxide; and
mixing the second composite oxide and a second nickel source to form a second mixture; and
performing second heating on the second mixture, and
wherein the first composite oxide comprises lithium and cobalt.

12. The method for manufacturing a secondary battery according to claim 11,
wherein the first nickel source is nickel fluoride.

13. The method for manufacturing a secondary battery according to claim 11,
wherein a magnesium source is mixed in addition to the first composite oxide, the first nickel source, and the lithium fluoride to form the first mixture.

14. The method for manufacturing a secondary battery according to claim 11,
wherein step, the first mixture is formed by mixing a magnesium source in addition to the first composite oxide, the first nickel source, and the lithium fluoride,
wherein the first nickel source is nickel fluoride, and
wherein the magnesium source is magnesium fluoride.

15. A method for manufacturing a secondary battery comprising a positive electrode comprising a positive electrode active material, a negative electrode, and an electrolyte, the method comprising:
mixing a first composite oxide and a first nickel source to form a first mixture;
performing first heating on the first mixture to form a second composite oxide;
mixing the second composite oxide, a second nickel source, and lithium fluoride to form a second mixture; and
performing second heating on the second mixture, and
wherein the first composite oxide comprises lithium and cobalt.

16. The method for manufacturing a secondary battery according to claim 15,
wherein the first nickel source is nickel fluoride.

17. The method for manufacturing a secondary battery according to claim 15,
wherein a magnesium source is mixed in addition to the second composite oxide, the second nickel source, and the lithium fluoride to form the second mixture.

18. The method for manufacturing a secondary battery according to claim 15,
wherein the second mixture is formed by mixing a magnesium source in addition to the second composite oxide, the second nickel source, and the lithium fluoride,
wherein the first nickel source is nickel fluoride, and
wherein the magnesium source is magnesium fluoride.

19. The method for manufacturing a secondary battery according to claim 11,
wherein the first heating is performed at a temperature higher than or equal to 650° C. and lower than or equal to 1000° C., and
wherein the second heating is performed at a lower temperature than the first heating.

20. The method for manufacturing a secondary battery according to claim 3,
wherein the positive electrode active material has a layered rock-salt crystal structure belonging to R-3m,
wherein the positive electrode active material has a structure in which a CoO₂ layer and a lithium layer are alternately stacked, and
wherein magnesium segregated on the surface portion of the composite oxide inhibits a shift in the CoO₂ layer.

21. The method for manufacturing a secondary battery according to claim 3,
wherein heating the mixture is performed at a temperature higher than or equal to 650° C. and lower than or equal to 1000° C.

22. The method for manufacturing a secondary battery according to claim 3,
wherein heating the mixture is performed at a temperature at which cation mixing is unlikely to occur.

23. The method for manufacturing a secondary battery according to claim 11,
wherein the first heating is performed at a temperature higher than or equal to 650° C. and lower than or equal to 1000° C., and
wherein the second heating is performed at a lower temperature than the first heating.
